(19) United States
(12) Patent Application Publication
(10) Pub. No.: US 2025/0185555 A1
(43) Pub. Date: Jun. 12, 2025

(54) DECODER-BASED IRRIGATION CONTROL SYSTEMS AND USER INTERFACES

(71) Applicant: Rain Bird Corporation, Azusa, CA (US)

(72) Inventors: Daniel B. Zimet, Carlsbad, CA (US); Joseph G. Porrazzo, Sahuarita, AZ (US); Steven M. Barendt, Leander, TX (US)

(21) Appl. No.: 18/974,417

(22) Filed: Dec. 9, 2024

Related U.S. Application Data
(60) Provisional application No. 63/608,084, filed on Dec. 8, 2023.

(51) Int. Cl. A01G 25/16; G06F 3/0482

(52) U.S. Cl. CPC A01G 25/16; G06F 3/0482

(57) ABSTRACT

In some embodiments, apparatuses and methods are provided herein useful to use with irrigation devices connected to a multi-wire path in an irrigation system. In some embodiments, an irrigation management system includes an irrigation management application which, when executed by an electronic device, causes a user interface to be displayed to a user. The user interface includes features that permit a user to do one or more of configure, monitor, program, control, adjust various aspects of the irrigation management system. For example, the user interface displays decoder addresses assigned to irrigation stations and permits the user to manipulate various aspects of decoder address assignments to the irrigation stations and to perform various diagnostics and/or troubleshooting in connection with the decoders assigned to the irrigation stations.

### CROSS-REFERENCE TO RELATED APPLICATIONS

This application claims the benefit of U.S. Provisional Application No. 63/608,084, filed Dec. 8, 2023, and entitled DECODER-BASED IRRIGATION CONTROL SYSTEMS AND USER INTERFACES (Attorney Docket No. 8473-157975-US), which is incorporated herein by reference in its entirety.

### TECHNICAL FIELD

This disclosure relates generally to irrigation control and, in particular, to decoder-based irrigation control systems with user interfaces for monitoring and controlling irrigation.

### BACKGROUND

In a typical irrigation control system, a computer executing irrigation control software and/or a dedicated electronic irrigation controller store and execute irrigation schedules that control watering components in a landscape to apply watering. In large-scale irrigation systems that may be employed, for example, on golf courses, there is a very large number of valves or irrigation stations, each of which has to be individually controlled (e.g., opened or closed to control water flow to sprinklers) and monitored. Central irrigation control software is often complex and requires the user to undergo specialized training, which is complex, time-consuming, and often not easy to understand, such that a limited number of users are able to properly operate the central irrigation control software.

Generally, decoder-based irrigation systems use a two-wire path (a single pair of wires) extending into a landscape to interface a large number of solenoids to a controller using less wiring relative to a discrete wire path to each solenoid. A controller or interface unit outputs a modulated power signal on the two-wire path to power and control the devices connected to the two-wire path. Decoders connect to the two-wire path at various locations in parallel to each other. Decoders derive their operational power from the modulated power signal and decode to data modulated on the power signal to receive commands and messages. Each decoder has a unique device address that can be addressed so that multiple decoders can be controlled on the “party-line” two-wire path. These unique addresses are often printed on labels of the decoders as a series of numbers and/or represented as printed bar codes. The controller or interface unit addresses individual decoders by their unique address to be able to individually control a given solenoid connected to a decoder.

Typical decoder-based systems have tens or hundreds of decoders connected to the two-wire path with digital addresses ranging into the tens of thousands or even higher. In order to address and control these decoders, the unique addresses of the connected decoders need to be programmed or entered into the controller, and stored in a lookup table. Decoder addresses are often written or typed on a listing by an installer and then manually entered in the controller. For example, using the user interface of the controller (buttons, dials, display screen) or using the user interface of a computer (keyboard, mouse, monitor) or other device if the irrigation controller is implemented on a computer. The manual process of address entry is time consuming and error prone. Addresses may also be read from bar codes by an optical reader and then transferred to the controller. Such optical reading is likewise time consuming since a reader must be brought to the decoders or the decoders are brought to the scanner before installation. Additionally, since decoders are frequently buried underground after installation, there are times that a decoder needs to be dug up to verify a digital address if an error occurs.

### BRIEF DESCRIPTION OF DRAWINGS

Disclosed herein are embodiments of systems, methods, user interfaces, and controls relating to monitoring and/or controlling a decoder-based irrigation system. This description includes drawings, wherein:

FIG. 1 illustrates a simplified block diagram of an exemplary central control-based irrigation system in accordance with some embodiments;

FIG. 2 illustrates a simplified block diagram of an exemplary irrigation controller-based irrigation system in accordance with some embodiments;

FIG. 3 illustrates a diagram of an exemplary irrigation control system in accordance with some embodiments;

FIG. 4 illustrates a diagram of another exemplary irrigation control system in accordance with some embodiments;

FIG. 5 illustrates a feature of another exemplary irrigation control system in accordance with some embodiments;

FIG. 6 is a functional block diagram of an exemplary computing device in accordance with some embodiments;

FIG. 7 is a functional block diagram of an exemplary server device in accordance with some embodiments;

FIG. 8 is a functional block diagram of an exemplary mobile device in accordance with some embodiments;

FIG. 9A illustrates a simplified block diagram of an exemplary irrigation system including an irrigation control unit with an encoder in accordance with some embodiments;

FIG. 9B illustrates a simplified block diagram of an exemplary encoder of an irrigation control unit using an H-bridge in accordance with some embodiments;

FIG. 10 is a schematic illustration of an exemplary output power signal modulated with data by encoding each cycle of the power signal with one of two frequencies to represent a data bit in accordance with some embodiments;

FIG. 11 illustrates a simplified block diagram of an exemplary decoder unit for an irrigation system that receives power and data from an irrigation control unit in accordance with some embodiments;

FIG. 12 shows a flow diagram of an exemplary process of automatic discovery of addresses in accordance with some embodiments;

FIG. 13 shows an exemplary discovery message format in accordance with some embodiments;

FIG. 14A-14B illustrate an exemplary automatic discovery of addresses of irrigation devices in accordance with some embodiments;

FIG. 15 shows a flow diagram of an exemplary process of automatic assignment of irrigation devices in accordance with some embodiments;

FIG. 16 illustrates an exemplary process of swapping zone number assignments between irrigation devices and/or addresses in accordance with some embodiments;

FIG. 17A shows an example user interface of an irrigation control unit in accordance with some embodiments;

FIG. 17B shows an example user interface installed on a mobile device in accordance with some embodiments;

FIG. 18A illustrates an exemplary portion of a user interface on a mobile device in accordance with some embodiments that displays a listing of irrigation stations and irrigation device addresses, some of which are assigned to the irrigation stations;

FIG. 18B illustrates an exemplary portion of a user interface on a mobile device in accordance with some embodiments that displays a menu that defines the meaning of status icons associated with the irrigation device addresses in the listing;

FIG. 18C illustrates an exemplary portion of a user interface on a mobile device in accordance with some embodiments that displays a listing of irrigation stations and irrigation device addresses, where one of the irrigation stations has two irrigation device assigned to it;

FIG. 19A illustrates an exemplary portion of a user interface on a mobile device in accordance with some embodiments that includes a sorting feature permitting the user to sort the irrigation stations and irrigation device addresses based on user-selectable sort options;

FIG. 19B illustrates an exemplary portion of a user interface on a mobile device in accordance with some embodiments and shows the user-selectable sort options that are displayed to the user after the sorting feature is activated;

FIG. 20A illustrates an exemplary portion of a user interface on a mobile device in accordance with some embodiments that includes a filtering feature permitting the user to filter the irrigation stations and irrigation device addresses based on user-selectable sort options;

FIG. 20B illustrates an exemplary portion of a user interface on a mobile device in accordance with some embodiments and shows the user-selectable filtering options that are displayed to the user after the filtering feature is activated;

FIG. 20C illustrates an exemplary portion of a user interface on a mobile device in accordance with some embodiments and shows the listing of the irrigation stations after a user-selected filtering option has been applied;

FIG. 21A illustrates an exemplary portion of a user interface on a mobile device in accordance with some embodiments that includes a search feature that permits the user to enter a search query to search at least for irrigation device addresses and irrigation station identifiers/names;

FIG. 21B illustrates the exemplary portion of the user interface of FIG. 21A in accordance with some embodiments after the user interacted with the search feature and showing the last five search terms employed by the user;

FIG. 21C illustrates the exemplary portion of the user interface of FIG. 21A in accordance with some embodiments after the user interacted with the search feature and showing that the search term entered by the user into the search feature was found as a result of the search;

FIG. 22A illustrates an exemplary portion of a user interface on a mobile device in accordance with some embodiments that includes an interactive irrigation device address scan feature that permits the user to cause the irrigation management application to scan the irrigation system to detect all unique irrigation device addresses connected to the multi-wire path;

FIG. 22B illustrates the exemplary portion of the user interface of FIG. 22A in accordance with some embodiments after the user interacted with the irrigation device address scan feature and showing an interactive prompt that requires the user to select an option that indicates whether the irrigation system includes a master valve;

FIG. 22C illustrates the exemplary portion of the user interface of FIG. 22A in accordance with some embodiments after the scanning of the irrigation device addresses has been initiated via the device address scan feature;

FIG. 22D illustrates the exemplary portion of the user interface of FIG. 22A in accordance with some embodiments after the scan for irrigation device addresses is complete and shows a listing of irrigation device addresses detected during the scan;

FIG. 23A illustrates an exemplary portion of a user interface on a mobile device in accordance with some embodiments that includes an interactive feature selection option that permits the user to select a feature to apply to the listing of the irrigation stations and irrigation device addresses;

FIG. 23B illustrates the exemplary portion of the user interface of FIG. 23A in accordance with some embodiments after the user interacted with the feature selection option and showing an interactive features menu that includes several features selectable by the user;

FIG. 23C illustrates the exemplary portion of the user interface of FIG. 23B in accordance with some embodiments after the user interacted with the remove all feature in the features menu and showing a prompt that requires the user to confirm the removal of all irrigation device addresses from the listing;

FIG. 23D illustrates the exemplary portion of the user interface of FIG. 23C in accordance with some embodiments after the user interacted with the remove all confirmation prompt and showing that the listing of the irrigation stations no longer includes any irrigation device addresses associated therewith;

FIG. 24A illustrates an exemplary portion of a user interface on a mobile device in accordance with some embodiments that includes an interactive options feature that permits the user to select an option to apply to the listing of the irrigation stations;

FIG. 24B illustrates the exemplary portion of the user interface of FIG. 24A in accordance with some embodiments after the user interacted with the options feature and showing an interactive station options menu that includes several options selectable by the user;

FIG. 24C illustrates the exemplary portion of the user interface of FIG. 24B in accordance with some embodiments after the user interacted with the edit station option in the station options menu and shows an options sub-menu permitting the user to view information and select an option relating to an irrigation station;

FIG. 24D illustrates the exemplary portion of the user interface of FIG. 24C in accordance with some embodiments after the user interacted with the advanced settings option and showing several advanced setting options selectable by the user in connection with an irrigation station;

FIG. 25A illustrates the exemplary portion of the user interface of FIG. 24A in accordance with some embodiments after the user interacted with the options feature and showing the interactive station options menu that includes several options selectable by the user;

FIG. 25B illustrates the exemplary portion of the user interface of FIG. 25A in accordance with some embodiments after the user interacted with the remove address option in the station options menu and shows a prompt that requires the user to confirm the removal of an address from the listing;

FIG. 25C illustrates the exemplary portion of the user interface of FIG. 25B in accordance with some embodiments after the user interacted with the prompt to confirm removal of the irrigation device address from the listing, and shows the listing of irrigation stations with the user-selected address having been removed;

FIG. 26A illustrates an exemplary portion of a user interface on a mobile device in accordance with some embodiments that includes an option to perform a swap of the irrigation device of a first irrigation station in the listing with another irrigation station in the listing;

FIG. 26B illustrates the exemplary portion of the user interface of FIG. 26B in accordance with some embodiments after the user interacted with the irrigation device address swap option and showing a prompt that requires the user to confirm the irrigation device address swap;

FIG. 27A illustrates an exemplary portion of a user interface on a mobile device in accordance with some embodiments that includes an alternative option to perform a swap of the irrigation device address of a first irrigation station in the listing with another irrigation station in the listing;

FIG. 27B illustrates the exemplary portion of the user interface of FIG. 27A after the user interacted with the irrigation device address swap option and showing a listing of user-selectable irrigation device addresses that the user may select for the swap;

FIG. 27C shows the exemplary portion of the user interface of FIG. 27B in accordance with some embodiments after the user selects decoder addresses that the user would like to swap and shows a swap preview window;

FIG. 28 illustrates an exemplary portion of a user interface on a mobile device in accordance with some embodiments, showing a plurality of distinct interactive blocks or sections that are each associated with a single irrigation station selectable by the user;

FIG. 29A illustrates an exemplary portion of a user interface on a mobile device in accordance with some embodiments that includes an interactive feature selection option that permits the user to select a feature to apply to the listing of the irrigation stations and irrigation device addresses;

FIG. 29B illustrates the exemplary portion of the user interface of FIG. 29A in accordance with some embodiments after the user interacted with the feature selection option and showing an interactive features menu that includes a troubleshooting option selectable by the user;

FIG. 29C illustrates the exemplary portion of the user interface of FIG. 29B in accordance with some embodiments after the user interacted with the troubleshooting feature in the features menu and showing a troubleshooting menu with troubleshooting options that are selectable by the user;

FIG. 30A illustrates the exemplary portion of the user interface of FIG. 29C in accordance with some embodiments after the user interacted with the 2-wire health option in the troubleshooting menu and showing a health snapshot menu displayed to the user before the troubleshooting test is performed;

FIG. 30B illustrates the exemplary portion of the user interface of FIG. 29C in accordance with some embodiments after the user interacted with the 2-wire health option in the troubleshooting menu and showing a health snapshot menu displayed to the user after the troubleshooting test is performed;

FIG. 31A illustrates the exemplary portion of the user interface of FIG. 29C in accordance with some embodiments after the user interacted with the find short option in the troubleshooting menu and showing a prompt that requires the user to confirm the energizing of the multi-wire path;

FIG. 31B illustrates the exemplary portion of the user interface of FIG. 31A in accordance with some embodiments after the user interacted with the prompt to confirm the energizing of the multi-wire path and showing an informational menu to the user;

FIG. 32 shows a simplified flow diagram illustrating a method of managing irrigation in accordance with some embodiments;

FIG. 33 shows a simplified flow diagram illustrating a method of managing irrigation in accordance with some embodiments; and

FIG. 34 shows a simplified flow diagram illustrating a method of managing irrigation in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these embodiments of the present disclosure. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the art as set forth above except where different specific meanings have otherwise been set forth herein.

### DETAILED DESCRIPTION

The following description is not to be taken in a limiting sense, but is made merely for the purpose of describing the general principles of exemplary embodiments. The scope of the invention should be determined with reference to the claims. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the invention. Thus, appearances of the phrases “in one embodiment,” “in an embodiment,” “in some embodiments”, “in some implementations”, and similar language throughout this specification may, but do not necessarily, all refer to the same embodiment. Various user interface features for allowing users to interface with a decoder-based irrigation control system are described herein. The following describes a few exemplary decoder-based irrigation control systems, following by several user interface embodiments.

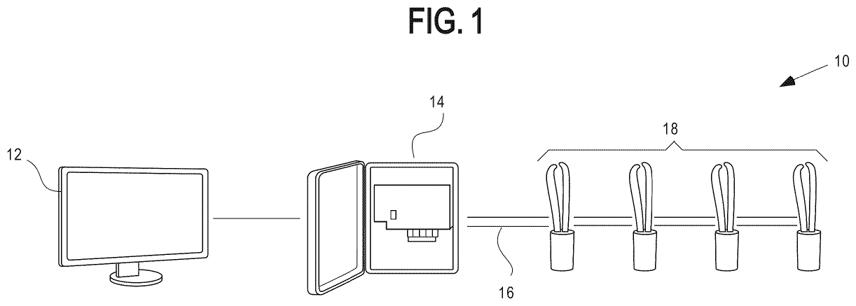

In FIG. 1, a simplified block diagram of an exemplary central control-based irrigation system 10 is shown. By one approach, a central control-based irrigation system 10 includes a computer 12, although in a central control system, it is understood that the computer 12 can be a computer, a computer system, a mobile computer device, a smart phone, a tablet computer, a server or a server system, for example. The computer 12 may be at the irrigation site (landscape) or may be remote from the irrigation site. The computer 12 can have central control irrigation control software installed thereon that can create and/or execute all irrigation schedules and programming. Often, the computer 12 generates schedules for hundreds of irrigation stations or zones in the field.

In some configurations, the computer 12 is coupled to one or more field interface devices or irrigation control units 14. FIG. 1 illustrates an irrigation control unit 14. The computer 12 may be coupled to the irrigation control unit 14 through various types of wired and/or wireless local area networks and/or wide area networks. The irrigation control unit 14 is the interface to the local irrigation devices 18 in the field, for example, decoders, receivers, sprinklers, sensors, master valves, and so on. In a decoder-based system (i.e., in a system that includes decoders as the example irrigation devices 18), the irrigation control unit 14 includes an encoder or a modulator and a multi-wire output interface that electrically couple to a multi-wire path 16 (e.g., a two-wire path) that extends from the irrigation control unit 14 into the field. The multi-wire path 16 can extend tens or hundreds of meters in the landscape.

The multi-wire path 16 is typically a two-wire path, but it will be understood that this path may be a three or more wire path. The irrigation control unit 14 receives irrigation commands and/or irrigation schedules from the computer 12, and uses the encoder/modulator to encode or modulate data from these commands and/or schedules onto an output power signal that is applied to the multi-wire path 16. The output power signal provides power and control signaling over the multi-wire path 16 to irrigation devices 18 connected to the multi-wire path 16. As is common, various irrigation devices 18 (e.g., decoders, receivers, and so on) connected to the multi-wire path 16 at different locations in the field. These irrigation devices 18 receive the output power signal and derive their operational power and decode or demodulate the data on the signal to determine if the data from the signal is intended for the particular device or not, and if it is, the device takes any action indicated by the data. For example, if the computer 12 intends that a given irrigation device 18 is to cause irrigation, the output power signal is modulated with data to address the given irrigation device 18 such as a decoder and provide a turn on command.

The given irrigation device 18 decodes or demodulates data on the multi-wire path 16 and decodes or demodulates the turn on command. The irrigation device 18 then causes an electrically actuated solenoid valve connected to (or integrated with) the irrigation device to open allowing water to flow through the valve to the sprinkler device/s in the flow path of the valve. In a typical decoder-based control system, there may be tens or hundreds of irrigation devices 18. Although only one multi-wire path 16 is shown in FIG. 1, it is understood that there may be more than one multi-wire path extending from the irrigation control unit 14.

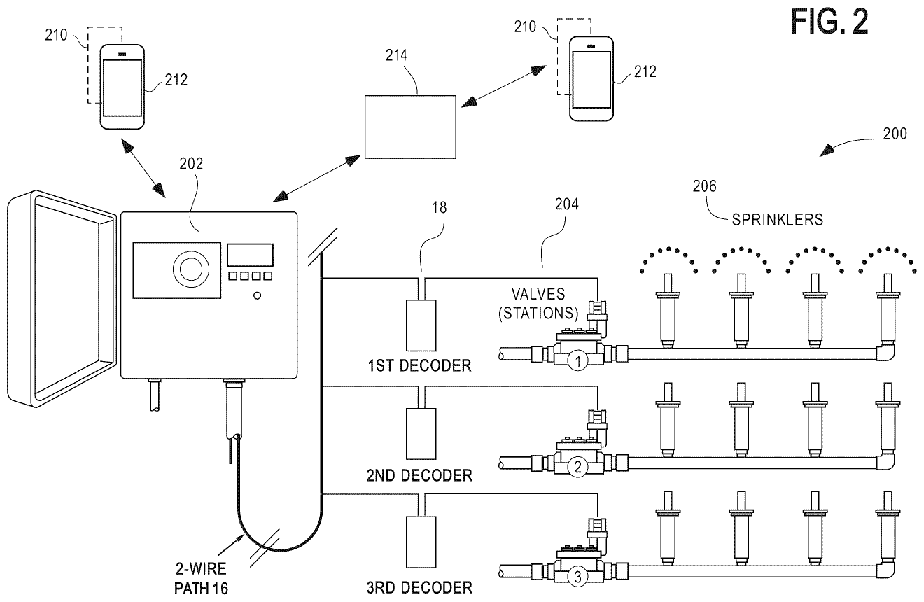

In FIG. 2, a simplified block diagram of an exemplary irrigation controller-based decoder irrigation system 200 is shown. In this embodiment, a dedicated irrigation controller, referred to as irrigation control unit 202, includes all functionality to generate and execute irrigation schedules with user input. That is, the irrigation control unit 202 includes a user interface (e.g., rotary dial, buttons, switches, display screen, and so on) and includes programming (e.g., firmware stored in memory of the controller). Thus, in some embodiments, the functionality of the computer 12 and irrigation control unit 14 of FIG. 1 may be implemented in the irrigation control unit 202. For example, the irrigation control unit 202 includes an encoder or modulator that is configured to encode or modulate data based on the stored irrigation schedules and/or manual user commands onto an output power signal that is applied to the multi-wire path 16 (e.g., a two-wire path as shown in FIG. 2). For example, the output power signal output over the multi-wire path 16 provides operational power to the irrigation devices 18 (illustrated as decoders) and/or is modulated with data in order to address and instruct the irrigation devices 18 such as decoders according to the irrigation programming in the irrigation control unit 202.

Relative to the system of FIG. 1, FIG. 2 illustrates valves 204 (e.g., latching or non-latching solenoid activated valves) coupled to the devices 18. The valves 204 control water flow through a pressurized water pipe to sprinkler devices 206. In some embodiments, the valves 204 are referred to as zones or stations, each having an assigned number. It is understood that there may be one or more valves 204 coupled to a given device 18. In some embodiments, the functionality of the irrigation control unit is implemented in a front panel or control module having the main control circuit board and microcontroller, and the functionality to interface with and encode signals for the multi-wire path 16 is provided in an encoder/modulator module that is electrically coupled to the front panel, the encoder/modulator module including the multi-wire interface connectors. A commercial example of a decoder-based irrigation controller is the Rain Bird ESP-LXD Series Two-Wire Decoder Controller, commercially available from Rain Bird Corporation of Azusa, California, United States. See also, U.S. Pat. No. 11,234,380, granted 1-12-2023, entitled “IRRIGATION CONTROLLER WITH RELAYS” (Docket No. 8473-147633-US), which describes various decoder-based irrigation controllers and is incorporated herein by reference. And see also, U.S. Pat. No. 11,357,181, granted 5-25-2022, entitled “DATA MODULATED SIGNAL GENERATION IN A MULTI-WIRE IRRIGATION CONTROL SYSTEM” (Docket No. 8473-150383-US), which describes various decoder-based irrigation controllers and data modulation approaches and is incorporated herein by reference.

In some embodiments, a user interface of the exemplary irrigation controller-based decoder irrigation system 200 is implemented at least in part at a device remote from the irrigation control unit 202 and in communication with the control unit 202. For example, at least portions of the user interface are implemented by a mobile application 210 installed on and executed by a mobile electronic device 212 such as a mobile phone or tablet. When executed, the mobile application 210 causes the mobile electronic device 212 to wirelessly communicate with the irrigation control unit 202 having a wireless transceiver. This communication may be direct between the mobile electronic device 212 and the irrigation control unit 202 (e.g., using Bluetooth or WiFi), and/or may be via one or more intermediary devices 214 (such as servers, routers, repeaters, network devices, cellular communication systems, local area networks, and so on).

The mobile application 210 provides a control interface to the user via the user interface of the mobile electronic device 212 (e.g., using a touch sensitive display screen, buttons, voice input, etc.). In such embodiments, the mobile application 210 and the mobile electronic device 212 provide and include all functionality to receive user input and commands used to generate and execute irrigation schedules. In some embodiments, the user interface may be entirely implemented via the mobile application 210 and mobile electronic device 212 such that a user interface (rotary dial, buttons, switches, display screen, and so on) for user input is not needed at the control unit 202. Further, it is understood that in some embodiments, the irrigation control unit 12 of FIG. 1 may similarly communicate with a mobile application of a mobile electronic device to receive some or all of the input needed to generate and execute irrigation schedules.

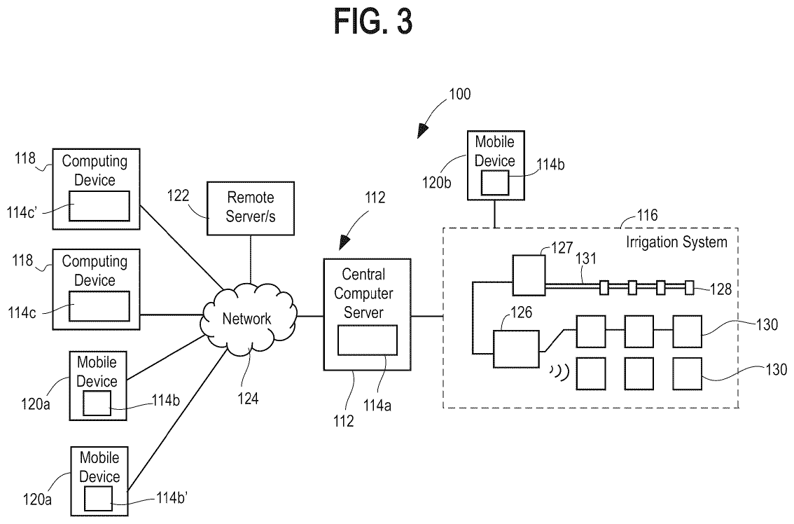

Referring to FIG. 3, an exemplary irrigation management system 100 is shown. Generally, the system 100 includes an irrigation management application 114a (e.g., central control software) stored on and executed by a central computer 112, which can be used for managing irrigation components of an irrigation system 116 located at one or more sites. The irrigation management application 114a and central computer 112 can be accessed via a network 124 (e.g., the Internet) by authorized remote electronic devices, such as computing devices 118, mobile devices 120a (e.g., mobile phones, tablets, etc.). Further, the central computer 112 can communicate with remote server(s) 122 (e.g., weather servers, map servers, and other third-party data or service providers) via the network 124. The irrigation management application functions to provide one or more of the functions noted above. For example, in some embodiments, the irrigation management application 114a can include, for example, one or more of setting, monitoring and adjusting operational parameters of and informational data associated with any and all components of the irrigation system 116, visually displaying the operational status of and informational data associated with any and all components of the irrigation system 116, automatically or manually controlling the operational parameters of any and all components of the irrigation system 116, and/or automatically or manually turning on and off and/or activating and deactivating any and all components of the irrigation system 116.

In FIG. 3, the central computer 112, computing devices 118, and mobile devices 120a, 120b are examples of electronic devices. The term “electronic device” as used herein may include a stationary or portable electronic device, for example, a desktop computer, a laptop computer, a server, multiple communicatively connected servers, a distributed computer, a tablet computer, a mobile phone, a personal digital assistant (PDA), a smartwatch or other wearable device, or any other electronic device including a control circuit (e.g., processor) that executes at least a portion of the irrigation management application and/or related application/s that support the irrigation management application. The exemplary electronic devices shown in FIG. 3, namely, central computer 112, computing device 118, mobile devices 120a, 120b, and remote server 122, may be configured for data display and entry and processing as well as for communication with each other and other devices of the system 100 via the network 124.

The exemplary network 124 depicted in FIG. 3 may be any computer connection network, e.g., including one or more of a wide-area network (WAN), a local area network (LAN), a personal area network (PAN), a wireless local area network (WLAN), a wired network, a wireless network, or any other internet or intranet network, or combinations of such networks. Generally, communication between various electronic devices of system 100 may take place over hard-wired, wireless, cellular, LoRa, LoRaWAN, Zigbee, Wi-Fi or Bluetooth (e.g., Bluetooth Low Energy (BLE)) networked components or the like. In some embodiments, one or more electronic devices of system 100 may include cloud-based features, such as cloud-based memory storage.

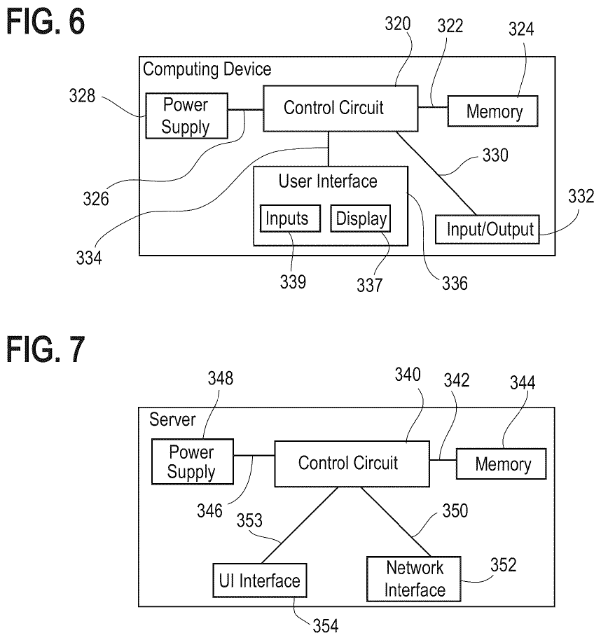

In some embodiments, electronic devices such as the central computer 112, computing device 118, mobile phone/tablet 120a, 120b, and/or remote server 122 include at least a portion of or are otherwise configured to work with the irrigation management application 114a. Accordingly, as shown in FIG. 3, the mobile devices 120a and 120b include one of irrigation management applications 114b and 114b′, and the remote computing devices 118 include one of irrigation management applications 114c and 114c′. In some embodiments, the irrigation management application 114a, 114b, 114b′, 114c, 114c′ comprise computer program code that is configured to be respectively installed on and executed by the electronic devices 112, 118, and 120a, 120b (e.g., by a control circuit of these electronic devices described in more detail below with respect to FIG. 6-7).

The irrigation management application 114a, 114b, 114b′, 114c, 114c′ can be executed by the respective electronic devices 112, 118, 120a, 120b in concert with other software modules or applications (computer program code), or groups of applications, such as operating systems, browser applications, location applications (e.g., mapping, GPS, etc. applications), two-factor authentication (TFA) applications, single sign on (SSO) applications, graphics processing applications, security applications, etc. For example, in some embodiments, the irrigation management application 114b′ and 114c′ comprises a browser application including code (e.g., HTML) and/or scripts (e.g., JavaScript) downloaded from the irrigation management application 114a and executed via the browser application that runs on the respective ones of the computing devices 118 and the mobile devices 120a. When the browser application executes the received code (e.g., HTML) and/or scripts (e.g., JavaScript) downloaded from the irrigation management application 114a, the browser application and the downloaded code/scripts together function as the irrigation management application 114b′, 114c′ of the remote computer 118 and mobile device 120a to display a user interface for the user.

In some embodiments, the software of the irrigation management application 114a, 114b, 114c can be a dedicated application (e.g., an application specific to irrigation management functions) or a general application that can provide or support irrigation management functions as well as other operating system and other non-irrigation management functions. In some embodiments, the irrigation management application 114a, 114b, 114c is an add-on application that is installed on one or more of the electronic devices 112, 118, and 120a, 120b, respectively, and that cooperates with and/or is integral to other application/s of the electronic devices 112, 118, 120a, 120b such as the operating system and works with the other application/s to provide the functionality described herein. And in some embodiments, the irrigation management application 114b, 114c can comprise an application configured to link a browser application to a remote computer device (central computer 112, 112a) or server (cloud-based server 112b) configured to provide signaling (code and/or scripts) to cause the browser application to display the user interface. In other words, the irrigation management application 114b, 114c can simply provide a link to a computer or mobile device supported website served by the central computer 112, 112a or the cloud-based server 112b, the website serving the user interface for the display at the remote computer 118 and/or mobile devices 120a, 120c.

With reference to FIG. 3, the general functionality of managing (e.g., monitoring and/or controlling) the irrigation system 116 is implemented via a central computer 112, which is connected to irrigation equipment at one or more sites of the irrigation system 116. The components of the irrigation system 116 are variable depending on the type of system and level of control needed. For example, the equipment of the irrigation system 116 may include various field control devices such as interface units 126, communication components/relays/switches (not shown), satellite controllers 130, encoder units 127 (i.e., a type of interface unit that outputs modulated commands on a two-wire path 131), decoders 128, station valves, master valves, sprinklers, emitters, sensors, pumps, pump stations, lighting devices, etc. Generally, one or more of the field components control operation of stations.

As used herein, a station (which may also be referred to herein as an “irrigation station”) is a controlled output of the irrigation system that corresponds to a physical component in the field. A station typically has binary states, such as on or off, but could further be a partially on/partially off state. An example “irrigation station” corresponds to a valve that is controlled, for example, using a latching or non-latching solenoid. The valve is typically in an off state (closed, not allowing water to flow therethrough) or an on state (open, allowing water to flow therethrough). When a given valve is open, water flows through the valve to one or more sprinkler devices in the fluid path downstream of the valve. In some cases, the valve is part of a “valve-in-head” sprinkler (such as a rotor) in which case there is a one-to-one relationship between valve (station) and the sprinkler. In some cases, the fluid path from the valve branches to one or more sprinklers is located separate from the valve. In any event, the controlled valve is typically referred to as an irrigation station. In the illustration of FIG. 3, each of the satellite controllers 130 may couple to and control multiple irrigation stations. And in FIG. 3, each of the decoders 128 may directly control one or more valves, such that a given decoder is coupled to and controls one or more irrigation stations. It is also known that other stations may be controlled by embodiments of the irrigation management application 114a. And it is known to use switches e.g., to control pumps, fountains, electrical lighting, and the like, such that the switches can each be considered a station being controlled by the irrigation management system.

In the embodiment illustrated in FIG. 3, the central computer 112 is coupled to the decoders 128 (which can be generically referred to as irrigation devices) via an encoder unit 127 at the site of the irrigation system 116, and is connected to the encoder unit 127 via the network 124 which can include direct wireline connections from the central computer 112 to the encoder unit 127. In some embodiments, the central computer 112 is owned and operated by the user or customer and has the irrigation management application 114a installed thereon. In certain aspects, the central computer 112 provides, via the software of the irrigation management application 114a, a user interface to the user that is at the central computer 112 (e.g., via a keyboard and display directly coupled to the central computer 112 or viewed by users at their respective remote electronic devices 118, 120a via irrigation management application 114a, 114b, 114b′, 114c, 114c′ running respectively thereon.

As will be described in more detail below, in some aspects, the irrigation management application 114a of the central computer 112 may generate, via the irrigation management application 114b, 114b′, 114c, 114c′ (e.g., a conventional application, mobile application, web browser application, etc.) a user interface for a user of the electronic device 118, 120a that permits the user to monitor the operational status of any component of the irrigation system 116 and to enter and/or modify various operational or informational parameters associated with any of the components of the irrigation system 116. For example, in one aspect, the user of an electronic device 118, 120a may enter a user-desired selections (e.g., run time schedule, irrigation station identifier, command to turn irrigation on/off, etc.) via the user interface of the irrigation management application 114b, 114b′, 114c, 114c′ accessible on the user's electronic device 118, 120a, and the entry is received by the central computer 112 and stored in its memory.

In some embodiments, the output signals corresponding to the inputs entered by a user of an electronic device 112, 118, 120a into a user interface generated by the respective irrigation management application 114a, 114b, 114b′, 114c, 114c′ are transferred by the central computer 112 to the field components. For example, in some embodiments, the central computer 112 sends on/off commands to the interface unit 126 to be passed to the appropriate satellite controller 130 to control the appropriate stations, or may be passed to the encoder unit 127 to be formatted into a command to be transmitted to the appropriate decoder 128 to control the appropriate one or more valve (irrigation station) controlled by the decoder 128. In some embodiments, the irrigation management application 114a at the central computer 112 transmits an irrigation schedule or an adjustment to an irrigation schedule to a given satellite controller 130 via the interface unit 126, the schedule stored and executed by the satellite controller 130. Notably, while the central computer 112 is shown in FIG. 3 as not being at the site of the irrigation system 116, in some aspects, the central computer 112 may be located at the site of the irrigation system 116. Such a central computer 112 may be a customer-owned computer with irrigation management application 114a installed thereon.

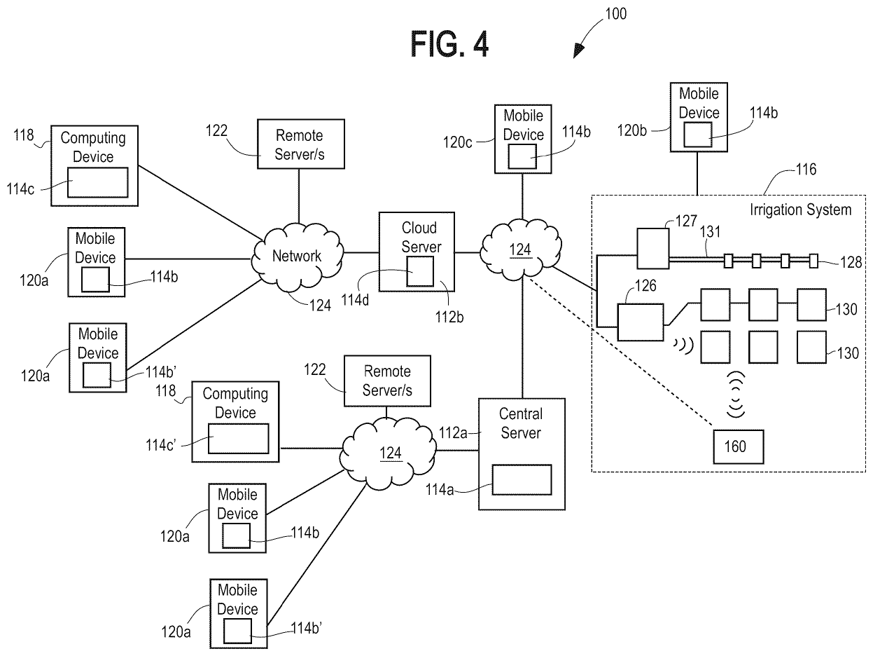

With reference to FIG. 4, in some embodiments, the central computer 112a is similar to the central computer 112 of FIG. 3 in that it is remote from the site of the irrigation system 116 and coupled to the irrigation system 116 by a network 124 (e.g., a wide area network). As also shown in FIG. 4, the irrigation management application 114d may be stored and executed by a cloud-based server 112b. In such embodiments, the cloud-based server 112b may be hosted by an irrigation company that provides irrigation control services (such as irrigation system monitoring, irrigation schedule creation, management and execution) from a remote central location to multiple different users or customers via remote computing devices 118 and/or mobile devices 120a for their respective irrigation systems at their respective sites. As shown in FIG. 4, the cloud-based server 112b is communicationally coupled to the devices at the site of the irrigation system 116 via the network 124 similar to how the central computer 112a is communicationally coupled to the devices at the site of the irrigation system 116.

In some embodiments, the cloud-based server 112b is owned and operated by the user or customer and has irrigation management application 114d installed thereon. In some embodiments, the functionality of monitoring and/or controlling the irrigation system 116 is implemented via the cloud-based server 112b. For example, the cloud-based server 112b may provide a user interface via the irrigation management application 114b, 114b′, 114c, 114c′ to the user that is viewed by the user at the user's remote computing device (e.g., computer) 118 and/or mobile device 120a. Using the irrigation management application 114b, 114b′, 114c, 114c′, the user of a remote computer 118, mobile devices 120a may enter a user-desired operational attribute selections (e.g., pause irrigation, restart irrigation, turn irrigation station on/off, etc.), and these selections are received by the cloud-based server 112b and may be stored in its memory. The output signals from the cloud-based server 112b are communicated to the field devices at the site of the irrigation system 116.

In some embodiments, similar to that described in FIG. 3, the irrigation management application 114b, 114c shown in FIG. 4 can be a dedicated application (e.g., an application specific to irrigation management functions), or a general application that can provide or support irrigation management functions as well as other operating system and other non-irrigation management functions. And in some embodiments, the irrigation management application 114b′ and 114c′ can be a browser-based application that is native to an operating system of the remote computer 118 or mobile device 120a or downloaded to and installed on the remote computing device 118 or mobile device 120a. When the browser-based application receives code (e.g., HTML) and/or scripts (e.g., JavaScript) downloaded from the irrigation management application 114a or 114d, the browser-based application and the downloaded code/scripts together function as the irrigation management application 114b′, 114c′ to display a user interface at the remote computing device 118 and mobile device 120a. And in some embodiments, the irrigation management application 114b, 114c can comprise an application configured to link a browser application to a remote computer device (central computer 112, 112a) or server (cloud-based server 112b) configured to provide signaling (code and/or scripts) to cause the browser application to display the user interface. In other words, the irrigation management application 114b, 114c can simply provide a link to a computer or mobile device supported website served by the central computer 112, 112a or the cloud-based server 112b, the website serving the user interface for the display at the remote computer 118 and/or mobile devices 120a, 120b.

Also as shown in FIGS. 3 and 4, in some embodiments, the irrigation management application 114b of the mobile device 120b can be configured to provide irrigation management functionality directly to one or more of the components of the irrigation system 116 at the site. For example, the mobile device 120b can be configured to communicate wirelessly and directly to one or more of the encoder units 127, the decoder 128, the interface unit 126 and the satellite controllers 130. For example, one or more of these devices may include an integrated or removably connectable transceiver to communicate with the mobile device 120b. In such embodiments, the mobile device 120b may communicate directly to these devices without first communicating to the irrigation management application 114a or 114d. Also shown in FIG. 4, in some embodiments, the irrigation management application 114b of mobile device 120c can directly communicate with one or more of the field devices via the network 124 without first communicating to the irrigation management application 114a on the central server or the irrigation management application 114d on the cloud-based server 112b.

Generally, users can access features of the irrigation management application 114a at the central computer 112, 112a and/or at the remote electronic devices 118, 120a, e.g., to manage the irrigation system 116 by checking the status of various components of the irrigation system 116, sending commands to various components of the irrigation system 116, making programming changes associated with various components of the irrigation system 116, viewing reports/status/alerts in connection with various components of the irrigation system 116, and so on. In some embodiments, the irrigation management application 114a, 114b, 114c, 114d can communicate with remote servers 122, for example, map servers to obtain map information and/or imagery, weather servers, to obtain rainfall, humidity and other weather-related information that can be used by the irrigation management application 114a-114d to adjust watering schedules of the irrigation system 116.

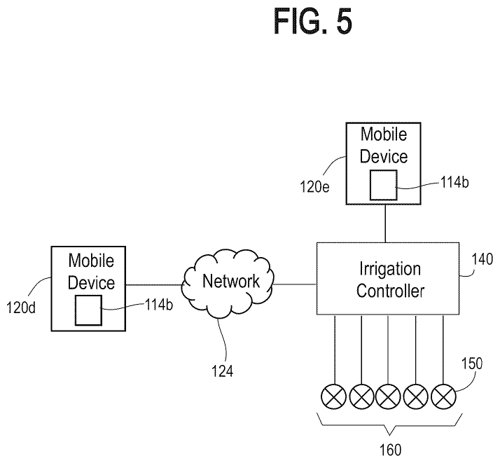

Referring next to FIG. 5, in some embodiments, the irrigation management application 114b permits mobile devices 120d and 120e to communicate with an irrigation controller 140 directly or via a network 124 without communicating via any central computer 112, 112a, or via the cloud-based server 112b. For example, in some embodiments, the irrigation controller 140 is a stand-alone controller or irrigation control unit that is independent of or not part of a larger central control system. In other words, as shown in FIG. 5, a user of the mobile device 120d, 120e may use the irrigation management application 114b to monitor and/or control various aspects of the status and/or operation of one or more stations 150 via various user interfaces. In this illustrated embodiment, the stations 150 connected to the irrigation controller 140 are irrigation stations (e.g., valves that control the flow of water to one or more sprinkler device fluidly connected to valves).

With continued reference to FIG. 5, in some embodiments, the network 124 used by the mobile device 120d may be any local or wide area network and can include a cellular network, a local wireless network (e.g., a Wi-Fi network), and so on. And in some embodiments, the mobile device 120e may communicate with an integrated or removably connected transceiver of the irrigation controller 140 (e.g., using Bluetooth or other direct wireless connection). It is understood that the irrigation controller 140 can be any irrigation control device, such as a station-based controller, decoder-based controller, a decoder, wireless valve/rotor, and so on.

Also, as shown in FIGS. 3-5, in some embodiments, the functionality of managing (e.g., monitoring and/or controlling) the irrigation system 116 is implemented via software stored on or accessible by the mobile electronic device 120a-120e, such as a mobile application version of the irrigation management application 114b and/or a browser that works together with the irrigation management application 114a, 114d. In some embodiments, the browser function executing commands and code received from the irrigation management application 114a, 114d can be referred to as an irrigation management application 114b′, 114c′.

As shown in FIGS. 3-5, the irrigation management application 114b can be an iOS or Android-based irrigation management application (or app) installed on the mobile device 120a-120e and is configured to wirelessly communicate via the network 124 with one or more of the central computer 112, 112a, cloud-based server 112b, and/or with components of the irrigation system 116 in the field. In such case, a mobile application (mobile app) 114b of the mobile devices 120a-120e provides a user interface to the user on a display screen of the mobile device to allow the user to monitor and/or control various aspects of the irrigation system 116. In some embodiments, the mobile device 120a-120e can transmit wireless signals to one or more of the central computer 112, 112a, cloud-based server 112b to provide the signaling to the components of the irrigation system 116 to implement various operational attribute adjustments and/or control commands to one or more components of the irrigation system 116.

It is noted that in some embodiments, at least portions of the irrigation management application is stored in the memory of different devices in the system such that the irrigation management application is distributed between various devices, e.g., the central computer 112, 112a, cloud-based server 112b, the remote computers 118 and the mobile devices 120a-120c. Further, in some embodiments, the irrigation management application at the remote computer 118 and/or mobile devices 120 comprises a browser application configured to display the user interface based on signaling received from a remote computer device or server in order to provide irrigation management functionality to the user via the user interface.

In some embodiments, as shown in FIG. 4, some components of the irrigation system 116 may be part of a local wireless network, such as a LoRaWAN network including a LoRaWAN gateway 160 that is in communication with the network 124. For example, one or more local controllers, sensors, actuators of the irrigation system 116, may include a LoRa transceiver and communicate using LoRa radio technology (over ISM bands) with the LoRaWAN gateway 160. As is known, a LoRaWAN gateway can communicate using LoRaWAN to devices within 1000-5000 meters. A typical LoRaWAN gateway 160 can communicate with the network 124 using cellular, WiFi, etc.). In some cases, a LoRaWAN server which is part of the cloud can be used to implement LNS server functionality for the LoRaWAN gateway 160. Accordingly, in some embodiments, any of the various computers, servers, controllers, mobile devices, and so on, may communicate with LoRaWAN-based devices at the site via the LoRaWAN gateway 160.

With reference to FIG. 6, an exemplary computing device (e.g., computer 112, 118) configured for use with exemplary systems and methods described herein may include a control circuit 320 electrically coupled via a connection 322 (e.g., a bus, etc.) to a memory 324 and via a connection 326 (e.g., a bus, etc.) to a power supply 328. In some embodiments, the control circuit 320 is a programmable processor (e.g., a microprocessor or a microcontroller). And in some embodiments, the control circuit 320 can comprise a fixed-purpose hard-wired platform or can comprise a partially or wholly programmable platform, such as a microcontroller, an application specification integrated circuit, a field programmable gate array, and so on. These architectural options are well known and understood in the art and require no further description.

The control circuit 320 can be configured (for example, by using corresponding programming stored in the memory 324 (such as the irrigation management application) as will be well understood by those skilled in the art) to carry out one or more of the steps, actions, and/or functions described herein. In some embodiments, the memory 324 may be integral to the control circuit 320 or can be physically discrete (in whole or in part) from the control circuit 320 and may be configured to non-transitorily store the computer instructions that, when executed by the control circuit 320, cause the control circuit 320 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM)) as well as volatile memory (such as an erasable programmable read-only memory (EPROM))). Accordingly, the memory 324 may be referred to as a non-transitory medium or non-transitory computer readable medium.

The control circuit 320 of the computing device may be also electrically coupled via a connection 330 to an input/output 332 that can receive signals from other devices, for example, the central computer 112, 112a, cloud-based server 112b, one or more mobile devices 120, remote server 122, etc., and/or from another electronic device of the system 100 or in communication with the system 100. The input/output 332 of the computing device can also send signals to other devices, for example, interface units 126, encoder units 127, etc.

The control circuit 320 of the exemplary computing device shown in FIG. 6 may be electrically coupled via a connection 334 to a user interface 336, which may include a visual display or display screen 337 (e.g., LED screen) and/or button input 339 that provide the user interface 336 with the ability to permit a user of the computing device to user the irrigation management application 114a to monitor and/or control the irrigation system 116 by inputting menu selections and/or commands via touch-screen and/or button operation and/or voice commands as will be described in more detail below. It will be appreciated that the performance of such functions by the control circuit 320 of the computing device may not be dependent on a human operator, and that the control circuit 320 of the computing device may be programmed to perform such functions without a human operator. In some embodiments, the user interface 336 is integral with the other components of the computing device, e.g., the computing device is a laptop computer with a display screen 337 and inputs 339 (e.g., keyboard, mousepad). And in some embodiments, the user interface 336 is separated from the other components of the computing device, e.g., the computing device is a desktop or tower computer to which the display screen 337 and inputs 339 (e.g., keyboard/mouse) are connected.

With reference to FIG. 7, an exemplary server (e.g., cloud-based server) 112b configured for use with exemplary systems and methods described herein may include a control circuit 340 electrically coupled via a connection 342 (e.g., a bus, etc.) to a memory 344 and via a connection 346 (e.g., a bus, etc.) to a power supply 348. As noted above, the control circuit 340 can comprise a fixed-purpose hard-wired platform or can comprise a partially or wholly programmable platform, such as a microcontroller, an application specification integrated circuit, a field programmable gate array, and so on.

The control circuit 340 can be configured (for example, by using corresponding programming stored in the memory 344 as will be well understood by those skilled in the art) to carry out one or more of the steps, actions, and/or functions described herein. In some embodiments, the memory 344 may be integral to the processor-based control circuit 340 or can be physically discrete (in whole or in part) from the control circuit 340 and may be configured to non-transitorily store the computer instructions that, when executed by the control circuit 340, cause the control circuit 340 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM)) as well as volatile memory (such as an erasable programmable read-only memory (EPROM))). Accordingly, the memory 344 may be referred to as a non-transitory medium or non-transitory computer readable medium.

The control circuit 340 of the server may be also electrically coupled via a connection 350 to a network interface 352 that can receive signals from, for example, the central computer 112/112a, mobile device 120, cloud-based server 112b, remote server 122, etc., and/or from another electronic device of the system 100. The input/output 332 of the computing device 118 can also send signals to other devices, for example, interface units, encoder units 127, etc.

The control circuit 340 of the exemplary server shown in FIG. 7 may be electrically coupled via a connection 353 to a UI interface 354 that provides a user of the server with the ability to run the irrigation management application 114d to monitor and/or control the irrigation system 116 as will be described in more detail below. It will be appreciated that the performance of such functions by the control circuit 340 of the server may not be dependent on a human operator, and that the control circuit 340 of the server may be programmed to perform such functions without a human operator.

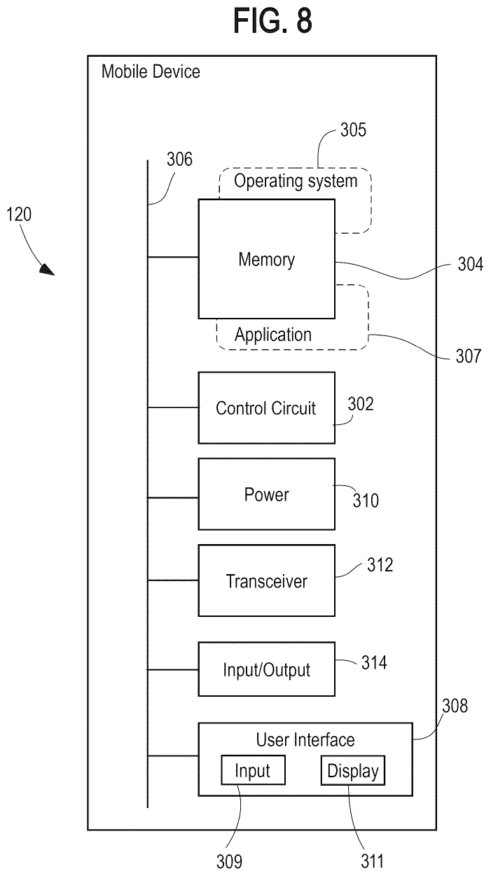

FIG. 8 is a block diagram of a mobile device 120 (e.g., example mobile devices 120a-120e), according to some embodiments. The mobile device 120 may be used for implementing any of the functionalities described herein. By way of example, the mobile device 120 may comprise a control circuit 302 (e.g., processor), memory 304, and at least one communication bus 306 (e.g., links, paths, interconnections, or the like). Some embodiments may include one or more internal and/or external power sources or supplies 310. The control circuit 302 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, etc. Further, in some embodiments, the control circuit 302 can be part of control circuitry and/or a control system, which may be implemented through one or more processors with access to one or more memory 304 that can store commands, instructions, code and the like that is implemented by the control circuit 302 and/or processors to implement intended functionality. In some applications, the control circuit 302 and/or memory 304 may be distributed over a communications network (e.g., LAN, WAN, Internet) providing distributed and/or redundant processing and functionality.

In one embodiment, the memory 304 of the mobile device 120 stores data and executable code, such as an operating system 305 and an application 307. The application 307 is configured to be executed by the mobile device 120 (e.g., by the control circuit 302). The application 307 can be a dedicated application (e.g., an application dedicated to monitoring and/or controlling an irrigation system 116), a general-purpose application (e.g., a web browser, etc.), and/or a dedicated application linking a general-purpose application such as a browser to a user interface transmitted by a central computer or remote server. Accordingly, the application 307 is representative of all types of applications that may be resident on or run by the mobile device 120 (e.g., software preinstalled by the manufacturer of the mobile device, software installed by an end user (which may be a mobile app or an internet browser app), software installed by a vendor (e.g., irrigation company), etc.).

In one embodiment, the application 307 operates in concert with the operating system 305 when executed by the control circuit 302 to cause actions to be performed by the mobile device 120. For example, with respect to the disclosure contained herein, execution of the application 307 by the processor of the control circuit 302 causes the mobile device 120 to perform actions consistent with the managing (e.g., monitoring and/or controlling) of the irrigation system 116. In some embodiments, the application 307 includes at least a part of the irrigation management application referred to herein. And in some embodiments, to the extent a browser function which is part of the application 307 or the operating system 305 in receiving commands, code (Java Script) and data to provide a user interface, such browser function can be considered part of the irrigation management application referred to herein.

The user interface 308 of the mobile device 120 can allow a user to interact with the system 100 and receive information through the system 100. In some instances, the user interface 308 includes a display device 311 (e.g., display screen, etc.) and/or one or more user input device 309 (e.g., buttons, touch screen, track ball, keyboard, mouse, etc.), which can be a part of, or wired, or wirelessly coupled with the mobile device 120. In the embodiment shown in FIG. 8, the mobile device 120 further includes one or more communication interfaces, ports, and/or transceivers 312 and the like, allowing the mobile device 120 to communicate over a communication bus, a distributed computer and/or communication network (e.g., a local area network (LAN), wide area network (WAN), etc.), other wired or wireless networks or communication channels with other devices and/or other such communications or combination of two or more of such communication methods.

Further, the transceiver 312 can be configured for wired, wireless, optical, fiber optical cable, satellite, or other such communication configurations or combinations of two or more of such communications. Some embodiments include one or more input/output (1/O) ports 314 that allow one or more devices to couple with the mobile device 120. The I/O ports 314 can be substantially any relevant port or combinations of ports, such as but not limited to USB, Ethernet, or other such ports. The I/O ports 314 can be configured to allow wired and/or wireless communication coupling to external components. For example, the I/O ports 314 can provide wired communication and/or wireless communication (e.g., Wi-Fi, Bluetooth, LoRa, LoRaWAN, cellular, RF, and/or other such wireless communication), and in some instances may include any known wired and/or wireless interfacing device, circuit and/or connecting device, such as but not limited to one or more transmitters, receivers, transceivers, or combinations of two or more of such devices.

The mobile device 120 is an example of a control and/or processor-based system with a control circuit 302. Again, the control circuit 302 can be implemented through one or more processors, controllers, central processing units, logic, software and the like. Further, in some implementations the control circuit 302 may provide the processor functionality. The memory 304, which can be accessed by the control circuit 302, typically includes one or more processor-readable and/or computer-readable media accessed by at least the control circuit 302, and can include volatile and/or nonvolatile media, such as RAM, ROM, EEPROM, flash memory and/or other memory technology. Further, while the memory 304 is shown as internal to the mobile device 120, the memory 304 can be internal, external or a combination of internal and external memory. The external memory can be substantially any relevant memory such as, but not limited to, solid-state storage devices (SSDs) or drives, hard disk drives (HDDs), one or more of universal serial bus (USB) stick or drive, flash memory secure digital (SD) card, other memory cards, and other such memory or combinations of two or more of such memory, and some or all of the memory may be distributed at multiple locations over a computer network. The memory 304 can store code, software, executables, scripts, data, content, lists, programming, programs, log or history data, user information, irrigation system information, and the like. While FIG. 8 shows various components being coupled together via a bus 306, it is understood that the components may actually be coupled to the control circuit 302 and/or one or more other components directly.

The following description relates to various user interface (UI) and programming features provided by the software of irrigation management application 114a-114d, which, as mentioned above, can be installed on and executed by, for example, a central control computer/server, a cloud-based server, a stand-alone computing device (e.g., desktop, laptop, etc.), and a mobile device (e.g., a mobile phone, tablet, etc.) using an irrigation application.

Generally, an encoder may receive an input AC signal from an external source and transforms it into a voltage level suitable for the two-wire path and to power the devices. For example, the controller 10 of FIG. 1 may receive a 120 VAC signal, and use a step-down transformer to convert it into a 24 VAC waveform suitable to power the various decoders. The 24 VAC waveform may then be modulated using amplitude modulation by clipping certain portions of the wave. For example, if the first half of a full wave is clipped (amplitude is lowered), this may be interpreted as a logic “1”, whereas if it is unclipped, it may be interpreted as a logic “0”. It is known to vary the amplitude of the waveform in a variety of ways to encode data on the waveform.

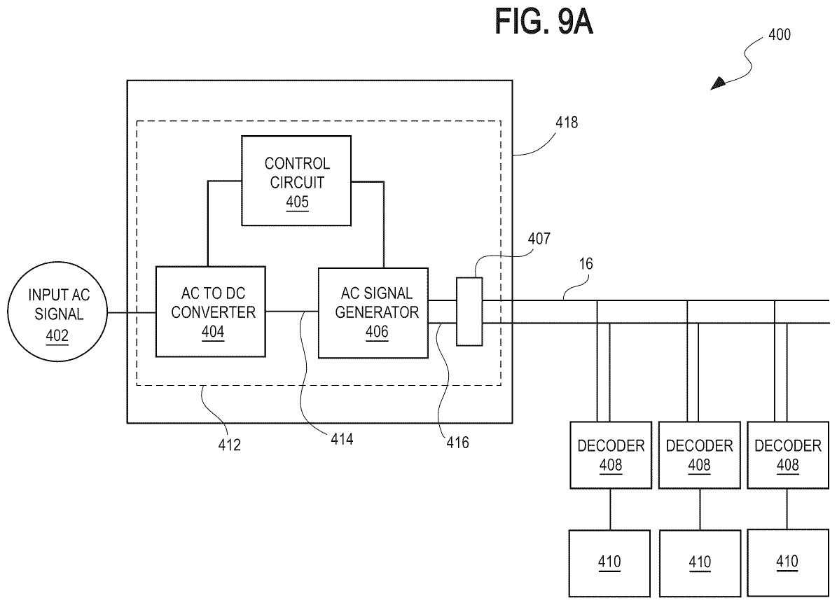

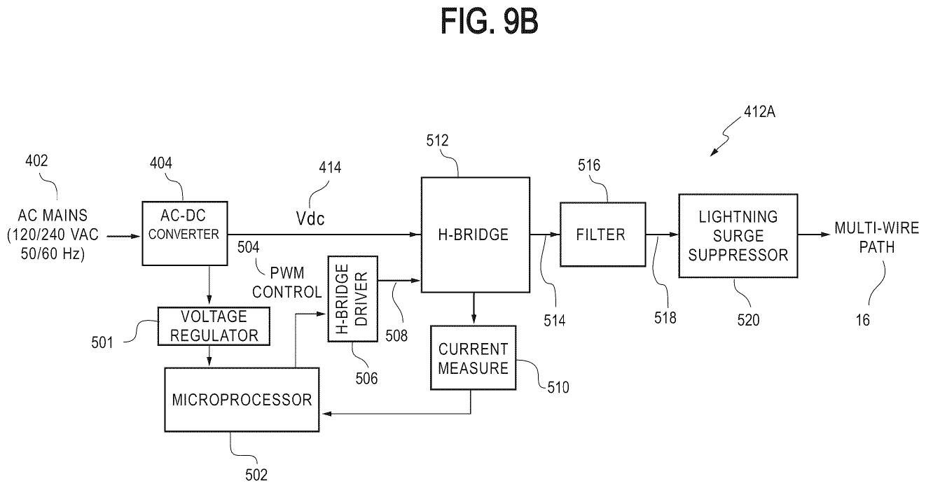

Referring to FIGS. 9A and 9B, an exemplary irrigation control device for a decoder-based system such as an encoder 412 receives an input AC signal 402 and first converts it to a DC signal 414 using an AC to DC converter 404 in some embodiments. Next, the encoder 412 creates a new AC waveform using the DC signal 414 and a pulse width modulated (PWM) signal 504 provided by a microcontroller 305. The PWM signal 504 causes transistors of an H-bridge 512 receiving the DC signal 414 to switch in a manner to create new AC waveform that is modulated with the data. This approach of breaking down the input AC signal 402 into a known DC signal 414 allows any AC source (there are different AC power standards in the US and other countries) to be connected, and removes any issues with inconsistent voltage levels or frequency in the received signal or accidental connection to an AC source that is too high. Thus, regardless of the input AC signal, a consistent AC waveform is created that has the same peak to peak voltage and desired frequencies. Additionally, the PWM signal 504 modulates data on the waveform as it is being created. The encoder 412 modulates the frequency of the waveform on a cycle-by-cycle basis. That is, the encoder 412 causes given cycles of the waveform to be one of two frequencies (i.e., 60 Hz and 80 Hz). In FIG. 9B, two successive cycles having a frequency of 60 Hz are interpreted as a logic “1” and two successive cycles having a frequency of 80 Hz are interpreted as a logic “0”. Generally, in communications, such frequency modulation between two or more frequencies is referred to as frequency shift keying (FSK).

In some embodiments, circuits, systems and methods are provided to produce an output AC signal for the multi-wire path, and an input power signal is converted into a DC voltage, which is used to generate an AC signal modulated with data. With reference to FIG. 9A, a simplified block diagram is shown of an exemplary irrigation system 400 that includes an irrigation control unit 418 including an encoder (encoder circuit) that generates an AC signal that is applied to the multi-wire path 16. By one approach, the irrigation control unit 418 includes an encoder 412 having an AC to DC converter 404, a control circuit 405 and an AC signal generator 406. In some aspects, an input AC power signal 402 is coupled to the AC to DC converter 404 which outputs a DC voltage 414. In one configuration, the input AC signal 402 may be a 120 VAC signal and/or 240 VAC signal at 50 Hz and/or 60 Hz. It is understood that the characteristics of the input AC signal 402 will depend on the power source and can have any suitable voltage level and frequency. It is further understood that the input AC signal 402 may be a power signal input into the irrigation control unit 418 (e.g., from the wall) or may be a stepped down or transformed power signal. The DC voltage 414 output by the AC to DC converter 404 is input to the AC signal generator 406. For example, the DC voltage may be at any suitable level, such as at 24, 40, 48 volts DC. The value of the DC voltage will vary depending on the requirements of the system.

The AC to DC converter 404 is coupled to a control circuit 405 which is also coupled to the AC signal generator 406. The control circuit 405 is a processor-based device including one or more processors, and operates with one or more integrated or connected memories. The control circuit 405 and the memory may be integrated together, such as in a microcontroller, application specification integrated circuit, field programmable gate array or other such device, or may be separate devices coupled together. Generally, the control circuit 405 can comprise a fixed-purpose hard-wired platform or can comprise a partially or wholly programmable platform. These architectural options are well known and understood in the art and require no further description here. And generally, the control circuit 405 is configured (for example, by using corresponding software and/or firmware programming as will be well understood by those skilled in the art) to carry out one or more of the steps, actions, and/or functions described herein. For example, in some embodiments, the control circuit 405 controls operation of the encoder 412 and/or the irrigation control unit 418, and outputs signaling to the AC signal generator 406 to control the waveform of the output AC signal 416 provided to the multi-wire path 16.

In some embodiments, under control by the control circuit, the AC signal generator 406 creates a modulated output signal having any desired signal characteristics or modulation technique. The output AC signal 416 is coupled to the multi-wire path 16 at a multi-wire path connector or multi-wire path interface 407. In some aspects, the output AC signal 416 provides operational power to the irrigation devices (e.g., decoders 408, each having unique device addresses) coupled to the multi-wire path 16, in such case, the output AC signal may also be referred to as an AC power signal. In some embodiments, the output AC signal 416 is modulated with data but does not provide operational power, i.e., the devices connected to the multi-wire path receive their operational power in other ways, such as through battery power or connection to a different power supply.

One or more irrigation devices are connected to the multi-wire path 16 at various locations about the length of the multi-wire path 16. As shown in FIG. 9A, these irrigation devices are shown as decoders 408 (which may also be referred to as demodulators). The decoders 408 derive operational power from the received signal and decode the data from the signal to determine if they are addressed and receive and execute any received commands. Depending on the signaling output from the control circuit 405, the output AC signal 416 provided by the AC signal generator 406 may be modulated in any number of ways. In some aspects, the output AC signal is one or more of amplitude, frequency, and phase modulated with data.

In some aspects, the output AC signal applied to the multi-wire path 16 is amplitude modulated by selectively clipping or attenuating portions of the signal waveform. Such output signals are described in more detail in U.S. Pat. No. 10,653,081, granted 4/29/2020, entitled “METHOD AND APPARATUS FOR PROGRAMMING A DECODER-BASED IRRIGATION CONTROLLER” (Docket No. 8473-142942-US), which is incorporated herein by reference. In some aspects, the output AC signal is frequency modulated. For example, in some embodiments, the AC signal generator 406 creates a signal in which the frequency of one or more cycles of the signal is selectively changed to modulate data bits on the signal, e.g., using a frequency shift keying modulation. For example, as controlled by the control circuit 405, the AC signal generator 406 selectively changes the frequency of each cycle of the AC signal (at the start of each cycle) to one of two or more values, e.g., 55 and 65 Hz, thereby outputting a modulated output AC signal 416 over the multi-wire path 16. In some aspects, the decoders 408 determine whether each cycle is at 55 Hz and/or 65 Hz to extract the corresponding 1 or 0 data bit. For example, by using frequencies close to 60 Hz, the modulated signal may power the decoders 408 and any connected irrigation components 410, such as latching or non-latching solenoids, sensors, and so on. In some aspects, the output AC signal having been frequency modulated inherently provides a balanced waveform that does not need a negative bias, and thus, is immune to galvanic corrosion on the transmission medium.

In some aspects, the output AC signal is phase modulated. For example, in some aspects, the AC signal generator 406 may create a signal in which the phase of one or more cycles of the signal is selectively changed to modulate data bits on the signal. For example, as controlled by the control circuit 405, the AC signal generator 406 selectively changes the phase of each cycle of the AC signal (at the start of each cycle) to be in phase or out of phase thereby outputting a modulated output AC signal 416 over the multi-wire path 16. Further details are described in U.S. Pat. No. 10,228,711, granted Feb. 20, 2019, entitled “DECODER SYSTEMS AND METHODS FOR IRRIGATION CONTROL,” which is incorporated herein by reference in its entirety.

Referring next to FIG. 9B, an exemplary irrigation control device such as an encoder 412A of an irrigation control unit using an H-bridge is shown. In some embodiments, the encoder 412A may use any switching amplifiers, such as the H-bridge. In some implementations, the encoder 412A includes an H-Bridge circuit 512, an H-Bridge driver 506, a filter circuit 516 and a surge suppressor circuit 520 (lightning surge protector). In some implementations, the encoder 412A includes the AC to DC converter 404, a voltage regulator 501, and a microprocessor 502 (an example of the control circuit 405). The encoder 412A may include a current measure circuit 510. The AC to DC converter 404 provides the DC voltage 414 to the H-Bridge circuit 512. The regulator 501 couples to the AC to DC power supply and provides operational DC power to the microprocessor (microcontroller) 502. In some aspects, the microprocessor 502 outputs a Pulse Width Modulation (PWM) signal 504 to the H-Bridge driver 506 which drives the H-bridge circuit 512 to produce an AC signal 514 which is smoothed by the filter circuit 516 to provide the output AC signal 518 for the multi-wire path 16. The lightning surge suppressor circuit 520 is provided to protect the encoder 412A from lightning strikes or other surges on the multi-wire path 16. In FIG. 9B, the H-Bridge driver 506, the H-Bridge circuit 512 and the filter circuit 516 form one embodiment of the AC signal generator of FIG. 9A.

The encoder 412A may include a current measure circuit 510 coupled to the H-Bridge circuit 512 that can sense and measure the current being drawn by devices on the multi-wire path 16, e.g., in order to detect whether a decoder instructed to draw power to open a valve has in fact done so (i.e., did the solenoid turn on), and/or to detect data bits transmitted by the decoders through selectively altering the amount of current consumed by the decoders. The current measure circuit 510 provides an output to the microcontroller 502. Other details are described, for example, in U.S. Publication No. 2024/0180092, entitled AUTO-DETECTION OF DEVICES ON A MULTI-WIRE IRRIGATION CONTROL SYSTEM AND AUTO-ASSIGNMENT OF RECEIVERS TO IRRIGATION ZONES, incorporated herein by reference in its entirety.

As shown in FIG. 9B, in some embodiments, the example encoder 412A includes a current measure 510 or current sense for diagnostics and to detect shorts in the connected multi-wire paths 16. In some aspects, the current measure 510 will include a resistor at the output of the H-bridge 512 connected to an operational amplifier. This allows the amount of current drawn from encoders 412A in use to be measured. This can be used to detect whether an encoder 412A instructed to draw power to open a valve has in fact done so (i.e., did the solenoid turn on), and/or to detect data bits transmitted by the encoders 412A through selectively altering the amount of current consumed by the encoders 412A. And if too much current is being drawn, if a short is detected. If a short is detected, the power to the multi-wire path 106 can be removed.

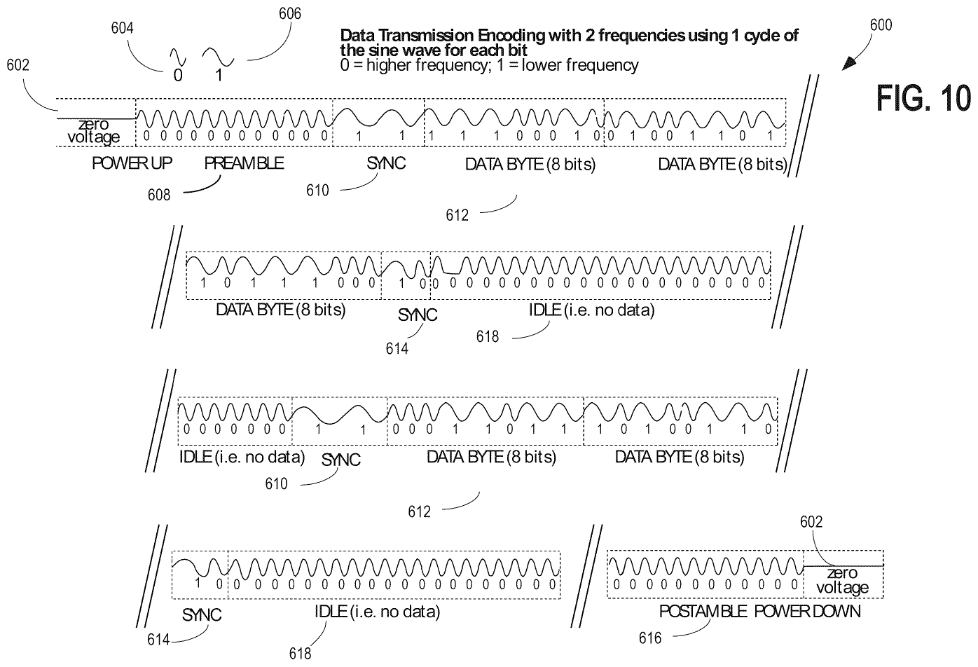

With reference to FIG. 10, an output power signal 600 is modulated with data by encoding each cycle of the output power signal with one of two frequencies to represent data bits. Each cycle of the output power signal is modulated to be either at a first frequency (see first cycle 604) or at a second frequency (see second cycle 606). As illustrated in FIG. 10, the first cycle 604 is at a higher frequency (the first frequency) than the second cycle 606 (the second frequency). Alternatively, in some embodiments, the second cycle 606 is at a higher frequency than the second cycle 606. As can be seen, in these embodiments, the first cycle 604 represents a logic 0 and the second cycle 606 represents a logic 1. In the example shown in FIG. 10, the signal protocol includes a preamble 608, a data sync portion 610, a data portion 612, an idle sync portion 614, an idle portion 618, and a postamble 616.

Notably, the decoder may not be powered on as shown in 602 where zero voltage is applied to the path. During the start of power/data transmission, the preamble 608 is sent as a number of the first cycles to provide the decoder and/or the irrigation devices time to power up and/or activate before it is time to decode data. Next, a sync portion 610 having a known sequence of modulated cycles is provided to indicate the start of data transmission. For example, in some embodiments, during a first period of time, one or more cycles of the waveform are modulated at one or more first frequencies to synchronize a start of the modulated data portion of the waveform. Next, the data portion 612 is provided that includes a series of cycles modulated as either cycle 604 or 606 to transmit data bits (and data bytes) to the decoder. For example, in some embodiments, during a second period, the output power signal is modulated such that one or more cycles of the output power signal are at one or more second frequencies to create the modulated data portion.

In some aspects, the second frequencies can be the same as the first frequencies, can have one or more frequencies in common or can be different frequencies. In some embodiments, the encoded data in the modulated data portion can represent one or more of a first instruction to activate one or more irrigation devices and a second instruction to deactivate the one or more irrigation devices. There may also be periods of no data transmission shown by the idle portion 618. In some embodiments, the period of time provided by the idle portion 618 is a period of time that the irrigation control unit 14 of FIG. 1 and/or the dedicated irrigation control unit 202 of FIG. 2 have allotted to receive a response from one or more decoders 18 and/or irrigation devices 206. For example, in some embodiments, there may be one or more periods within the modulated data portion where the output power signal is modulated such that one or more cycles of the output power signal are at one or more first frequencies to separate data content of the modulated data portion. If data transmission is to resume, another data sync portion 610 and data portion 612 are provided.

If no further data transmission is needed, the idle portion 618 is followed by the postamble 616, and then the signal is no longer applied to the multi-wire path. In some embodiments, the postamble 616 resembles the idle portion 618 with the exception of the data sync portion 610 that precedes the idle portion 618. For example, in some embodiments, the output AC signal is modulated such that one or more cycles of the output power signal are at the one or more first frequencies to synchronize an end of the modulated data portion of the output power signal. Given that each cycle of the power signal is modulated to one of two frequencies, the decoding circuitry need only detect the timing of zero crossings to determine the frequency of a given cycle, and thus, the data bit represented by the cycle. In some embodiments, one or more frequencies are used for modulating data in the data portion (e.g., the one or more second frequencies) and at least one different frequency is used in the portions of the waveform that serve to frame (sync and/or end) or separate the data portion. Further variations of frequency modulation of the output power signal are described in U.S. Pat. No. 11,357,181, granted 5-25-2022, entitled “DATA MODULATED SIGNAL GENERATION N A MULTI-WIRE IRRIGATION CONTROL SYSTEM” (Docket No. 8473-150383-US), which is incorporated herein by reference.

Generally, FIG. 10 shows that two exemplary cycles at a given frequency provide a logic level, and the encoder 412A uses multiple (e.g., three) successive cycles at 60 Hz to equate to a “1” and uses multiple (e.g., three) successive cycles at 80 Hz to equate to a “0”. Additionally, in some embodiments, Manchester encoding is used for error detection, sync signals are provided, and additional frequencies can be used to synchronization and other purposes. FIG. 10 shows an example signal format. Generally speaking, frequency modulation of the AC waveform results in a balanced waveform and is advantageous over amplitude modulation which can result in an unbalanced waveform that can lead to corrosion of the two-wire path.

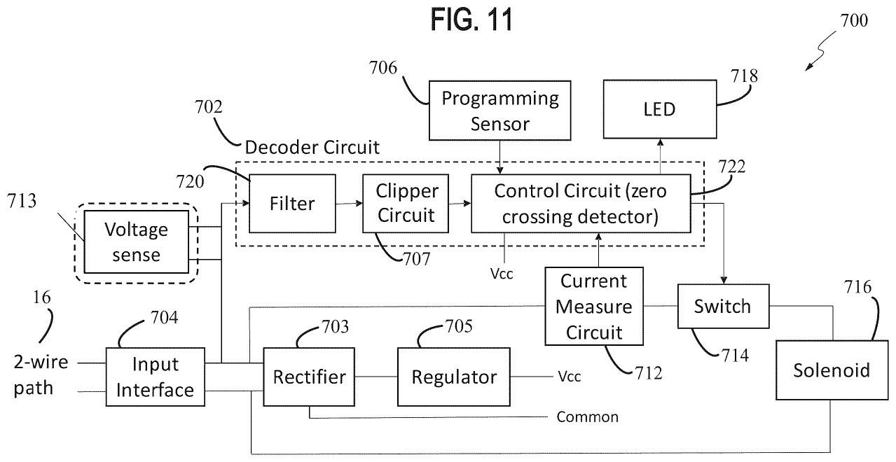

In FIG. 11, a simplified block diagram of an exemplary decoder unit 700 for an irrigation system that receives power and data from an irrigation control unit is shown. In some aspects, the exemplary decoder unit 700 includes an input interface 704 that couples to a multi-wire path 16 of a decoder-based irrigation control system and receives an output AC signal modulated with data and transmitted by an encoder 412A of an irrigation control unit 202 over the multi-wire path 16. In some aspects, to derive operational power for the decoder unit 700, the AC signal is rectified by a rectifier 703 and regulated by regulator 705 to provide a DC voltage. In some embodiments, the input interface 704 may include a terminal block, a coaxial connector, a pluggable connector, and a circular connector, among other types of commercially available connectors. In some embodiments, the input interface 704 comprises wires extending from the circuitry of the decoder unit 700 that are spliced or coupled to the multi-wire path 16. In some aspects, the output AC signal is modulated with data using one or more of amplitude, phase and frequency modulation, or any other known modulation techniques. In some aspects, the modulation of the output AC signal includes selective modulation of a frequency of one or more cycles of the output AC signal to have a selectable one of a plurality of frequencies.

In some aspects, the decoder unit 700 includes a switch 714 coupled to the input interface 704. In some aspects, the switch 714 may include a triode for alternating current (TRIAC) and/or other switching devices commercially available that is controllable by a control circuit, a processor, and/or a microcontroller. In some aspects, the switch 714 couples to a solenoid 716 of an irrigation device (e.g., a valve). In some aspects, the decoder unit 700 includes a decoder circuit 702 connected and/or coupled to the input interface 704 and including a control circuit 722. In some aspects, the control circuit 722 decodes the data from the received output AC signal input to the decoder circuit 702. It is understood that the circuitry and function of the decoder circuit can vary depending on the modulation of the output AC signal. In some aspects, the control circuit 722 determines, from the decoded data, that the irrigation device is to be activated. In some aspects, the control circuit 722 outputs a control signal to the switch 714 to cause the switch 714 to close and connect the output AC signal to the solenoid 716.

In some aspects, the decoder unit 700 includes a current measure circuit 712 coupled to the switch 714. The current measure circuit 712 may include an operational amplifier and a resistor. The current measure circuit 712 may measure a current of the output AC signal passing through the switch 714 and being drawn by the solenoid 716 and provides a first output signal including the measure of the current to the control circuit 722. In some aspects, the control circuit 722 determines, based on the measure of the current, whether the solenoid 716 is operating properly or whether a ground short condition exists. In some aspects, the decoder unit 700 includes a light emitting diode (LED) 718 (e.g., a multi-color LED), a programming sensor 706, and/or a voltage signal clipper circuit 707. In some aspects, the LED 718 may be mounted on a housing enclosing the decoder circuit 702, the switch 714, and/or the current measure circuit 712. In some aspects, the LED 718 illuminates when the control circuit 722 determines that the ground short condition exists.

A decoder circuit 702 may be coupled to the input interface 704. The decoder circuit 702 may include a filter 720 coupled to the input interface 704. In some aspects, the filter 720 filters the output AC signal. In some embodiments, the decoder circuit 702 includes a clipper circuit 707 coupled to an output of the filter 720. In some aspects, the clipper circuit 707 limits an amplitude of the filtered output AC signal. In some aspects, the clipper circuit 707 may include two diodes in series and/or one or more electronic components capable of clipping or attenuating portions of a signal waveform, for example, the output AC signal. In some aspects, the clipper circuit 707 may include two Zener diodes in series. The decoder circuit 702 may include a control circuit 722 that receives a filtered and clipped output AC signal from the clipper circuit 707. The control circuit 722 may be configured to (programmed to) detect zero crossings and timing of the zero crossings of the filtered and clipped output AC signal.

The control circuit 722 may determine a frequency of one or more cycles of the output AC signal. For example, the control circuit 722 can determine or distinguish the frequency of each cycle or group of cycles in the received waveform to decode data in the waveform. In some aspects, the control circuit 722 decodes the data modulated on the output AC signal based the frequency of multiple sets of the one or more cycles of the output AC signal. In some aspects, the control circuit 722 determines, from the decoded data, that the irrigation device is to be activated. In some aspects, the control circuit 722 outputs a control signal to the switch 714 to cause the switch 714 to close and connect the output AC signal to the solenoid 716.

Generally, as shown in FIG. 11, a decoder unit 700 decodes the data encoded on the AC waveform. In some embodiments, the decoder unit 700 includes a decoder circuit 702 having a filter 720, a clipper circuit 707 and a control circuit 722 with a zero-crossing detector. The filter 720 filters the modulated AC signal received at the input interface 704. In some aspects, the clipper circuit 707 limits an amplitude of the filtered AC signal (e.g., using a comparator with hysteresis). The control circuit 722 receives a filtered and clipped output AC signal and detects zero crossings and the timing of the zero crossings. This is used to determine the frequency of each cycle of the received AC signal. For example, the control circuit 722 can determine or distinguish the frequency of each cycle or group of three cycles in the received waveform to decode data in the waveform. If the received data indicates that the particular decoder unit 700 is to take action, such as to turn on its solenoid 716, the switch 714 is activated to switch the AC signal to the solenoid 716.

As shown in FIG. 11, the decoder unit 700 includes a current measure circuit 712 that is coupled to the switch 714. The current measure circuit 712 senses and provides output signals to the control circuit 722 (e.g., microcontroller) that are indicative of the current passing or flowing through the switch 714 and being drawn by the solenoid 716. These measurements may be used by the control circuit 722 to automatically determine if there is a ground short in the solenoid 716 or whether the solenoid is operating properly. For example, a short may be detected if the current drawn is above a threshold higher than the expected current draw. Also, an open circuit may be detected if the current drawn is below a threshold lower than the expected current draw. As also shown in FIG. 11, a voltage sense circuit 713 is coupled to the input interface 704 to measure the voltage of the received signal. In this way, it can be determined if sufficient voltage is received to power the solenoid. Due to corrosion and/or length of the wire and/or number of devices, the voltage of the AC signal may be too low for normal operation. This can be detected to diagnose line voltage issues. As also shown in FIG. 11, the decoder includes an LED 718 used as a status indicator. The LED is a multi-color indicator (green, blue, red). The LED 718 may illuminate solid green when the irrigation station coupled to the decoder unit 700 is on and has activated its solenoid 716. The LED 718 may be solid or flashing red when the irrigation station is on, but the solenoid 716 short is connected. The LED 718 may blink blue or green to indicate whether the decoder unit 700 is addressed or unaddressed. Since such decoder units 700 are typically installed in the field and buried or contained in a valve box, known decoder units 700 have no use for status indicators, but the decoder units 700 described herein advantageously provide a visible status indicator.

In decoder-based systems such as shown in FIG. 1, to be able to address and control many irrigation devices such as decoders 18 attached to the two-wire path 16, the controller 10 knows the unique addresses of the decoders 18 (which may be alternatively referred to herein as “irrigation devices”). Decoder addresses (which are also referred to herein as “irrigation device addresses) are typically a number of bits (e.g., 16 bits) assigned to the decoder 18 during manufacturing. The address can be represented in a barcode or QR code printed on a label on the side of the decoder 18. An installer will typically gather the decoders 18 to install (e.g., 50 decoders), and do one of the following: (1) hand write/type the addresses on paper or spreadsheet and manually enter the numbers in the controller; and (2) use a barcode (or other optical) scanner at the controller to scan the addresses into the controller. These approaches can be tedious and prone to user errors (writing/typing address and then entering them into a controller with a very limited user interface, i.e., a few buttons and display screen) and/or require that all decoders be brought to the location of the controller before they can be installed in the field.

Conversely, in some embodiments, one approach allows an installer to connect the various decoders in the field at the desired locations, and then activate an auto-address discovery process executed by the controller. In some aspects, the controller runs an algorithm to discover/learn the addresses of all connected decoders. This approach is advantageous at least in that it eliminates or reduces the need for the installer to enter or scan addresses.

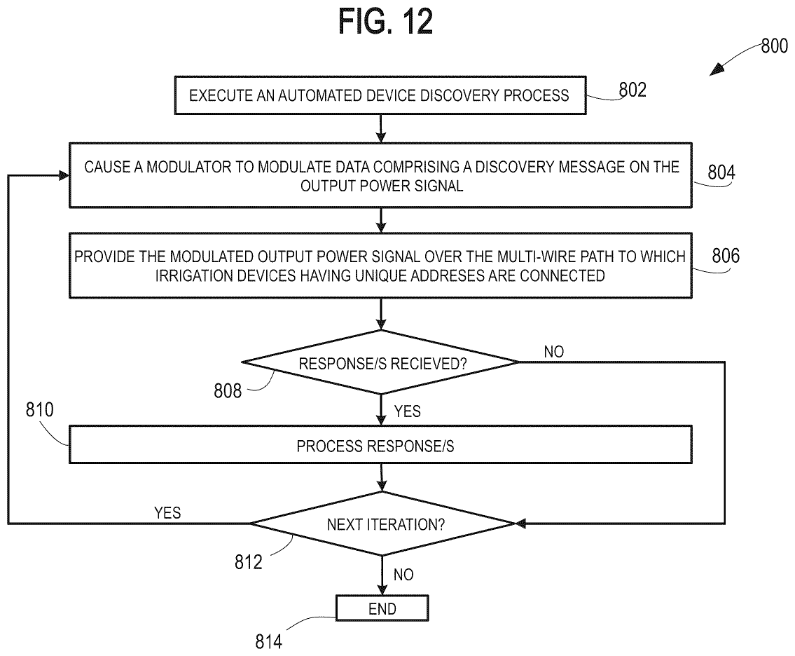

Referring next to FIG. 12, a flow diagram is shown of an exemplary process 800 of automatic discovery of addresses of irrigation devices in accordance with some embodiments. Initially, an automatic or automated device discovery process is initiated (Step 802). For example, the process is automatically initiated according to control programming, and/or the process is initiated by a user via user input via a user interface. In some embodiments, the functionality of the process 800 is implemented through the execution of computer program code by a control circuit. For example, a control circuit or microcontroller executes the computer program code (e.g., as firmware) to execute the discovery process. In some embodiments, the code is stored in internal memory of the control circuit, and in other embodiments, the code is stored in a separate memory accessible by the control circuit to retrieve and execute. In some embodiments, the control circuit is part of an irrigation control unit (e.g., irrigation control unit 14, 202, etc.) and/or part of a computer 12 (e.g., a computer, server, mobile computer device, smart phone, tablet computer, and so on) functioning at least in part as an irrigation control unit.

In some embodiments, the control circuit is coupled to and controls a modulator (e.g., the signal generator 406 of FIG. 9A that provides a modulated output power signal to a multi-wire interface 407). In some aspects, the multi-wire interface 407 is configured to be electrically coupled or connected to the multi-wire path 16 that extends into a landscape and to which irrigation devices are connected. In some embodiments, each irrigation device has a unique address and derives operational power from the output power signal and demodulates the data. And in some embodiments, a purpose of the automatic device discovery process is to discover or find the unique addresses of the irrigation devices connected to the multi-wire path without requiring addresses to be manually recorded and entered in the control unit or optically scanned and transferred to the control unit. Once initiated, the modulator is caused (e.g., by the control circuit) to modulate data comprising a discovery message on the output power signal (Step 804). In some aspects, the control circuit is coupled to and causes the modulator to modulate the output power signal. In some aspects, the discovery message indicates a portion of an address to match and prompts a response from one or more of the irrigation devices in which a corresponding portion of the unique address matches the portion of the address to match. In some aspects, unique addresses need only be unique for a particular installation or multi-wire path, and need not be globally unique across all installations.

With reference to FIG. 12, the output power signal is provided or output over the multi-wire path (Step 806). Next, it is determined if one or more responses to the discovery message are received from one or more irrigation devices connected to the multi-wire path (Step 808). In some configurations, if a response is not received, the control circuit determines if another iteration of the discovery message is needed (Step 812). If another iteration is needed (Step 812), then the control circuit causes the modulator to modulate a next iteration of the discovery message on the output power signal (Step 804). If another iteration is not needed (Step 812), this indicates that unique addresses have been found for all devices connected to the multi-wire path and the process ends (Step 814). Step 814 will typically occur after multiple iterations depending at least on the number of devices connected and the address space to search. If response/s is/are received in Step 808, the response/s is/are processed (Step 810), e.g., to determine additional devices with matching address portions and to assist in determining a next portion of an address to match for the next iteration. Until all addresses are determined, a next iteration is needed (at Step 812), and the process repeats at Step 802.

As shown in FIG. 12, the auto-address discovery approach of some embodiments operates using an iterative process of sending discovery messages (steps 804 and 806) to the two-wire path and prompting for decoders within address ranges to respond. The responses to a given discovery message and/or lack of response to a given discovery message (Steps 808 and 810) guide the next iteration of the discovery message. The discovery message generally requests that any device within the noted address range respond to indicate its presence on the path, and also to respond in one of several feedback slots that indicate further bits in the address.

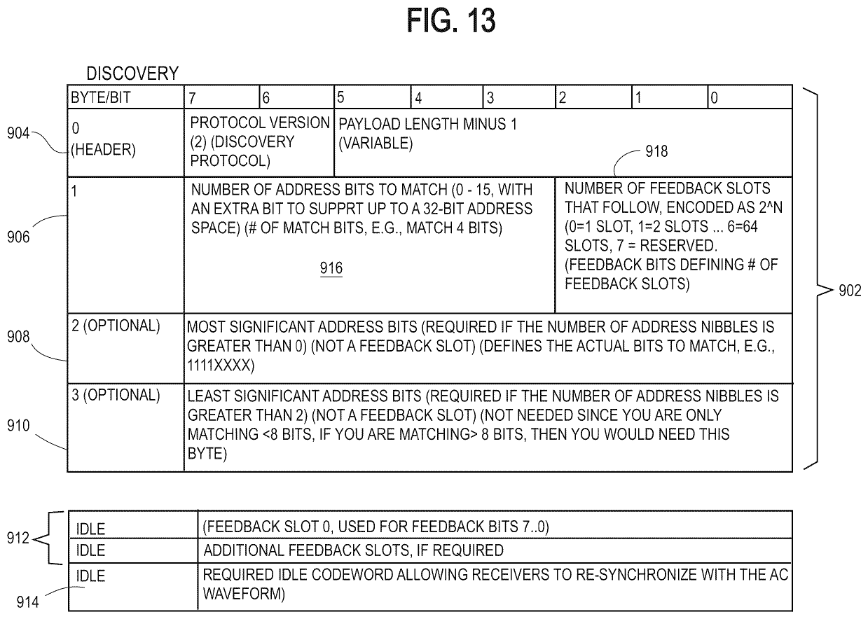

FIG. 13 illustrates an exemplary format of a discovery message 902 in accordance with some embodiments. For example, the discovery message 902 indicates a portion of an address to match (e.g., from the data in field 916 and indicated by parameter portions 908 and 910) and prompts a response from one or more of the irrigation devices in which a corresponding portion of a unique address matches the portion of the address to match. The discovery message 902 may then be followed by one or more feedback periods of time (also referred to as feedback slots) in feedback portions 912 during which irrigation devices with a matching address portion will provide feedback to indicate their presence on and connection to the multi-wire path 16.

In FIG. 13, the first parameter portion 906 may include a field for number of address bits to match 916 and/or a field 918 for a number of feedback periods of time. For example, field 916 may indicate that 4 bits in the address are to be matched, and field 918 may indicate that there are 4 feedback periods of time. In some aspects, the discovery message 902 includes a first data portion (e.g., the number of address bits to match field 916) and a second data portion (e.g., the number of feedback slots field 918). The first data portion corresponds to and/or defines the portion of the address bits to match and the second data portion corresponds to feedback periods of time for each of the one or more of the irrigation devices to respond. In some aspects, the first data portion and the second data portion define a range of addresses of irrigation devices to respond to the discovery message. In some aspects, the first data portion defines a first set of address bits to match and a position of first set of address bits in the address (e.g., a combination of the number of address bits to match field 916 and at least one of the second parameter portion 908 and the third parameter portion 910). For example, the field 916 together with parameter portions 908 and 910 indicate to match the 4 most significant bits, and they should match 1111.

The second parameter portion 908 may correspond to most significant address bits to match field 908. The third parameter portion 910 may correspond to least significant address bits to match field 910. In some aspects, in this example discovery message, if the most significant 8 or less address bits are to be matched, the third parameter portion is not needed. For example, if only matching the most significant 4 bits being 1111, then only the second portion 908 is populated with data. However, if it is intended to match the most significant 9 or more bits, both the second and third parameter portions 908 and 910 are used. In some embodiments, the second data portion may define a set of feedback periods of time in field 918. In some aspects, each feedback period of time corresponds to a second set of address bits and a position of the second set of address bits in the address.

In some aspects, a feedback period of time for use by each of the one or more of the irrigation devices depends on an additional portion of the unique address of each of the one or more of the irrigation devices. In some aspects, when a given irrigation device responds to the discovery message 902 during a given feedback period of time (e.g., feedback slot) in feedback portions 912, the response indicates that the given irrigation device matches the first set of address bits and indicates the second set of address bits of the given irrigation device. In some configurations, subsequent to the transmission of the modulated data, a control circuit may cause a modulator to transmit over the multi-wire path 16 one or more first idle signals (e.g., idle codewords of the feedback portions 912) corresponding to a feedback period of time the control circuit has allocated to receive the response from the one or more of the irrigation devices.

In yet some aspects, subsequent to the transmission of the one or more first idle signals, the control circuit may cause the modulator to transmit over the multi-wire path 16 at least one synchronization signal for the irrigation devices. For example, a final idle portion 914 is for synchronization purposes and allows the irrigation devices to re-synchronize (and be ready to receive another discovery message over the multi-wire path 16) after each transmission of discovery message by the control circuit 405 (FIG. 9A). After the discovery message 902, the feedback portions 912 may be included in the modulated data to provide a period of time for feedback from the irrigation devices. Each feedback portion 912 may include 16 zero bits, and an irrigation device may assert feedback during the bit position corresponding by the next address bits (e.g., the four address bits that follow the match indicated in this command).

As shown in FIG. 13, the discovery message defines: (1) the number of address bits to match in field 916, (2) the number of feedback slots in field 918, and (3) actual bits to match in fields 908 and 910. The discovery message is then followed by two or more feedback slots (bytes of idle or unmodulated cycles). Responding devices will respond during a portion of the idle bytes by drawing current from the received signal on the path. The current draw and bit location may be detected by the encoder to determine that a response is received. The initial iterations of the discovery message may have multiple responding devices or may only have a single responding device, and the subsequent discovery messages will match further bits until the exact addresses of the connected decoders are determined. This iterative approach is preferably in some embodiments used since it is not practical to query every individual address due to the sheer volume of a 16-bit address space.

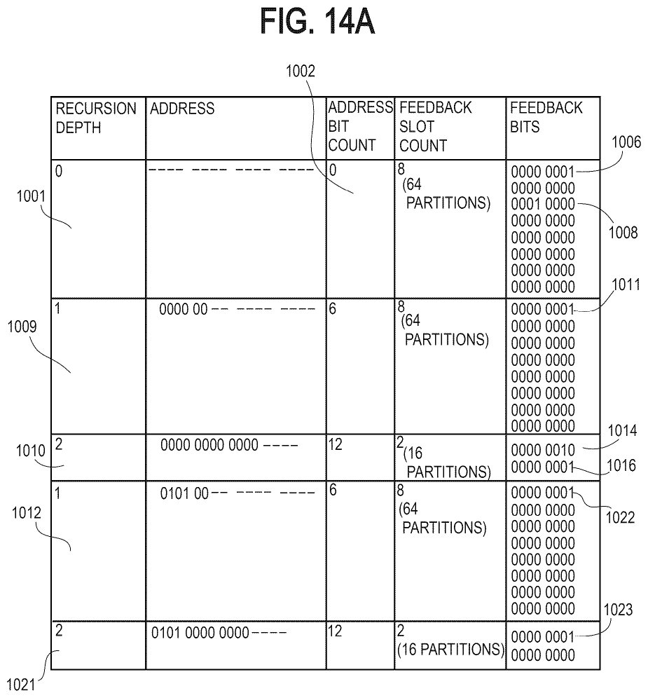

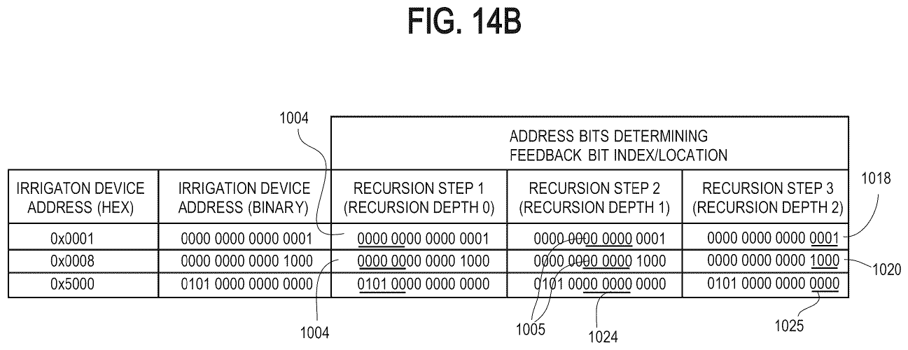

FIGS. 14A and 14B shows an exemplary automatic discovery of addresses of irrigation devices. In this example, the discovery messages (e.g., discovery messages 902) are used to search an entire 16 bit address space for three irrigation devices having addresses 0x0001, 0x0008, and 0x5000. In FIG. 14A, the return value is an array of integers, one per feedback bit position, with a zero value indicating no feedback for that bit position, and a non-zero value indicating feedback was detected. In FIGS. 14A and 14B, in the first recursion step 1 (recursion depth 0) 1001 using the wider search strategy, there are no number of address bits to match 1002 and the address bits determining the feedback bit location (or index) are address bits location 15 through 10. As such, for the irrigation devices with addresses 0x0001 and 0x0008, their responses will be in 0 feedback slot 1006 since they have a value of 0 in their corresponding address bits determining the feedback bit location 1004. For the irrigation device with address 0x5000, its response is in the corresponding feedback slot 1008.

In recursion step 2 (recursion depth 1) 1009, the discovery message now seeks to indicate address bits to match, and in this case, it is intended to match the most significant 6 bits. Since the responses to recursion step 1 indicate at least one device responded in which the first 6 bits are 0, the value of the first 6 bits to match is defined as 000000. And like recursion step 1, 64 partitions are used for feedback position defined by the next 8 bits. In this case, the irrigation devices with addresses 0x0001 and 0x0008 respond in 0 feedback slot 1011 since they have a value of 0 in their corresponding address bits determining the feedback bit location 1005. At this point, there are still multiple possible devices that could have responded in feedback slot 1011 and a further iteration is needed to discover the complete addresses. And since the device with address 0x5000 does not match the first 6 bits, it will not respond.

In recursion step 3 (recursion depth 2) 1010, since recursion step 2 indicates the first 12 bits, the discovery message of this step signals to match the most significant 12 bits, the value of which is 0000 0000 0000. The responding irrigation devices are 0x0001 and 0x0008 and not 0x5000 since the bits to match in bit locations [15 . . . 4] are all 0s. Moreover, the response for irrigation device 0x0001 is in 1 feedback slot 1014 since it has a value of 1 in its corresponding address bits determining the feedback bit location [3 . . . 0]1018. The response for irrigation device 0x0008 is in 8 feedback slot 1016 since it has a value of 8 in its corresponding address bits determining the feedback bit location [3 . . . 0] 1020. At this point, the irrigation control unit determines the complete addresses of the two responding devices (0x0001 and 0x0008).

What remains is to discover the device/s that responded in feedback slot 1008 in recursion step 1 (recursion depth 0) 1001. Thus, a next discovery message broadens its search relative to steps 1-3 (1001, 1009 and 1010). In another example, in recursion step 4 (recursion depth 1) 1012, the address bits to match are set to 010100, and the responding irrigation device is 0x5000 and not 0x0001 nor 0x0008 since the bits to match in bit locations [15 . . . 10] are 010100. The response for irrigation device 0x5000 is in 0 feedback slot 1022 since it has a value of 0 in its corresponding address bits determining the feedback bit location [9 . . . 4] 1024. At this point, there are still multiple possible devices that could have responded in feedback slot 1022 and a further iteration is needed to discover the complete addresses.

In recursion step 5 (recursion depth 2) 1021, since recursion step 4 indicates the first 12 bits, the discovery message of this step signals to match the most significant 12 bits, the value of which is 0101 0000 0000. The responding irrigation device is now only 0x5000 which responds in 0 feedback slot 1023 since it has a value of 0 in its corresponding address bits determining the feedback bit location [3 . . . 0] 1025. No other devices respond. Thus, the process is concluded since the irrigation control unit determines from the response and position the complete address of the last unknown device (0x5000). In recursion step 3 (recursion depth 2) 1010, the response for irrigation device 0x0001 is in 1 feedback slot 1014. What this mean is that the response “1” in 1014 is in bit 1 of the 16 bits shown under the column “Feedback Bits” with bit 0 of the 16 bits being the “0” to the right of “1” in 1014. Also, the response “1” of the irrigation device 0x0008 in 1016 is located in bit 8 of the 16 bits. Additionally, as explained above, the number of bits under the column “Feedback Bits” for the particular recursion step is based on the feedback slot count.

As explained above, FIGS. 14A and 14B illustrate a simple exemplary iterative messaging approach to discover the addresses of connected decoders 0x0001, 0x0008 and 0x5000. The first iteration 1001 does not indicate any bits to match (0 bits to match in 1002), but directs devices to respond in one of 64 partitions of 8 feedback slots according to their address. Devices 0x0001 and 0x0008 respond in slot 1006 and device 0x5000 responds in slot 1008. This is used to narrow in the second iteration 1009 which is targeting to find the devices responding in slot 1006. The second iteration 1009 requests to match the 6 most significant bits to be 0000 00 and again provides 64 partitions in 8 feedback slots.

In this case, again both 0x0001 and 0x0008 respond in slot 1011, but since 0x5000 does not match the 6 most significant bits, it does not respond. The third iteration 1010 goes another depth level requesting to match the 12 most significant bits (0000 0000 0000) and provides 16 partitions in 2 feedback slots for response. The response for device 0x0001 is in feedback slot 1014, and the response for device 0x0008 is in feedback slot 1016. The bit position of the response indicates the remaining address bits. And therefore, at this point, the discovery process has now identified the complete addresses of the two responding devices (0x0001 and 0x0008). Similar iterations 1012 and 1021 are used to identify device 0x5000.

In some aspects, now that the addresses of connected devices have been discovered as described above, or as addresses are entered or scanned into, or otherwise transferred to the controller, an installer often assigns station or zone numbers to these devices to help with irrigation scheduling. The exemplary irrigation controller 202 described herein according to some embodiments may simultaneously support 50 stations/zones and a given decoder (or other device connected to the two-wire path) may be assigned to one of stations/zones 1-50.

Water programming is often defined as watering programs that are assigned to each station. For example, watering program A can be created that irrigates every day for 10 minutes at 6 am, and watering program B can be created that irrigates Monday, Wednesday and Friday, for 15 minutes at each of 7 am and 10 am. The watering programs are assigned to stations (note that stations and zones are used synonymously). For example, stations 1-10, 15, 20-30 and 49-50 water according to program A, whereas stations 11-14, 16-19, 31-40 operate according to program B, and stations 41-48 operate according to both programs A and B. To make this programming happen, in some embodiments, the decoders having discovered 16-bit addresses are assigned to station numbers. This is typically performed via another manual process at the controller user interface and is time-consuming when there are up to 50 connected decoders.

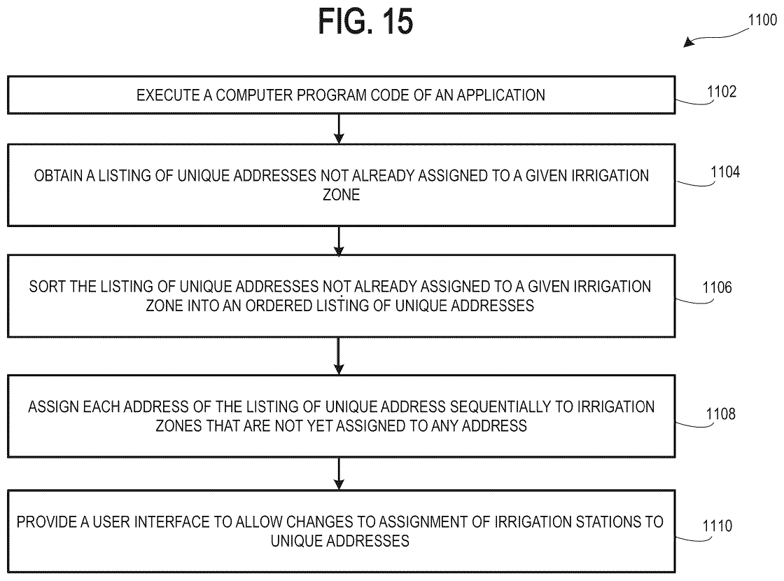

FIG. 15 shows a flow diagram of an exemplary process 1100 of automatic assignment of irrigation devices in accordance with some embodiments. In some aspects, an irrigation control unit for use with irrigation devices connected to a multi-wire path 16 in an irrigation system includes a control circuit that executes an application including computer program code that perform one or more steps (Step 1102). In some aspects, the control circuit, via the execution of the irrigation management application 114a, obtains a listing of unique addresses not already assigned to irrigation zones (Step 1104). In some aspects, the assignment of each unique address step includes assigning each unique address of the listing of unique addresses sequentially to available irrigation zones starting with a lowest value of the available irrigation zones assigned to a lowest value of the listing of unique addresses.

For example, in the example of FIGS. 14A and 14B above, a listing of unassigned addresses 0x0008, 0x0001, and 0x5000 could be assigned to the available zones 1, 2 and 3. For further example, if zones 1, 2, and 3 were already assigned to addresses, unassigned addresses 0x0008, 0x0001, and 0x5000 could be assigned to the available zones 4, 5 and 6. In some aspects, the assignment of each unique address includes assigning each unique address of the listing of unique addresses sequentially to available irrigation zones such that a unique address corresponding to a master valve is assigned a lowest number of the available irrigation zones. For example, a listing of unassigned addresses 0x0008, 0x0001, and 0x5000 and including a master valve (MV) having address 0x1040 could be assigned such that MV address 0x1040 is assigned to available zone 1 and unassigned addresses 0x0008, 0x0001, and 0x5000 are assigned to available zones 2, 3 and 4. It is noted that sequential assignments may be in ascending, descending or other order.

In some aspects, the control circuit, via the execution of the irrigation management application 114a, sorts the listing of unique addresses not already assigned to the irrigation zones into an ordered listing of unique addresses (Step 1106). By one approach, the assigning step may include assigning each unique address of the ordered listing of unique addresses sequentially to available irrigation zones. For example, a listing of unassigned addresses 0x0008, 0x0001, and 0x5000 could be first sorted into an ordered listing of unassigned addresses 0x0001, 0x0008, and 0x5000, which then are assigned to the available zones 1, 2 and 3. It is noted that Step 1106 is optional in some aspects.

In some aspects, available irrigation zones includes one or both of: one or more irrigation zones that have not yet been assigned to any unique address and one or more lost irrigation zones that were previously assigned to a unique address of an irrigation device that is no longer connected to the multi-wire path 16. For example, if zones 1, 2 and 3 have been assigned, but the address corresponding to zone 2 is missing or not functioning properly such that it appears to be disconnected, then three unassigned addresses could be assigned to zones 2, 4 and 5. In some embodiments, the control circuit, via the execution of the application, assigns each unique address of the listing of unique addresses sequentially to available irrigation zones (Step 1108).

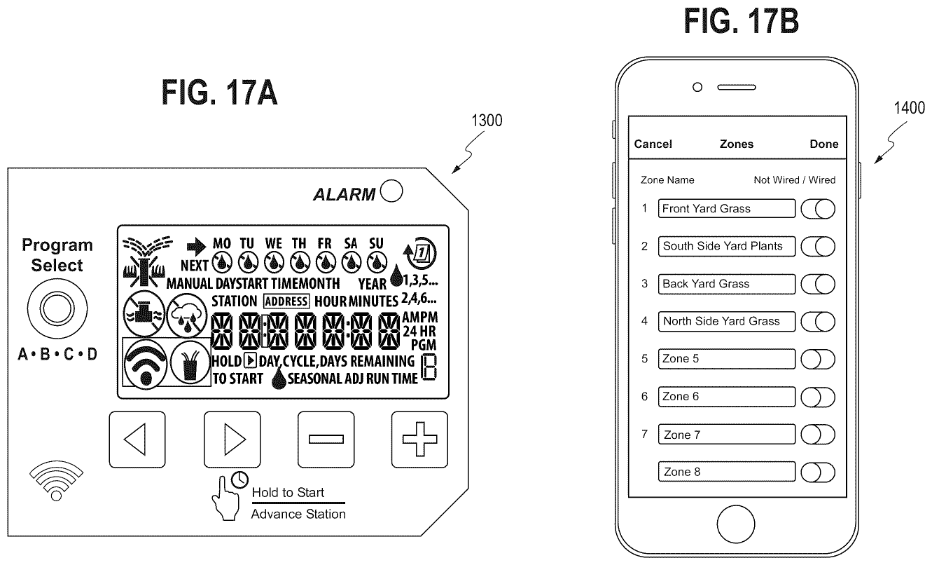

In some embodiments, the one or more steps include receiving user input via a user interface (e.g., as shown in FIGS. 17A and 17B below). The user input may indicate to change an irrigation zone assignment of a first irrigation zone assigned to a first unique address. In some aspects, the user input indicates removing an irrigation zone assignment of a first irrigation zone assigned to a first unique address, such that the first unique address is not assigned to an irrigation zone. In some aspects, an additional user input may be received via the user interface. The additional user input may indicate assignment of the first unique address to an available irrigation zone. In some embodiments, the user interface is provided to allow changes to assignment of irrigation stations to unique addresses (Step 1110).

Generally, FIG. 15 illustrates an advantageous approach in that the controller executes an auto-address assignment to stations algorithm that automatically assigns discovered addresses sequentially to available stations. In particular, as explained above, first, a listing is provided indicating discovered or input addresses (e.g., after being automatically discovered or otherwise input to the controller) of decoders that have not been assigned to stations or zones (step 1104). Next, this listing of addresses is sorted into an ordered listing (e.g., sequentially by address bits) (step 1106). Then, the available station/zones are sequentially assigned to the ordered listing of addresses (step 1108). For example, the lowest number address can be assigned to lowest number available station number. And last, in some embodiments, an interface is provided to allow the user to view and make adjustments to the automatic assignment (step 1110). Steps 1104, 1106 and 1108 eliminate time consuming user programming at the very limited interface of the controller.

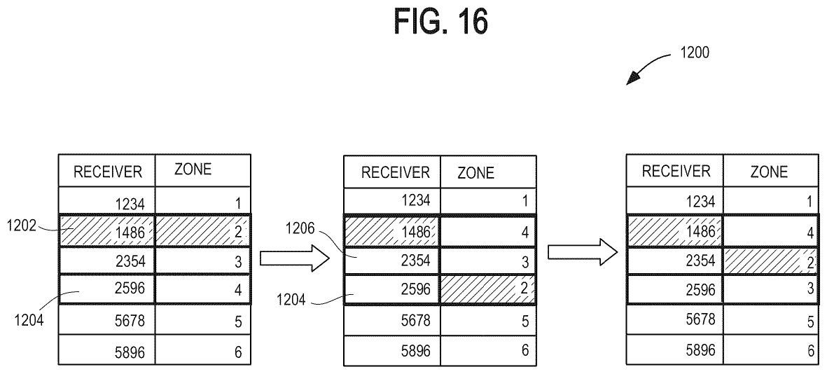

FIG. 16 illustrates an exemplary process 1200 of swapping zone number assignments between irrigation devices (receivers or decoders) and/or addresses in accordance with some aspects. For example, the irrigation stations (zones) automatically assigned to the addresses of receivers 1202 and 1204 (having addresses 1486 and 2596) are swapped. In another example, the zones between receivers 1204 and 1206 (having addresses 2354 and 2596) are then subsequently swapped.

More specifically, FIG. 16 provides a simple example of auto-assignment of decoders (“receivers” in FIG. 16) having 4 bits addresses to stations (“zones” in FIG. 16). On the left display, sequential addresses 1234, 1486, 2354, 2596, 5678 and 5896 are automatically assigned to stations 1-6, respectively. In the middle and right displays, the user switches the assignment of 1486 to be station 4, which renumbers 2354 and 2596 to stations 2 and 3. An exemplary user interface that allows a user to view and switch the assignment of the discovered addresses to stations is described in more detail below.

It is understood that there are various encoder and decoder approaches known. The approaches described thus far are examples. Further details of these embodiments may be found in one or more of the following patent documents, all incorporated herein by reference:
U.S. Pat. No. 8,532,831, granted Sep. 10, 2013, titled DATA COMMUNICATION IN A MULTI-WIRE IRRIGATION CONTROL SYSTEM (Docket No. 8473-92008-US);
U.S. Pat. No. 11,234,380, granted Feb. 1, 2022, titled IRRIGATION CONTROLLER WITH RELAYS (Docket No. 8473-147633-US);
U.S. Pat. No. 11,357,181, granted Jun. 14, 2022, titled DATA MODULATED SIGNAL GENERATION IN A MULTI-WIRE IRRIGATION CONTROL SYSTEM (Docket No. 8473-150383-US);
U.S. Pat. No. 11,925,149, granted Feb. 21, 2024, titled AUTO-DETECTION OF DEVICES ON A MULTI-WIRE IRRIGATION CONTROL SYSTEM AND AUTO-ASSIGNMENT OF RECEIVERS TO IRRIGATION ZONES (Docket No. 8473-153435-US); and
U.S. Pat. No. 11,038,146, granted Aug. 10, 2021, titled METHOD AND APPARATUS FOR PROGRAMMING A DECODER-BASED IRRIGATION CONTROLLER (Docket No. 8473-149112-US).

As shown in FIGS. 17A-17B, the sample UI shown in FIG. 10 may be implemented using the display screen and buttons of the irrigation controller 1300 (FIG. 17A), or via a mobile application of a phone 1400 (FIG. 17B) connected by WiFi or Bluetooth to the controller. An exemplary user interface may include buttons, dials, and/or switches, to name a few. The controller UI example shown in FIG. 17A is limited with only 4 buttons and the ability to display only 7 characters at once. Thus, a more robust interface of a mobile application implemented on a user device (such as a smart phone) with touch screen functionality (e.g., FIG. 17B) can provide an easier to use and more functional interface. Exemplary user interfaces that allow a user to view and edit the assignment of addresses to discovered stations is described in more detail below. Generally, the figures below illustrate exemplary user interface screens as may be implemented on a mobile device having a mobile application installed thereon, or accessible therewith.

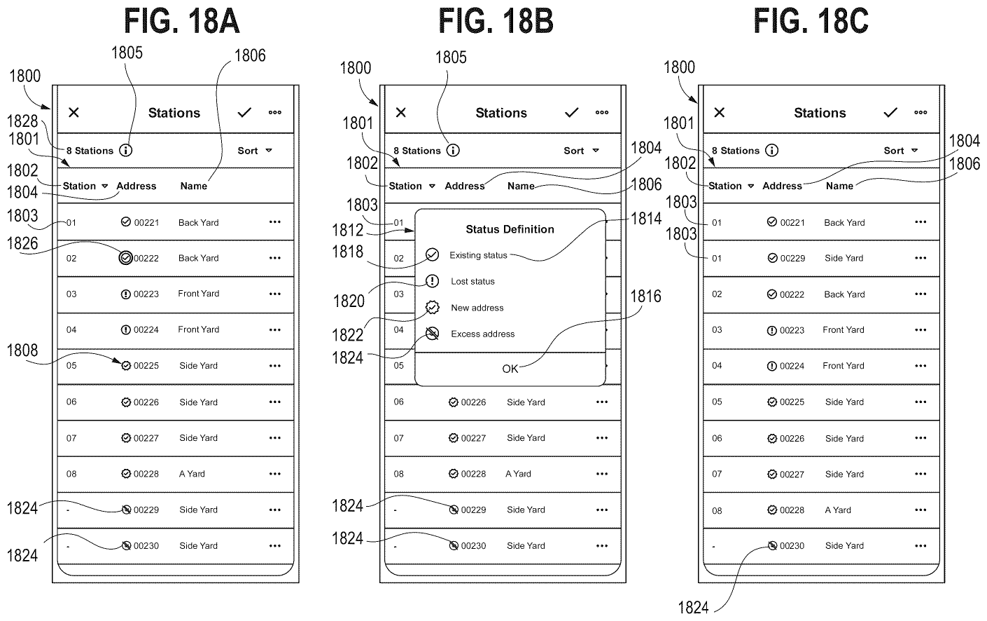

In FIG. 18A, a user interface 1800 in accordance with some embodiments is caused to be displayed by an irrigation management application 114a to a user and shows a listing 1801 of irrigation stations 1802 having been automatically assigned to irrigation device (e.g., a decoder) addresses 1804 (e.g., auto-discovered addresses such as 00300, 00221, 00222, etc.). It is noted that as described herein, a decoder having a unique decoder address is an example of an irrigation device having a unique irrigation device address. Other examples of irrigation devices include receivers, sprinklers, sensors, master valves, and so on. Further, while the terms decoder and decoder addresses may be referred to in connection with the embodiments of user interfaces of FIGS. 18A-31B, it is understood that such concepts and examples apply more generically to irrigation devices having irrigation device addresses such that the terms decoders and decoder addresses can be referred to more generically as irrigation devices and irrigation device addresses.

In the illustrated embodiments, each of the irrigation stations 1802 has an assigned identifier 1803. The identifier 1803 may be a numerical identifier (e.g., “01,” “02,” “03,” etc.), an alphabetic or letter-based identified (e.g., “A,” “B,” “C,” etc.), or an alphanumeric identifier (e.g., 1G1, 1G2, 1G3, etc.). In some aspects, the user interface 1800 permits the user to assign a name 1806 (e.g., “Front Yard,” “Back Yard,” “Side Yard,” etc.) to each irrigation station 1802. In the illustrated example, there are 8 decoder addresses 1804 found that are assigned to irrigation stations 01-08, and the user interface includes an exemplary informational field 1828, which visually indicates the exact number of irrigation stations 1802 (in this example, “8 stations”) that were found in a decoder address scan to be associated with a decoder address 1804.

In some embodiments, adjacent to each of the decoder addresses 1804 is a status indicator, which, in the example illustrated in FIG. 18A, is a graphical status indicator element in the form of a status icon 1808. In certain aspects, the status icon 1808 visually indicates a status of the decoder address 1804 adjacent to which the status icon 1808 is located. In certain implementations, the user interface 1800 includes an interactive “information” icon 1805, which, when interacted with by the user, generates a status definition menu 1812 as an overlay over a portion of the listing 1801 of irrigation stations 1802, as shown in FIG. 18B.

With reference to 18B, the exemplary status definition menu 1812 includes informational fields 1814 (four of them in this example) that indicate the definition (i.e., meaning) of each of the status icons 1808. In the illustrated example, the informational fields 1814 indicate that: the status icon 1818 represents an existing unique decoder address 1804 assigned to an irrigation station 1802; the status icon 1820 represents a new unique decoder address 1804 discovered and assigned to an irrigation station 1802; the status icon 1822 represents a previously found unique decoder address 1804 that is no longer found in a current decoder address scan (i.e., a lost decoder address 1804); and the status icon 1824 represents an excess unique decoder address 1804 discovered in the current decoder address scan, but not yet assigned to any irrigation station 1802. As illustrated in FIG. 18B, the exemplary status definition menu 1812 includes an interactive button or icon 1816 (called “OK” in this example) that, when interacted with by the user, permits the user to close the status definition menu 1812.

In some aspects, the user interface 1800 is configured such that the user is permitted to select (e.g., by tapping on, clicking a mouse on, etc.) a given irrigation station 1802 or a given decoder address 1804 in the listing 1801. In the embodiment illustrated in FIG. 18A, responsive to the selection by the user of one of the irrigation stations 1802 (in this example, Station 02) or one of the unique decoder addresses 1804 (in this example, Address 00222) in the listing 1801, the user interface 1800 is caused to generate a graphical element 1826 adjacent to or surrounding the status icon 1808 associated with the user-selected irrigation station 1802 or decoder address 1804 to visibly indicate that the irrigation station 1802 or decoder address 1804 has been selected by the user. In the embodiment illustrated in FIG. 18A, the graphical element 1826 is a ring (which may be executed in any color that may attract the user's attention) around the status icon 1808. It will be appreciated that the graphical element 1826 does not have to be a ring and may have any other geometric or irregular shape.

In the embodiment illustrated in FIGS. 18A and 18B, the listing 1801 includes two unique decoder addresses 1804 (i.e., Address 00229 and Address 00230) found during the decoder address scan and not assigned to any irrigation stations 1802. Such unassigned decoder addresses 1804 may be referred to as “buffer” decoder addresses, which may be assigned (e.g., manually by the user via the interface 1800) to an irrigation station 1802. FIGS. 18A and 18B also show that each of these two unassigned “buffer” decoder addresses 1804 (i.e., Address 00229 and Address 00230) is associated with a status icon 1824, which visually indicates that these decoder addresses 1804 are excess unique decoder addresses 1804 discovered in the current decoder address scan, but not yet assigned to any irrigation station 1802.

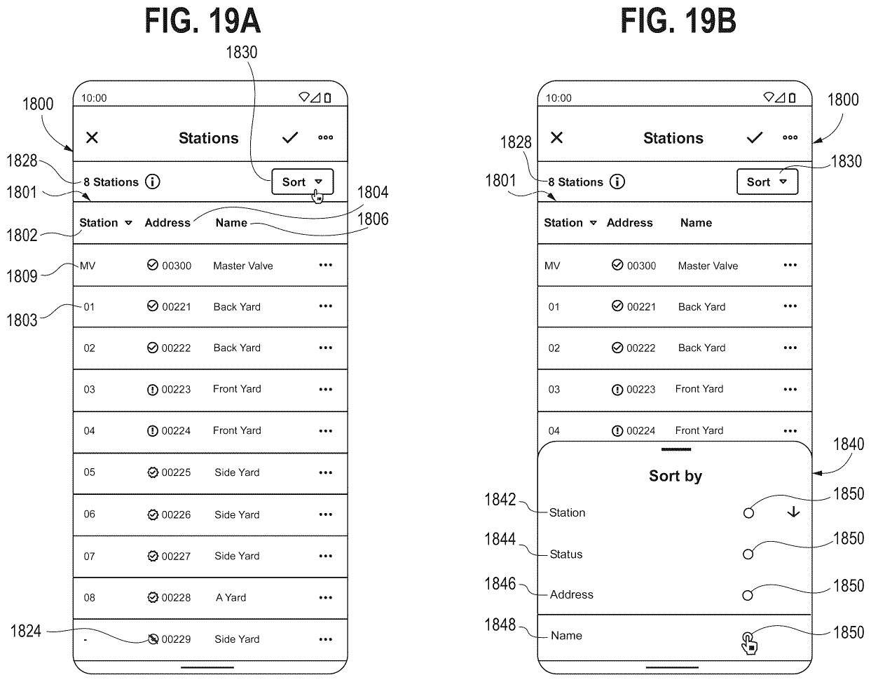

In the embodiment illustrated in FIG. 19A, the user interface 1800 further includes an interactive sorting icon or sorting feature 1830, which, when interacted with by the user, permits the user to select one of a plurality of sort options for sorting how the irrigation stations 1802 are displayed in the listing 1801. In some embodiments, responsive to a selection of the interactive sorting feature 1830 within the user interface 1800 by the user, the user interface 1800 generates an interactive sorting menu 1840 as an overlay over a portion of the listing 1801. In the embodiment illustrated in FIG. 19B, the interactive sorting menu 1840 includes multiple options that permit the user to sort the irrigation stations 1802.

The exemplary interactive sorting menu 1840 shown in FIG. 19B includes: an option 1842 to sort the irrigation stations 1802 by their respective (e.g., numerical) identifiers 1803; an option 1844 to sort the irrigation stations 1802 by the status of their respective decoder addresses 1804; an option 1846 to sort the irrigation stations 1802 by the numerical values of the decoder addresses 1804; and an option 1848 to sort the irrigation stations 1802 by the respective names 1806 of the irrigation stations 1802. In the illustrated embodiment, any of the sort options 1842, 1844, 1846, and 1848 may be selected by the user within the sorting menu 1840 by interacting with an interactive graphical element 1850 (e.g., a radial button, checkbox, etc.) associated therewith (the interactive graphical element 1850 associated with sorting option 1842 is shown as being selected in FIG. 19B by way of example).

Notably, in certain aspects the user interface 1800 permits the user to update the listing 1801 of the irrigation stations 1802 by manually adding one or more irrigation stations 1802 to the listing 1801. For example, FIG. 19A shows that the user manually added a master valve 1809 to the listing 1801. Notably, FIG. 19A shows that the master valve 1809 that the user manually added to the listing 1801 has a unique irrigation device address (e.g., decoder address 1804) assigned to it (shown as Address 00300 in FIG. 19A). However, it will be appreciated that the user interface 1800 permits the user to add to the listing 1801 one or more irrigation stations 1802 that do not have a pre-assigned decoder address 1804, in which case, the user interface 1800 permits the user to manually assign one or more decoder addresses 1804 to such a manually added irrigation station 1802.

For example, in some aspects, the user interface 1800 permits the user to assign an unassigned decoder address 1804 (i.e., Address 00229, Address 00230, or another Address not shown in FIG. 18A) to an irrigation station 1802 (e.g., Station 05) that already has one decoder address 1804 (i.e., Address 00225) assigned to it. FIG. 18C shows an example of the user interface 1800 where one irrigation station 1802 (i.e., Station 01) has two unique irrigation devices, i.e., decoder addresses 1804 assigned to it, namely, Address 00221 and Address 00229). In some embodiments, the user interface 1800 permits the user to assign one, two or more, irrigation devices other than decoders 18, for example, irrigation devices such as sensors (e.g., flow sensors, rain sensors, temperature sensors, soil moisture sensors, etc.), or other irrigation devices (receivers, sprinklers, etc.) to any of the irrigation stations 1802 in the listing 1801.

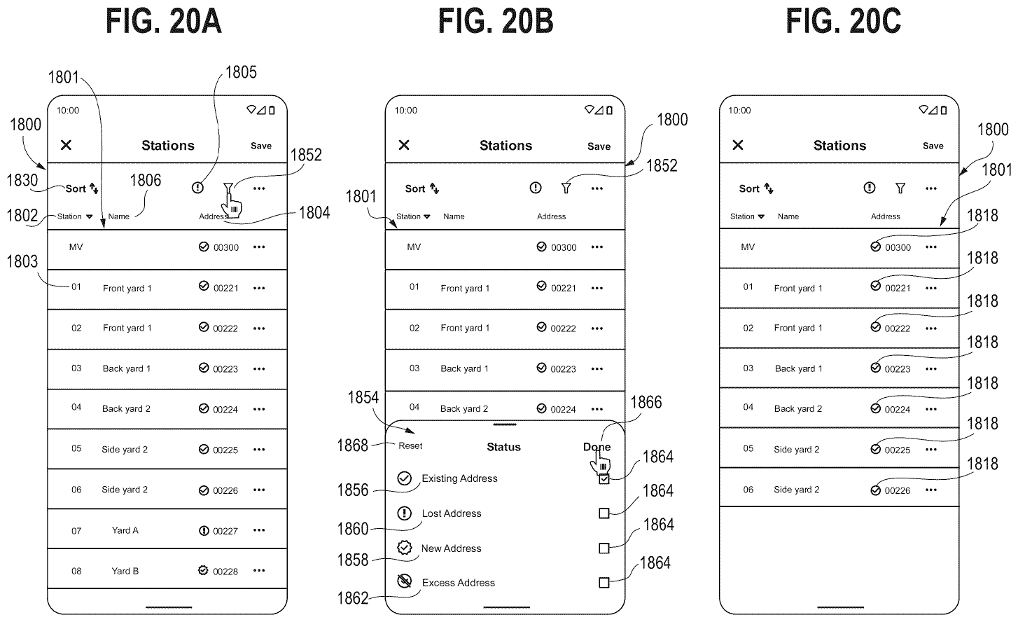

In the embodiment of FIG. 20A, the user interface 1800 further includes an interactive filtering feature 1852 that once selected, allows the user to filter the irrigation stations 1802 in the listing 1801 by the status of their decoder address 1804. In the embodiment of FIG. 20B, responsive to a selection of the interactive filtering feature 1852 within the user interface 1800 by the user, the user interface 1800 generates an interactive filtering menu 1854 as an overlay over a portion of the listing 1801. In the embodiment illustrated in FIG. 20B, the interactive filtering menu 1854 includes multiple options that permit the user to filter the irrigation stations 1802.

In particular, the exemplary interactive filtering menu 1854 shown in FIG. 20B includes: an option 1856 to filter the irrigation stations 1802 by an existing unique decoder address 1804 pre-assigned to the irrigation stations 1802 (i.e., “Existing Address” filter); an option 1858 to filter the irrigation stations 1802 by new unique decoder addresses 1804 discovered and assigned to the irrigation stations 1802 (i.e., “New Address” filter); an option 1860 to filter the irrigation stations 1802 by a previously discovered unique decoder address 1804 that is not found in a new decoder address scan (i.e., “Lost Address” filter); and an option 1862 to filter the irrigation stations 1802 by an excess unique decoder address 1804 discovered and not assigned to any one of the irrigation stations 1802 (i.e., “Excess Address” filter). It will be appreciated that less options or more options may be included in the interactive filtering menu 1854. In the illustrated embodiment, any of the filtering options 1856, 1858, 1860, and 1862 may be selected by the user within the filtering menu 1854 by interacting with an interactive graphical element 1864 (e.g., a radial button, checkbox, etc.) associated therewith (the interactive graphical element 1864 associated with filtering option 1856 is shown as being selected in FIG. 20B by way of example).

In the embodiment illustrated in FIG. 20B, the interactive filtering menu 1854 further includes an interactive field 1866 (called “Done” in this example) that, when interacted with by the user, applies the filtering option (in this case, filtering option 1856). In addition, the interactive filtering menu 1854 further includes an interactive field 1868 (called “Reset” in this example) that, when interacted with by the user, cancels the application of a filtering option and resets the user interface 1800 back to the view shown in FIG. 20A. As shown in FIG. 20C, in response to a user's selection of the interactive graphical element 1864 associated with the filtering option 1856 (i.e., “Existing Address” filter) and selecting the interactive field 1866 called “Done,”, the user interface 1800 is caused to display a listing 1801 of the irrigation stations 1802 filtered by the Existing Address filter (i.e., displays only the irrigation stations 1802 that are associated with an existing decoder address 1804). As can be seen in FIG. 20C, the irrigation stations 1802 in the listing 1801 all have decoder addresses 1804 with a status icon 1818 next to them, representing that each of these decoder addresses 1804 is an existing unique decoder address 1804 assigned to an irrigation station 1802.

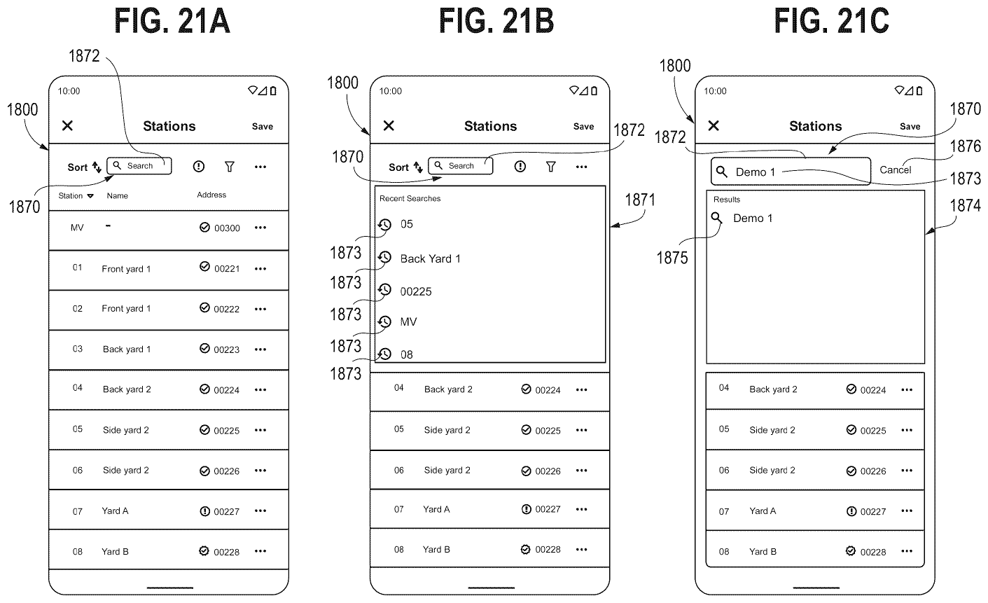

In the embodiment illustrated in FIG. 21A-21C, the user interface 1800 further includes an interactive search feature 1870, which, when interacted with by the user, permits the user to enter a search query into a freeform text input field 1872, and to search for at least one of (e.g., numerical) identifiers 1803 of irrigation stations 1802, names 1806 of the irrigation stations 1802, and/or unique decoder addresses 1804 assigned to irrigation stations 1802. In the exemplary embodiment shown in FIG. 21B, in response to a user's interaction with the interactive search feature 1870, the user interface 1800 is caused to a generate recent searches menu 1871, which overlays a portion of the listing 1801 and visually displays a predetermined number (five in this example) of the most recent search queries 1873 employed by the user to perform a search via the search feature 1870. In this example, the recent searches menu 1871 shows that the five most recent search queries were: “05,” “Back Yard 1,” “00225,” MV, and “08”).

Further, FIG. 21C shows an example, where the user interacted with the search feature 1870 by entering, into the freeform text input field 1872, the search phrase Demo 1 (which, in this example, is a name of a station of interest to the user). In response, the user interface 1800 was caused to generate a results menu 1874, which overlays a portion of the listing 1801 and visually displays the search results, i.e., the results being that the search initiated by the user by entering the search phrase “Demo 1” into the freeform text input field 1872 resulted in the user interface 1800 generating a search result field 1875 indicating that one instance of an irrigation station matching the name “Demo 1” was found. In the embodiment illustrated in FIG. 21C, the search feature 1870 further includes an interactive field or icon 1876 (called “Cancel” in this example), which, when interacted with by the user, permits the user to cancel the search for a search query 1873, and causes the user interface 1800 to return to a look as shown in FIG. 21A.

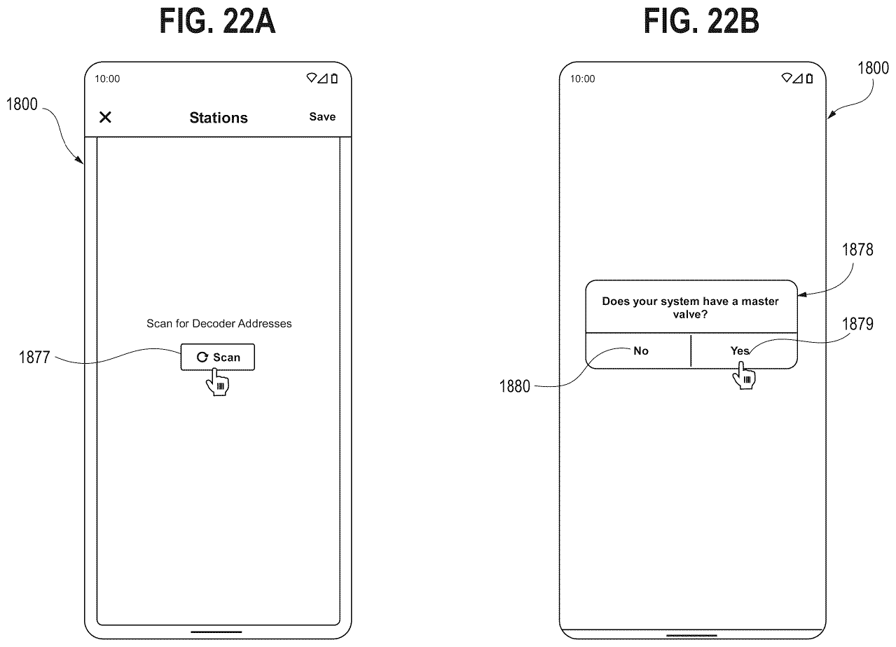

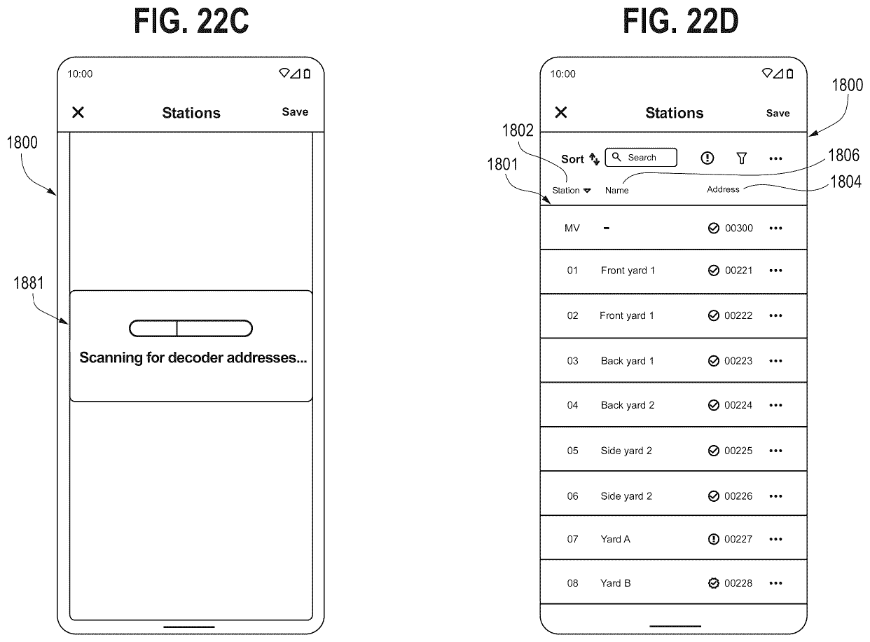

In some embodiments, the user interface 1800 further includes an interactive decoder address scan feature 1877 that permits the user to cause the irrigation management application 114a to scan the irrigation system to detect all unique decoder addresses 1804 connected to the multi-wire path. In the embodiment illustrated in FIG. 22A, the decoder address scan feature 1877 is in the form of an interactive icon or button called “Scan.” In one aspect, responsive to an interaction by the user with the interactive decoder address scan feature 1877, the irrigation management application causes the user interface 1800 to generate an interactive prompt 1878 as shown in FIG. 22B that requires the user to select an option 1879 (in this case, “Yes”) or an option 1880 (in this case, “No”) that indicates whether the irrigation system has a master valve.

In some embodiments, responsive a selection by the user of the option 1879 indicating that the irrigation system does include a master valve, the irrigation management application 114a performs several functions. In particular, the irrigation management application 114a performs a scan for the unique addresses of the decoders coupled to the multi-wire path and causes the user interface 1800 to generate an on-screen informational field 1881 as shown in FIG. 22C indicating that the scan of the unique addresses of the decoders is being performed. In addition, following the completion of the scan, the irrigation management application 114a causes the user interface 1800 to display an updated listing 1801 of the irrigation stations 1802 as shown in FIG. 22D, with the updated listing 1801 including the unique decoder addresses 1804 detected in association with irrigation stations 1802 and connected to the multi-wire path 16 that were identified during the scan. Notably, FIG. 22D shows that a decoder address 1804 (i.e., Address 00220 in the updated listing 1801) was found in association with the master valve (i.e., a valve with an identifier of “MV” in the updated listing 1801), but the master valve does not have a name assigned to it. However, as will be discussed below, the user interface 1800 permits the user to add a user-selected name (e.g., “Master Valve 1”) to the master valve.

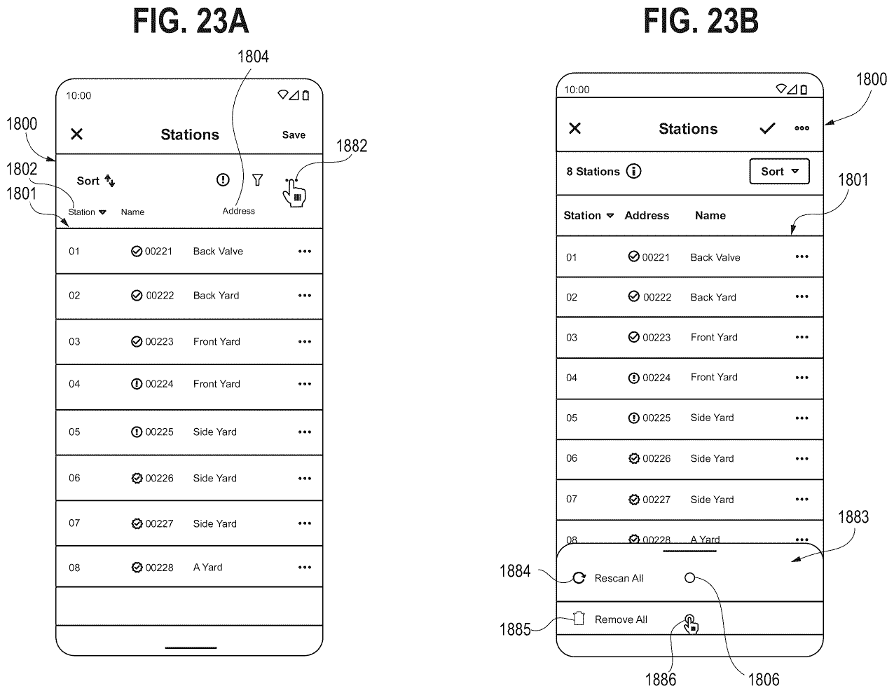

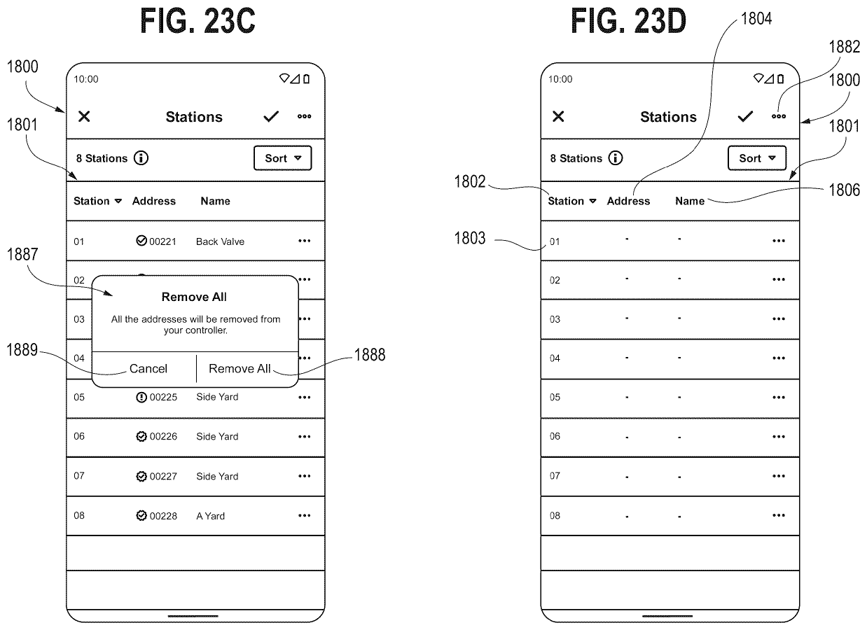

In some embodiments, the user interface 1800 further includes an interactive feature selection option 1882. In the embodiment illustrated in FIG. 23A, the interactive feature selection option 1882 is in the form of ellipses (but could be in the form of another symbol or shape) that, when interacted with by the user, causes the user interface 1800 to generate a features menu 1883 (shown in FIG. 23B) overlaying a portion of the listing 1801 and including an interactive decoder address rescan feature 1884, which, when interacted with by the user, permits the user to cause the irrigation management application 114a to rescan the irrigation system to detect all unique decoder addresses 1804 connected to the multi-wire path 16. In the illustrated embodiment, the features menu 1883 further includes an interactive remove all feature 1885, which, when interacted with by the user, permits the user to cause the irrigation management application 114a to update the user interface 1800 by removing all of the unique decoder addresses 1804 listed in the listing 1801 from association with the irrigation stations 1802.

A user may choose to do a rescan using the rescan feature 1884 or to remove all decoder addresses 1804 using the remove all feature 1885 after the user adds and/or removes irrigation stations and/or decoders to/from the irrigation system. In the illustrated embodiment, the rescan feature 1884 and the remove all feature 1885 may be selected by the user within the features menu 1883 by interacting with an interactive graphical element 1886 (e.g., a radial button, checkbox, etc.) associated therewith (the interactive graphical element 1886 associated with remove all feature 1885 is shown as being selected in FIG. 23B by way of example).

In one aspect, responsive to an interaction by the user with the graphical element 1886 to select the remove all feature 1885, the irrigation management application 114a causes the user interface 1800 to generate an interactive prompt 1887 as shown in FIG. 23C that requires the user to select an option 1888 (in this case, “Remove All”) to proceed with the removal of all decoder addresses 1804, or an option 1889 (in this case, “Cancel”) to cancel the removal of all decoder addresses 1804. In some aspects, responsive a selection by the user of the option 1888 indicating that the user wishes to proceed with discarding/removing all decoder addresses 1804, the irrigation management application 114a removes all decoder addresses 1804 from the listing 1801 and causes the user interface 1800 to display an updated listing 1801 of the irrigation stations 1802 as shown in FIG. 23D, with the updated listing 1801 including the irrigation stations 1802 (i.e., Stations 01, 02 . . . 08) but not including the unique decoder addresses 1804 assigned to these irrigation stations 1802. In some aspects, after applying the remove all feature 1885, the user may want to use the features menu 1883 to apply the rescan feature 1884 to initiate a new scan of the decoder addresses 1804 associated with the irrigation stations 1802 in the listing 1801.

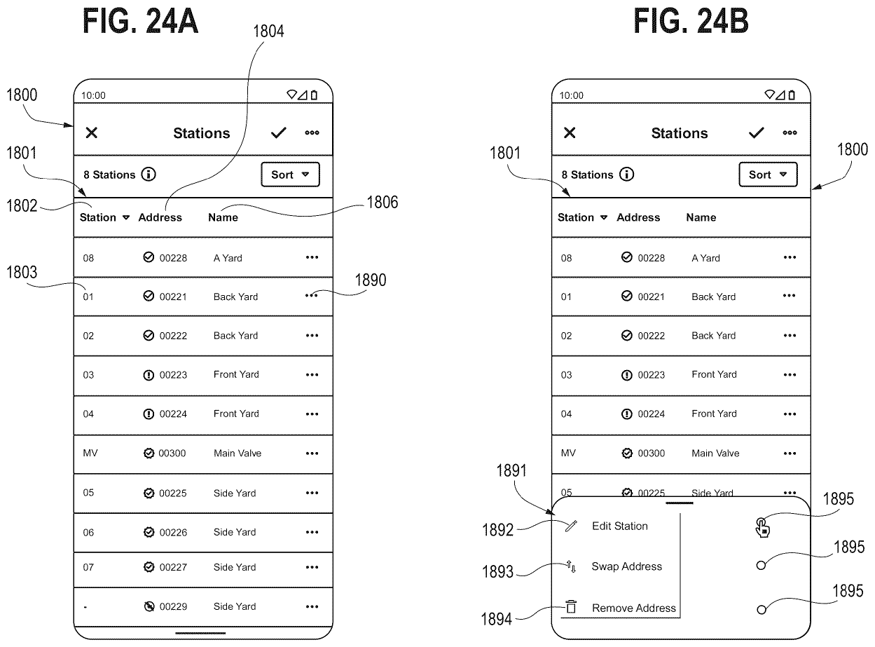

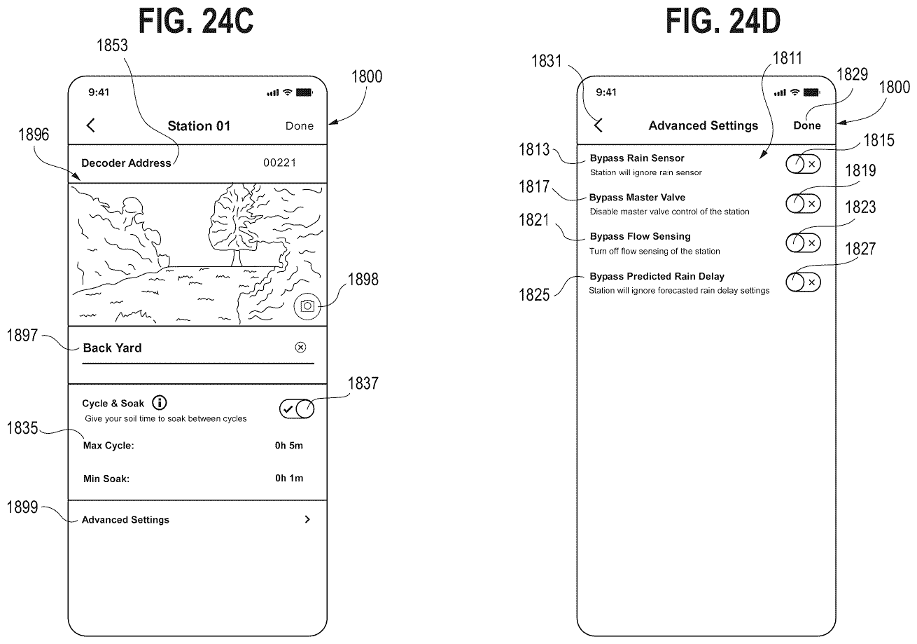

In some embodiments, the user interface 1800 further includes an interactive options feature 1890. In the embodiment of FIG. 24A, the interactive option options feature 1890 is in the form of ellipses (but could be in the form of another symbol or shape) that, when interacted with by the user, causes the user interface 1800 to generate an interactive station options menu 1891 (shown in FIG. 24B) overlaying a portion of the listing 1801 and including three user-selectable options. The first user-selectable option within the station options menu 1891 is an interactive station edit option 1892, which, when interacted with by the user, permits the user to edit various options relating to a user-selected irrigation station 1802. The second user-selectable option within the station options menu 1891 is an interactive swap address option 1893, which, when interacted with by the user, permits the user to swap the unique decoder address 1804 of one irrigation station 1802 in the listing 1801 with another irrigation station 1802 in the listing 1801. The third user-selectable option within the station options menu 1891 is an interactive remove address option 1894, which, when interacted with by the user, permits the user to remove the unique decoder address 1804 of any irrigation station 1802 from the listing 1801. In the embodiment of FIG. 24B, the edit station option 1892, the swap address option 1893, and the remove address option 1894 may be selected by the user within the station options menu 1891 by interacting with an interactive graphical element 1895 (e.g., a radial button, checkbox, etc.) associated therewith.

In the embodiment of FIG. 24A, the user has selected a single irrigation station 1802 (in this example, Station 01) by selecting the interactive options feature 1890. Responsive to an interaction by the user with the options feature 1890, the irrigation management application 114a causes the user interface 1800 to display the station options menu 1891 pertaining specifically to the user-selected irrigation station 1802. In some aspects, responsive a selection by the user of the graphical element 1895 associated with the station edit option 1892 (as shown in FIG. 24B), the irrigation management application 114a causes the user interface 1800 to generate a station options sub-menu 1896 shown in FIG. 24C that permits the user change various options relating to the user-selected irrigation station 1802.

The first user-selectable option within the station options sub-menu 1896 of FIG. 24C is an option 1897 that permits the user to change the name of the irrigation station 1802 (i.e., Station 01). In the embodiment of FIG. 24C, the name of the irrigation station 1802 being edited is “Back Yard,” but the user may change the name of the irrigation station 1802 to a different name, for example “Back Yard 1,” “Pool 1,” etc. The second user-selectable option within the station options sub-menu 1896 is an option 1898 that permits the user to change (e.g., upload or delete) a photograph depicting the physical location where Station 01 is located. The third user-selectable option within the station options sub-menu 1896 is an option 1899 that permits the user to view and modify one or more operational parameters of Station 01.

In the embodiment of FIG. 24C, the third option 1899 of the station options sub-menu 1896 is an “Advanced Settings” option, which, when interacted with by the user, causes the irrigation management application 114a to cause the user interface 1800 to display a settings sub-menu 1811 shown in FIG. 24D as an overlay over the listing 1801. The exemplary settings sub-menu 1811 is an advanced settings menu that includes four (but may include less than four or more than four) options selectable by the user in association with the irrigation station 1802 (i.e., Station 01).

In the example shown in FIG. 24D, the first advanced option available to the user is advanced option 1813 that permits the user to bypass (or not bypass) the rain sensor such that Station 01 will ignore (or will not ignore) the rain sensor associated therewith when performing its irrigation program. As illustrated, the user interface 1800 includes an interactive button or icon 1815 that permits the user to enable advanced option 1813 (i.e., by toggling the interactive button or icon 1815 to its right-most position), or to disable advanced option 1813 (i.e., by toggling the interactive button or icon 1815 to its left-most position). In the example shown in FIG. 24D, the advanced option 1813 is disabled because the interactive button or icon 1815 is in its left-most position. In the example shown in FIG. 24D, the second advanced option available to the user is advanced option 1817 that permits the user to bypass (or not bypass) the master valve such that the master valve control of Station 01 will be disabled (or enabled). As illustrated, the user interface 1800 includes an interactive button or icon 1819 that permits the user to enable advanced option 1817 (i.e., by toggling the interactive button or icon 1819 to its right-most position), or to disable advanced option 1817 (i.e., by toggling the interactive button or icon 1819 to its left-most position). In the example shown in FIG. 24D, the advanced option 1817 is disabled because the interactive button or icon 1819 is in its left-most position. In the example shown in FIG. 24D, the third advanced option available to the user is advanced option 1821 that permits the user to bypass (or not bypass) flow sensing such that flow sensing of Station 01 will be disabled (or enabled). As illustrated, the user interface 1800 includes an interactive button or icon 1823 that permits the user to enable advanced option 1821 (i.e., by toggling the interactive button or icon 1823 to its right-most position), or to disable advanced option 1821 (i.e., by toggling the interactive button or icon 1823 to its left-most position). In the example shown in FIG. 24D, the advanced option 1821 is disabled because the interactive button or icon 1823 is in its left-most position. In the example shown in FIG. 24D, the fourth advanced option available to the user is advanced option 1825 that permits the user to bypass (or not bypass) predicted rain delay such that Station 01 will ignore (or will not ignore) forecasted rain delay settings. As illustrated, the user interface 1800 includes an interactive button or icon 1827 that permits the user to enable advanced option 1825 (i.e., by toggling the interactive button or icon 1827 to its right-most position), or to disable advanced option 1825 (i.e., by toggling the interactive button or icon 1827 to its left-most position). In the example shown in FIG. 24D, the advanced option 1825 is disabled because the interactive button or icon 1827 is in its left-most position.

In the embodiment illustrated in FIG. 24D, the exemplary settings sub-menu 1811 of the user interface 1800 further includes an interactive button or icon 1829 (called “Done” in this example), which, when interacted with by the user, applies to Station 01 the advanced settings selected by the user by manipulating the interactive buttons or icons 1815, 1819, 1823, and 1827 of the advanced options 1813, 1817, 1821, and 1825, respectively. In addition, the exemplary settings sub-menu 1811 of the user interface 1800 includes an interactive button or icon 1831 (formed in the shape of a left-pointing V in this example), which, when interacted with by the user, cancels the application to Station 01 of the advanced settings selected by the user by manipulating the interactive buttons or icons 1815, 1819, 1823, and 1827 of the advanced options 1813, 1817, 1821, and 1825, respectively, and returns the user interface 1800 to the station options sub-menu 1896 shown in FIG. 24C.

With reference to FIG. 24C, the exemplary station options sub-menu 1896 includes an informational field 1853 that displays the decoder address 1804 (in this example, Address 00221) assigned to Station 01. As can be seen in FIG. 24A, this decoder address 1804 (i.e., Address 00221) is also displayed in the listing 1801 of irrigation stations 1802 in as being assigned to Station 01. In addition, the exemplary station options sub-menu 1896 shown in FIG. 24C includes an informational field 1835 that displays an operational parameter of Station 01. In this example, the informational field 1835 indicates that Station 01 is operating in Cycle & Soak mode, where the maximum irrigation cycle is 5 minutes and the minimum soak cycle is 1 minute. As illustrated, the informational field 1835 includes an interactive button or icon 1837 that permits the user to enable the Cycle & Soak mode (i.e., by toggling the interactive button or icon 1837 to its right-most position), or to disable the Cycle & Soak mode (i.e., by toggling the interactive button or icon 1837 to its left-most position). In the example shown in FIG. 24D, the Cycle & Soak mode is enabled because the interactive button or icon 1837 is in its left-most position.

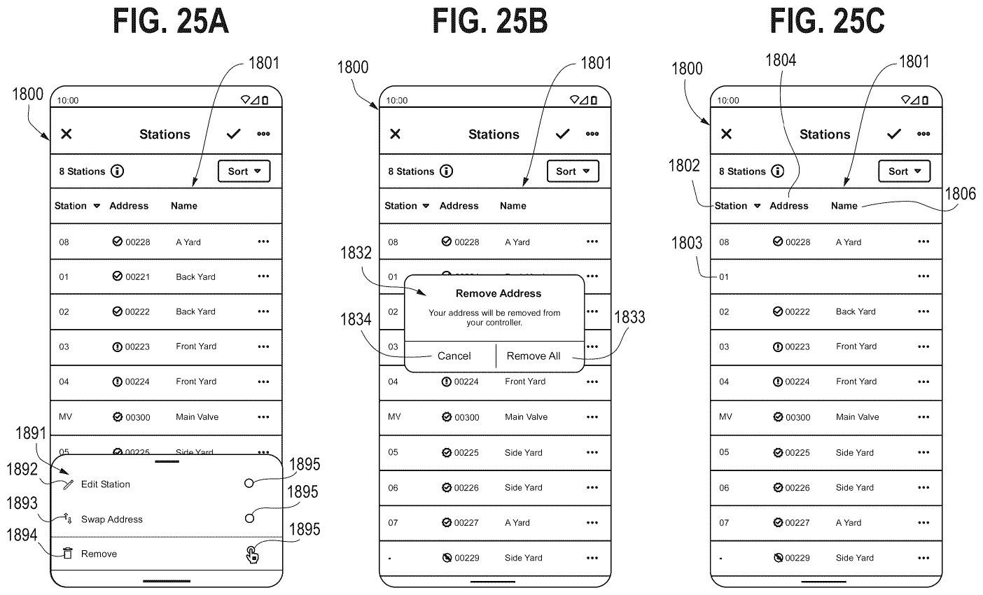

With reference back to FIGS. 24A, as mentioned above, in response to an interaction by the user with the interactive options feature 1890 association with Station 01, the irrigation management application 114a causes the user interface 1800 to generate the interactive station options menu 1891, which is shown in FIG. 24B and FIG. 25A overlaying a portion of the listing 1801 and including three user-selectable options 1892, 1893, and 1894 (which have been described above) that may be applied to Station 1. With reference to FIG. 25A, the user has opted to remove the selected Station 01 (Address 00221) by interacting with the graphical element 1895 associated with the remove option 1894. In response, the irrigation management application 114a causes the user interface 1800 to generate an interactive prompt 1832 shown in FIG. 25B as an overlay over the listing 1801 that requires the user to select an option 1833 (in this case, “Remove”) to confirm removal of the unique decoder address 1804 from association with Station 01 in the listing 1801, or to select an option 1834 (in this case, “Cancel”) to cancel the removal of the unique decoder address 1804 from association with Station 01 in the listing 1801.

In response to the user selecting the option 1833 from the interactive prompt 1832 to confirm the removal, from the listing 1801, of the unique decoder address 1804 (i.e., Address 00221) from association with Station 01, the irrigation management application 114a removes the Address 00221 from association with Station 01, and causes the user interface 1800 to display an updated listing 1801 of the irrigation stations 1802 as shown in FIG. 25C, with the updated listing 1801 displaying Station 01 as one of the irrigation stations 1802, but not displaying the Address 00221 as one of the decoder addresses 1804, such that Station 01 no longer has a decoder address 1804 assigned to it. In some aspects, the user interface 1800 permits the user to assign an unassigned decoder address 1804 (e.g., the unassigned “buffer” Address 00229) to Station 01, or to assign another user-selected unassigned decoder address 1804 to Station 01.

Notably, in the embodiment of FIG. 25C, the listing 1801 no longer includes the name (i.e., “Back Yard”) that was assigned to Station 01 (see FIG. 24A). In other words, the remove option 1894 removed not only the Address 00221 associated with Station 01 from the listing 1801, but also removed the name Back Yard from being associated with Station 01 in the listing 1801. However, in some aspects, the remove option 1894 may remove only the decoder address 1804 (i.e., Address 00221) associated with the irrigation station 1802 (i.e., Station 01) from the listing 1801 without removing the name (i.e., Back Yard) associated with Station 01 from the listing 1801.

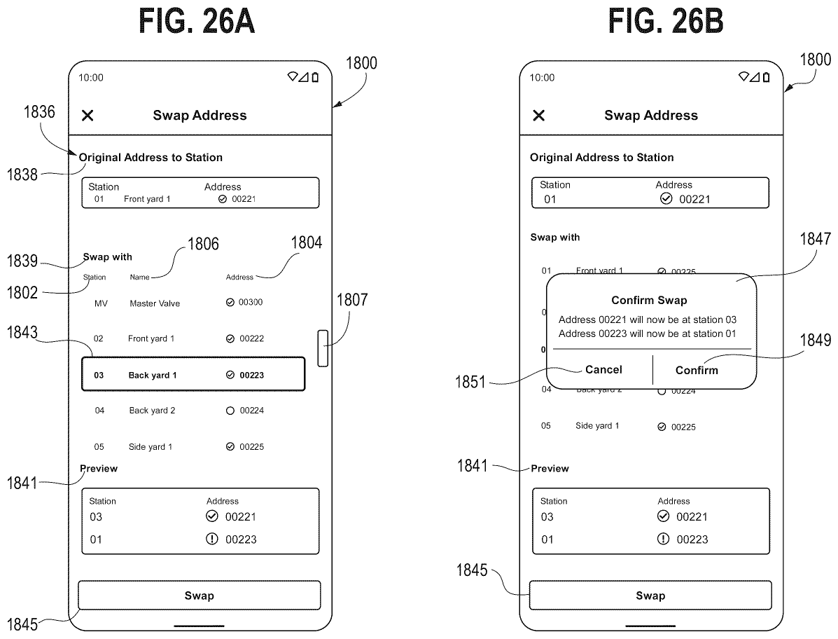

With reference back to FIGS. 25A, when the interactive station options menu 1891 is displayed to the user, responsive to the user's selection of option 1893, i.e., “Swap Address,” which the user would select with the intention of swapping the decoder address 1804 (i.e., Address 00221) of Station 01 with the decoder address 1804 of another irrigation station 1802, the irrigation management application 114a causes the user interface 1800 to generate an interactive swapping menu 1836 shown in FIG. 26A as an overlay over the listing 1801. The swapping menu 1836 shown in FIG. 26A includes a first informational field 1838 that displays the original decoder address 1804 assigned to Station 01, which, in this case, is Address 00221. The exemplary swapping menu 1836 of FIG. 26A further includes an interactive scrollable listing field 1839 that permits the user to scroll (e.g., using a scroll bar 1807) through a list of irrigation stations 1802 that have assigned decoder addresses 1804 and that are available for swapping their respective Addresses with the Address 00221 of Station 01. In FIG. 26A, the user has selected (e.g., by tapping, clicking a mouse, etc.) Station 03 for swapping the Address 00223 of Station 03 with the Address 00221 of Station 01. In some aspects, the irrigation station 1802 selected by the user for the swap is visually emphasized by a graphical element 1843 (e.g., color, bold font, etc.) to indicate that this irrigation station 1802 has been selected for the swap.

In the illustrated embodiment, the swapping menu 1836 further includes another informational field in the form of a preview window 1841. The exemplary preview window 1841 visually depicts both irrigation stations 1802, this example, Stations 01 and Stations 03, with their respective post-swap unique decoder address 1804 displayed. In other words, Station 01 is shown as having Address 00223 (formerly associated with Station 03) assigned to it, and Station 03 is shown as having Address 00221 (formerly associated with Station 01) assigned to it. In some embodiments, the preview window 1841 allows the user to see that proposed swap without having to make the proposed swap. This can help with potential user confusion while navigating the listing of the interactive scrollable listing field 1839 (e.g., the user may have scrolled beyond the selected station so that it is not visible in the listing).

Further, in the embodiment of FIG. 26A, the swapping menu 1836 further includes an interactive graphical element 1845 (e.g., a button, icon, etc.) that, when interacted with by the user, initiates the swap of the decoder addresses 1804 between the user-selected irrigation stations 1802, and causes the user interface 1800 to generate an interactive prompt 1847 shown in FIG. 26B as an overlay over the listing 1801. In the embodiment of FIG. 26B, the interactive prompt 1847 requires the user to select an option 1849 (in this example, a button or icon called “Confirm”) to confirm that, following the swap, Address 00221 will be assigned to Station 03 and that Address 00223 will be assigned to Station 01, or to select an option 1851 (in this example, a button or icon, “Cancel”) to cancel the swap. In some embodiments, the interactive prompt 1847 provides another verification of the proposed swap prior to initiating the station swap, e.g., in FIG. 26, the prompt 1847 displays “Address 00221 will now be at station 03” and “Address 00223 will now be at station 01”. This can provide a final verification and chance to not complete the swap if it is not as intended. While a swap can be changed back after confirmed, it can be easier for user to identify and fix errors in swapping and can result less chance of error by providing the swap preview of preview window 1841 and/or the swap confirmation in the interactive prompt 1847.

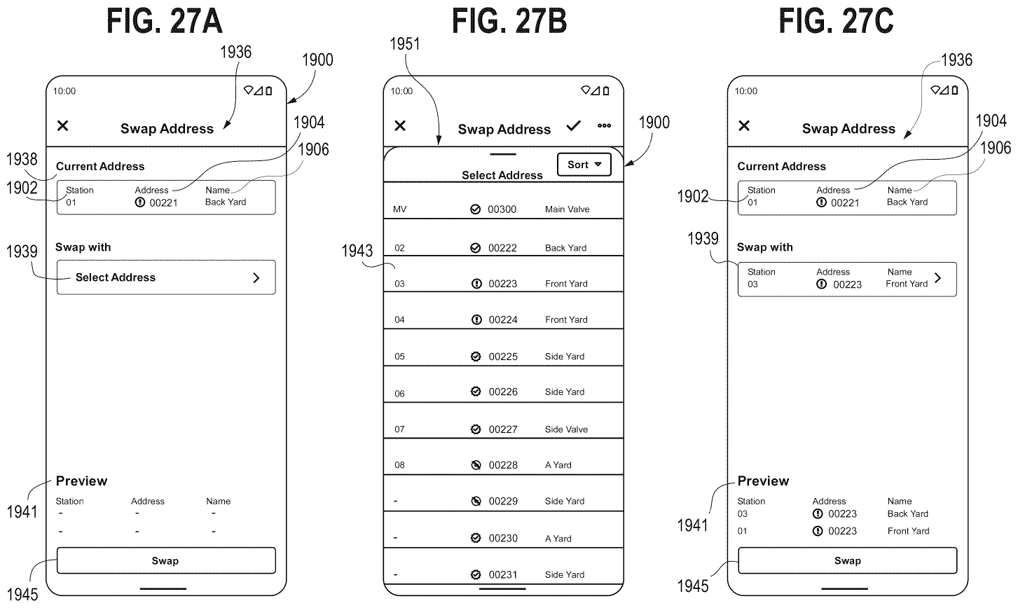

FIGS. 27A-27C illustrate an embodiment of a user interface 1900 that includes a swapping menu 1936 that represents an alternative embodiment to the swapping menu 1836 shown in FIG. 26A. Similarly to the swapping menu 1836 of FIG. 26A, the swapping menu 1936 shown in FIG. 27A includes a first informational field 1938 that displays the original decoder address 1904 assigned to Station 01, which, in this case, is 00221. Unlike the swapping menu 1836 of FIG. 26A, which includes an interactive scrollable listing field 1839 that permits the user to scroll through a listing of irrigation stations 1802 for the user to select for the swap, the exemplary swapping menu 1936 of FIG. 27A includes an interactive address select field 1939 (called “Select Address” in this example) that, when interacted with, generates a swap address selection menu 1951 shown in FIG. 27B that includes a scrollable listing of irrigation device (e.g., decoder) addresses, some of which may be assigned to irrigation stations (8 exemplary decoder addresses assigned to irrigation stations are shown in FIG. 27B), and some of which may be unassigned (4 exemplary decoder addresses that are unassigned are shown in FIG. 27B), that may be selected by the user for a swap with the decoder address 1904 (i.e., 00221) of Station 01. In some embodiments, this provides a listing with more swap options viewable at once to the user than the embodiments of FIGS. 26A-26B.

The exemplary swap address selection menu 1951 of FIG. 27B includes a scrollable listing of irrigation stations that permits the user to scroll through the irrigation device addresses 1904 that may be swapped with the Address 00221 of Station 01. In FIG. 27B, the user has selected (e.g., by tapping, clicking a mouse, etc.) Station 03 for swapping its Address 00223 with the Address 00221 of Station 01. Similarly to the user interface 1800, the user interface 1900 causes the irrigation station 1902 (i.e., Station 03) selected by the user for the swap to be visually emphasized by a graphical element 1943 (e.g., color, bold font, etc.) to indicate that Station 03 has been selected for the decoder address swap.

In the illustrated embodiment, responsive to the user's selection of station 03 for the Address swap, the user interface 1900 closes (i.e., hides) the swap address selection menu 1951 and reverts back to the swapping menu 1936. However, unlike the interactive address select field 1939 of the swapping menu 1936 of FIG. 27A, the interactive address select field 1939 of the user interface 1900 shown in FIG. 27C no longer includes the informational message such as “Select Address,” which is aimed at prompting the user to initiate a decoder address swap, and instead provides information relating to Station 03, which the user selected for the decoder address swap. In the example shown in FIG. 27C, the interactive address select field 1939 displays the irrigation station 1902 (i.e., Station 03) selected for the swap, the decoder address 1904 (i.e., Address 00223) of the irrigation station 1902 selected for the swap, and the name 1906 (i.e., Front Yard) of the irrigation station 1902 selected for the swap.

Similarly to the swapping menu 1836 of FIG. 26A, the swapping menu 1936 further includes a preview window 1941, which is akin to the preview window 1841 shown in FIG. 26A in that the preview window 1941 visually depicts both irrigation stations 1902 being swapped with their respective post-swap unique decoder addresses 1904. In other words, in the preview window 1941 of FIG. 27C, Station 01 is shown as having Address 00223 (formerly associated with Station 03) assigned to it, and Station 03 is shown as having Address 00221 (formerly associated with Station 01) assigned to it. Further, like the swapping menu 1836 of FIG. 26A, the swapping menu 1936 of FIG. 27C further includes an interactive graphical element 1945 (e.g., a button, icon, etc.) that, when interacted with by the user, initiates the swap of the decoder addresses 1904 between the user-selected irrigation stations 1902. And similar to the embodiments of FIGS. 26A-26B, the preview window 1941 and the element 1945 of the swapping menu 1936 of FIG. 27C can provide a final verification and chance to not complete the swap if it is not as intended. While a swap can be changed back after confirmed, it can be easier for user to identify and fix errors in swapping and can result less chance of error by providing the identified addresses in fields 1904 and 1939 and/or the swap preview of preview window 1941.

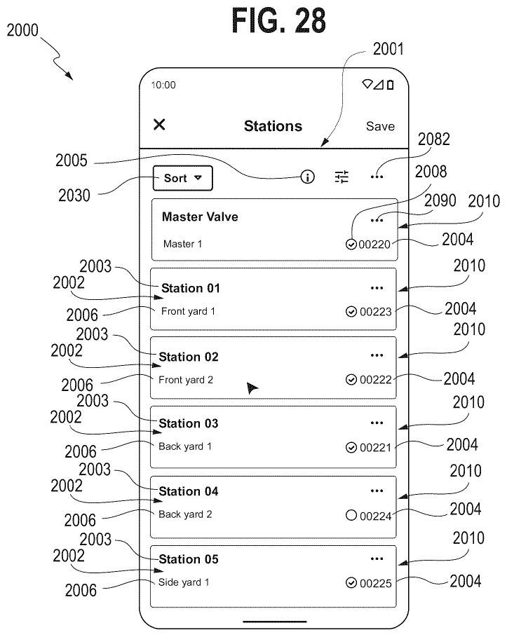

In the embodiment of FIG. 28, a user interface 2000 with an alternative version of the listing 1801 of FIG. 18A is shown. Generally, in the example shown in FIG. 28, instead of a single listing 1801 that lists the irrigation stations 1802, the user interface 2000 displays visually distinct, interactive blocks or sections 2010 (akin to a “v-card”) such that each of the interactive blocks or sections 2010 is associated with a single irrigation station 2002. In other words, in the embodiment shown in FIG. 28, the user interface 2000 does not include a single listing of five irrigation stations 2002, but instead includes six distinct interactive blocks or sections 2010. As illustrated in FIG. 28, each interactive block or section 2010 corresponds to a single irrigation station 2002 and is visually distinguishable (and, preferably, separate and distinct) from the other interactive blocks or sections 2010 corresponding to the other irrigation stations 2002.

More specifically, in the example shown in FIG. 28, six separate and distinct interactive blocks or sections 2010 are shown: a first block or section 2010 is associated with an irrigation station 2002 having an identifier 2003 “Master Valve,” a name 2006 “Master 1,” and a decoder address 2004 “00220;” a second block or section 2010 is associated with an irrigation station 2002 having an identifier 2003 “Station 01,” a name 2006 “Front yard 1,” and a decoder address 2004 “00223;” a third block or section 2010 is associated with an irrigation station 2002 having an identifier 2003 “Station 02,” a name 2006 “Front yard 2,” and a decoder address 2004 “00222;” a fourth block or section 2010 is associated with an irrigation station 2002 having an identifier 2003 “Station 03,” a name 2006 “Back yard 1,” and a decoder address 2004 “00221;” a fifth block or section 2010 is associated with an irrigation station 2002 having an identifier 2003 “Station 04,” a name 2006 “Back yard 2,” and a decoder address 2004 “00224;” and a sixth block or section 2010 is associated with an irrigation station 2002 having an identifier 2003 “Station 05,” a name 2006 “Side yard 1,” and a decoder address 2004 “00225.”

In some embodiments, adjacent to each of the decoder addresses 2004 is a status indicator, which, in the example illustrated in FIG. 28, is a graphical element in the form of a status icon 2008. Similarly to the status icon 1808 shown in FIG. 18A, the status icon 2008 visually indicates a status of the decoder address 2004 adjacent to which the status icon 1808 is located. Also similarly to the user interface 1800 shown in FIG. 18A, the user interface 2000 includes an interactive “information” icon 2005, which, when interacted with by the user, would cause the user interface 2000 to generate a status definition menu akin to the status definition menu 1812 shown in FIG. 18B that includes informational fields indicating the definition (i.e., meaning) of each of the status icons 1808. Also similarly to the user interface 1800 shown in FIG. 18A, the user interface 2000 includes an interactive sorting icon or sorting feature 2030, which, when interacted with by the user, permits the user to select one of a plurality of sort options for sorting how the interactive blocks or sections 2010 are displayed within the user interface 2000. Also similarly to the user interface 1800 shown in FIG. 18A, the user interface 2000 includes an interactive feature selection option 2082, which is in the form of ellipses (but could be in the form of another symbol or shape), and which, when interacted with by the user, would cause the user interface 2000 to generate a features menu akin to the features menu 1883 shown in FIG. 23B. Also similarly to the user interface 1800 shown in FIG. 18A, the user interface 2000 includes an interactive options feature 2090 in the form of ellipses (but could be in the form of another symbol or shape) that, when interacted with by the user, causes the user interface 2000 to generate an interactive station options menu akin to the station options menu 1891 shown in FIG. 24B overlaying a portion of the listing 2001 and including user-selectable options applicable to a user-selected irrigation station 2002.

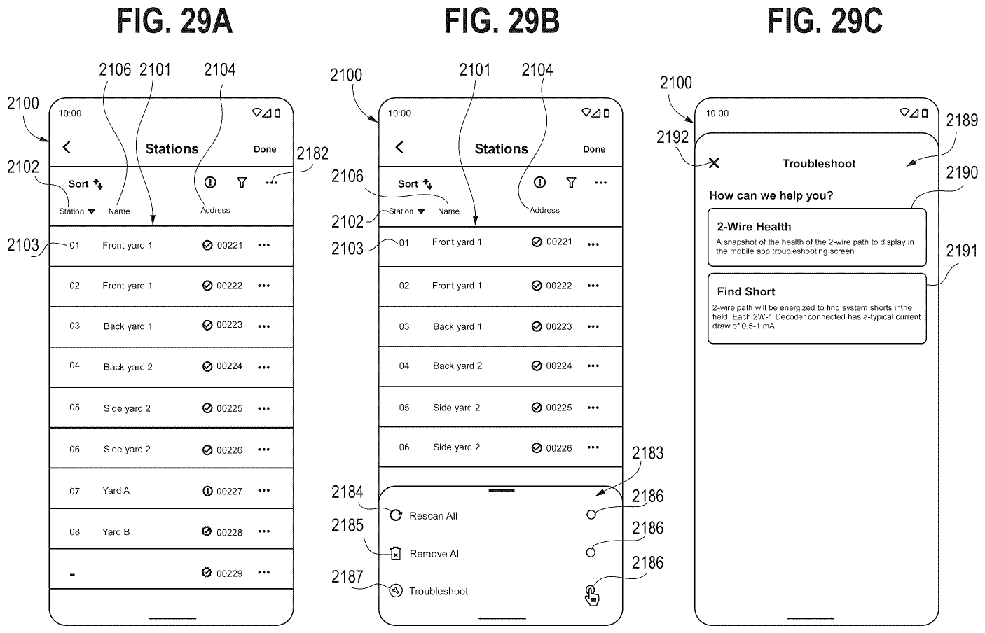

In the embodiment shown in FIG. 29A, a user interface 2100 includes an interactive feature selection option 2182 akin to the feature selection option 2182 shown in FIG. 23A. In the embodiment illustrated in FIG. 29A, the interactive feature selection option 2182 is in the form of ellipses (but could be in the form of another symbol or shape) that, when interacted with by the user, causes the user interface 2100 to generate a features menu 2183 (akin to the features menu 1883 in FIG. 23B) overlaying a portion of the listing 2101 and including three (but could be less or more) features for the user to choose from. Like the features menu 1883 of FIG. 23B, the features menu 2183 shown in FIG. 29B includes an interactive decoder address rescan feature 2184, which, when interacted with by the user, permits the user to cause the irrigation management application 114a to rescan the irrigation system to detect all unique decoder addresses 2104 connected to the multi-wire path. Also like the features menu 1883 of FIG. 23B, the features menu 2183 shown in FIG. 29B includes an interactive remove all feature 2185, which, when interacted with by the user, permits the user to cause the irrigation management application 114a to update the user interface 2100 by removing all of the unique decoder addresses 2104 listed in the listing 2101 from association with the irrigation stations 2102 (each of which may have an identifier 2103, an address 2104, and a names 2106).

Unlike the features menu 1883 of FIG. 23B, the features menu 2183 according to the embodiment of FIG. 29B further includes a troubleshoot feature 2187, which, when interacted with by the user, permits the user to cause the irrigation management application 114a to troubleshoot the irrigation stations 2102 in the listing 2101 and connected to the multi-wire path 16. In the embodiment illustrated in FIG. 29B, the troubleshoot feature 2187 may be selected by the user within the features menu 2183 by interacting with an interactive graphical element 2186 (e.g., a radial button, checkbox, etc.) associated therewith (the interactive graphical element 2186 associated with troubleshoot feature 2187 is shown as being selected in FIG. 29B).

In one aspect, responsive to an interaction by the user with the graphical element 2186 to select the troubleshoot feature 2187, the irrigation management application 114a causes the user interface 2100 to generate an interactive troubleshooting menu 2189 as shown in FIG. 29C, which includes two troubleshooting/diagnostic modes for the user to choose from (but it will be appreciated that, in some embodiments, the troubleshooting menu 2189 may include more than two troubleshooting/diagnostic modes that may be selected by the user). The exemplary troubleshooting menu 2189 shown in FIG. 29C includes an interactive multi-wire health option 2190 that permits the user to activate a multi-wire health mode and obtain a snapshot of a health of the multi-wire path 16 associated with the irrigation stations 2102 in the listing. In addition, the exemplary troubleshooting menu 2189 shown in FIG. 29C includes an interactive find short option 2191 that permits the user to activate a find multi-wire path short mode and energize the multi-wire path 16 to find one or more electrical shorts in the multi-wire path 16. In addition, the exemplary troubleshooting menu 2189 of FIG. 29C of the user interface 2100 includes an interactive button or icon 2192 (which is in the form of an “x” in this example), which, when interacted with by the user, permits the user to close troubleshooting menu 2189 and return to the listing 2001 shown in FIG. 29A.

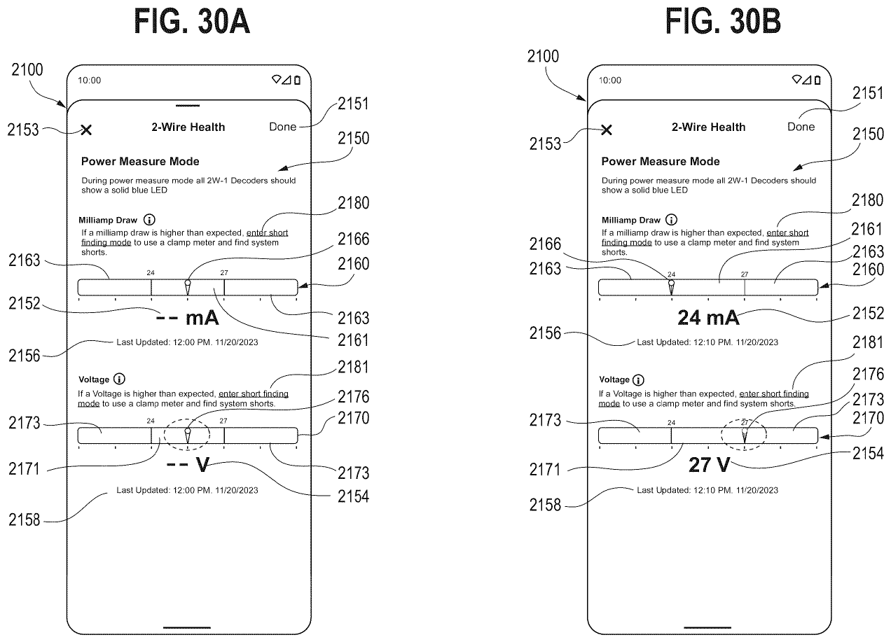

In some aspects, when the interactive multi-wire health option 2190 is interacted with by the user, the irrigation management application 114a causes the user interface 2100 to generate an interactive health snapshot menu 2150 (shown in FIG. 30A) overlaying a portion of the listing 2101 and including various informational fields. In the embodiment of FIG. 30A, the health snapshot menu 2150 provides informational data indicators for the current being drawn from the irrigation controller on the multi-wire path 16 and for voltage on the multi-wire path 16. In the case, where there are no prior current or voltage readings available, the default health snapshot menu 2150 as shown in FIG. 30A is displayed to the user. In some aspects, when the interactive multi-wire health option 2190 is interacted by the user, a control signal is sent to the irrigation controller to cause the irrigation controller 202 to measure the current draw and voltage and return data back to the user interface 2100 to populate the informational fields indicating the measured current draw and voltage as shown in the health snapshot menu 2150.

With reference to FIGS. 30A and 30B, the health snapshot menu 2150 includes a first informational field 2152 to indicate a numerical value of a measured current draw. In FIG. 30A, the first informational field 2152 does not indicate a numerical value of the measured current draw because there are no prior current draw readings available. On the other hand, in FIG. 30B, the first informational field 2152 indicates that the numerical value of the measured current draw is 24 mA. Similarly, the health snapshot menu 2150 includes a second informational field 2154 to indicate a numerical value of a measured voltage. In FIG. 30A, the second informational field 2154 does not indicate a numerical value of the measured voltage because there are no prior voltage readings available. On the other hand, in FIG. 30B, the second informational field 2154 indicates that the numerical value of the measured voltage is 27 V. The exemplary health snapshot menu 2150 further includes a third informational field 2156 to indicate a time and date of a most recent update of the current draw. In FIGS. 30A, the third informational field 2156 indicates that the most recent update of the current draw was at 12:00 PM on Nov. 20, 2023. On the other hand, in FIG. 30B, the third informational field 2156 indicates that the most recent update of the current draw was at 12:10 PM on Nov. 20, 2023. The exemplary health snapshot menu 2150 further includes a fourth informational field 2158 to indicate a time and date of a most recent measured update of the voltage. In FIGS. 30A, the fourth informational field 2158 indicates that the most recent update of the voltage was at 12:00 PM on Nov. 20, 2023. On the other hand, in FIG. 30B, the fourth informational field 2158 indicates that the most recent update of the voltage was at 12:10 PM on Nov. 20, 2023.

With reference to FIGS. 30A and 30B, the health snapshot menu 2150 includes a first value bar 2160 to indicate a range of nominal values of the measured current draw and a range of outlier values of the measured current draw. Notably, in some embodiments, the user interface 2100 does not include the first value bar 2160. That is, the first value bar 2160 is an optional feature of the user interface 2100. In some embodiments, a central region 2161 of the first value bar 2160 represents the current values expected for normal operation, whereas the periphery regions 2163 of the first value bar 2160 represent the current values above and below those expected for normal operation.

In the embodiment illustrated in FIGS. 30A-30B, the first value bar 2160 includes a first visual indicator 2166. In the example shown in FIG. 30A, the first visual indicator 2166 is positioned at the center of the first value bar 1260 at a default location because there are no prior current draw readings available. On the other hand, in the example of FIG. 30B, the first visual indicator 2166 is positioned at location that corresponds to the numerical value (i.e., 24 mA) of the measured current draw (which is also shown in the first informational field 2152 in FIG. 30A).

With reference to FIGS. 30A and 30B, the health snapshot menu 2150 includes a second value bar 2170 to indicate a range of nominal values of the measured voltage and a range of outlier values of the measured voltage. Notably, the second value bar 2170 is an optional feature of the user interface 2100 such that, in some embodiments, the user interface 2100 does not include the second value bar 2170. In the illustrated embodiment, a central region 2171 of the second value bar 2170 represents the voltage values expected for normal operation, whereas the periphery regions 2173 of the second value bar 2170 represent the voltage values above and below those expected for normal operation. In the embodiment illustrated in FIGS. 30A-30B, the second value bar 2170 includes a second visual indicator 2176. In the example of FIG. 30A, the second visual indicator 2176 is positioned at the center of the second value bar 1270 at a default location because there are no prior voltage readings available. On the other hand, in the example of FIG. 30B, the second visual indicator 2176 is positioned at location that corresponds to the numerical value (i.e., 27 V) of the measured voltage (which is also indicated in the second informational field 2154 in FIG. 30A).

In some embodiments, the user interface 2100 may provide guidance to the user, for example, by instructing the user to enter a short finding mode (discussed in more detail below) if the current or voltage is higher than expected. In particular, in the embodiment of FIG. 30B, the health snapshot menu 2150 further includes a first interactive link 2180 associated with the current draw and configured to permit the user to enter the find multi-wire path short mode without interacting with the interactive find short option 2191 of the troubleshooting menu 2189. In addition, the health snapshot menu 2150 of FIG. 30B further includes a second interactive link 2181 associated with the voltage and configured permit the user to enter the find multi-wire path short mode without interacting with the interactive find short option 2191 of the troubleshooting menu 2189.

In the embodiment illustrated in FIG. 30B, the exemplary health snapshot menu 2150 of the user interface 2100 includes an interactive button or icon 2151 (called “Done” in this example), which, when interacted with by the user, closes the health snapshot menu 2150 and returns the user interface 2100 to the listing 2101 of the irrigation stations 2102 as shown in FIG. 29A. In addition, the exemplary health snapshot menu 2150 of the user interface 2100 includes an interactive button or icon 2153 (which is in the form of an “x” in this example), which, when interacted with by the user, permits the user to close the health snapshot menu 2150 and return to the interactive troubleshooting menu 2189 shown in FIG. 29C.

In some embodiments, responsive to a selection by the user of the interactive multi-wire health option 2190 to activate the multi-wire health mode, the irrigation management application 114a causes the irrigation controller to continuously measure the current draw and/or the voltage and update the measured current and/or voltage values in real time while the multi-wire health mode is active at certain predetermined intervals, such as, every second, every 5 seconds, every 30 seconds, every minute, etc. In some embodiments, when the multi-wire health mode is active, the LEDs of a decoder being diagnosed will be illuminated in a predetermined color (e.g., solid blue) to visually indicate that current and/or voltage measurements are being taken.

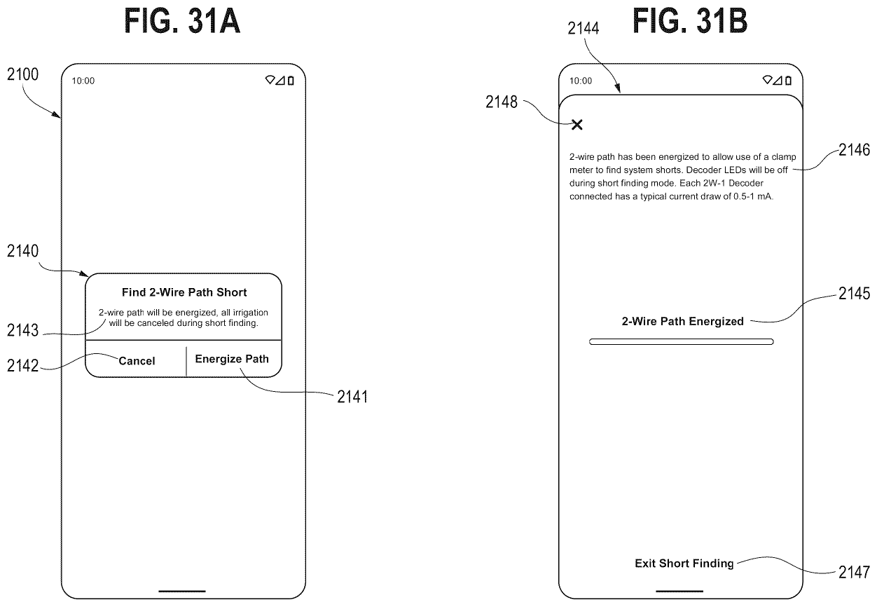

In some aspects, when the interactive find short option 2191 is interacted with by the user from the interactive troubleshooting menu 2189, the irrigation management application 114a causes the user interface 2100 to display an interactive prompt 2140 shown in FIG. 31A overlaying a portion of the listing 2101. In the embodiment of FIG. 31A, the interactive prompt 240 requires the user to interact with an option to proceed with the find multi-wire path short mode or to interact with an option to cancel the find multi-wire path short mode.

In particular, the interactive prompt 2140 includes an interactive graphical element 2141 (called “Energize Path”), which when interacted with by the user, causes the irrigation management application 114a to cause a current to be transmitted along the multi-wire path 16 to energize the multi-wire path 16. In addition, the interactive prompt 2140 includes an interactive graphical element 2142 (called “Cancel”), which when interacted with by the user, cancels the find multi-wire path short mode and does not cause the irrigation management application 114a to cause a current to be transmitted along the multi-wire path 16 to energize the multi-wire path 16. In the embodiment illustrated in FIG. 31A, the interactive prompt 2140 further includes an informational field 2143 that visually indicates to the user that, if the find multi-wire path short mode is activated, the multi-wire path will be energized, and all irrigation will be cancelled while the multi-wire path short mode is active.

In some aspects, when the interactive graphical element 2141 is interacted by the user to activate the multi-wire path short mode and to cause a current to be transmitted along the multi-wire path 16 to energize the multi-wire path 16 the irrigation management application 114a causes the user interface 2100 to generate an informational short finding menu 2144 shown in FIG. 31B as an overlay over the listing 2101 of the irrigation stations 2102. In the embodiment illustrated in FIG. 31B, the informational short finding menu 2144 includes a first informational field 2145 that visually indicates to the user that the multi-wire path has been energized.

As is common, the irrigation controller switches a constant voltage source to the multi-wire path 16. When the multi-wire path 16 is energized, the user can apply a clamp meter at various locations of the multi-wire path 16 to determine if and where there is a short. In some embodiments, any active irrigation by the irrigation stations 2102 will be canceled while the multi-wire path 16 is energized, decoder LEDs are off, and each decoder will typically draw 0.5-1 mA. The exemplary informational short finding menu 2144 illustrated in FIG. 31B further includes a second informational field 2146 that visually indicates to the user that the multi-wire path has been energized to allow the use of a clamp meter to find system shorts, and that the decoder LEDs will be off during the multi-path short finding mode, and that each connected decoder will have a current draw of 0.5-1 mA while the multi-wire short finding mode is active.

In the embodiment illustrated in FIG. 31B, the exemplary informational short finding menu 2144 of the user interface 2100 includes an interactive button or icon 2147 (called “Exit Short Finding” in this example), which, when interacted with by the user, closes the informational short finding menu 2144 and returns the user interface 2100 to the listing 2101 of the irrigation stations 2102 as shown in FIG. 29A. In addition, the exemplary informational short finding menu 2144 shown in FIG. 31B includes an interactive button or icon 2148 (which is in the form of an “x” in this example), which, when interacted with by the user, permits the user to close the informational short finding menu 2144 and return to the interactive troubleshooting menu 2189 shown in FIG. 29C.

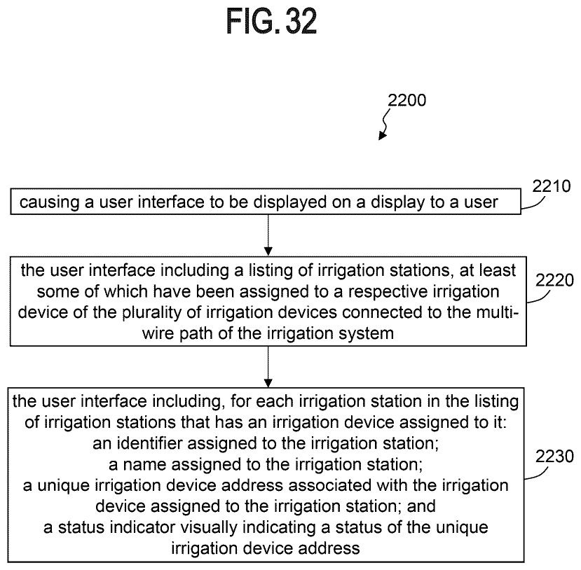

FIG. 32 illustrates a simplified flow diagram of an exemplary method 2200 of managing irrigation in accordance with some embodiments. In step 2210, the method 2200 includes causing a user interface (e.g., user interfaces 1800, 2000, 2100 described above) to be displayed on a display to a user. In step 2220, the method 2200 includes causing the user interface to display a listing of irrigation stations, at least some of which have been assigned to a respective irrigation device of the plurality of irrigation devices connected to the multi-wire path of the irrigation system (e.g., listing 1801, 1901, 2001 described above). In step 2230, the method 2200 further includes the user interface including, for each irrigation station in the listing of irrigation stations that has an irrigation device assigned to it: an identifier assigned to the irrigation station (e.g., identifier 1803 described above); a name assigned to the irrigation station (e.g., name 1806 described above); a unique irrigation device address associated with the irrigation device assigned to the irrigation station (e.g., address 1804 described above); and a status indicator visually indicating a status of the unique irrigation device address (e.g., status icon 1808 and FIGS. 18A-18C described above).

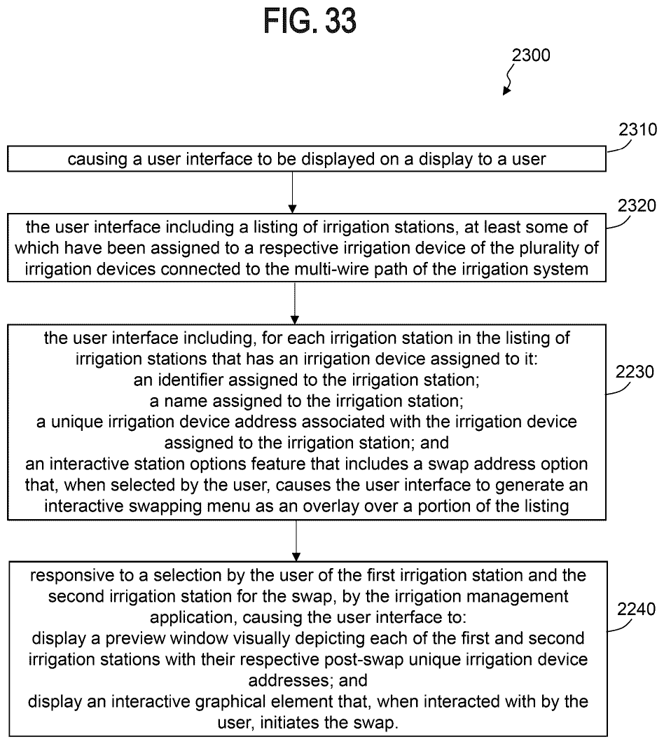

FIG. 33 illustrates a simplified flow diagram of an exemplary method 2300 of managing irrigation in accordance with some embodiments. In step 2310, the method 2300 includes causing a user interface (e.g., user interfaces 1800, 2000, 2100 described above) to be displayed on a display to a user. In step 2320, the method 2300 includes causing the user interface to display a listing of irrigation stations, at least some of which have been assigned to a respective irrigation device of the plurality of irrigation devices connected to the multi-wire path of the irrigation system (e.g., listing 1801, 1901, 2001 described above). In step 2230, the method 2200 further includes the user interface including, for each irrigation station in the listing of irrigation stations that has an irrigation device assigned to it: an identifier assigned to the irrigation station (e.g., identifier 1803 described above); a name assigned to the irrigation station (e.g., name 1806 described above); a unique irrigation device address associated with the irrigation device assigned to the irrigation station (e.g., address 1804 described above); and an interactive station options feature that includes a swap address option (e.g., swap address option 1893 described above) that, when selected by the user, causes the user interface to generate an interactive swapping menu (e.g., swapping menu 1836 described above) as an overlay over a portion of the listing to permit the user to select a first irrigation station of the irrigation stations and a second irrigation station of the irrigation stations to perform a swap of the unique irrigation device address assigned to the first irrigation station with the unique irrigation device address assigned to the second irrigation station. Step 2240 of the method 2200 further includes, responsive to a selection by the user of the first irrigation station and the second irrigation station for the swap, by the irrigation management application, causing the user interface to: display a preview window visually depicting each of the first and second irrigation stations with their respective post-swap unique irrigation device addresses; and display an interactive graphical element that, when interacted with by the user, initiates the swap (e.g., FIGS. 26A-26B).

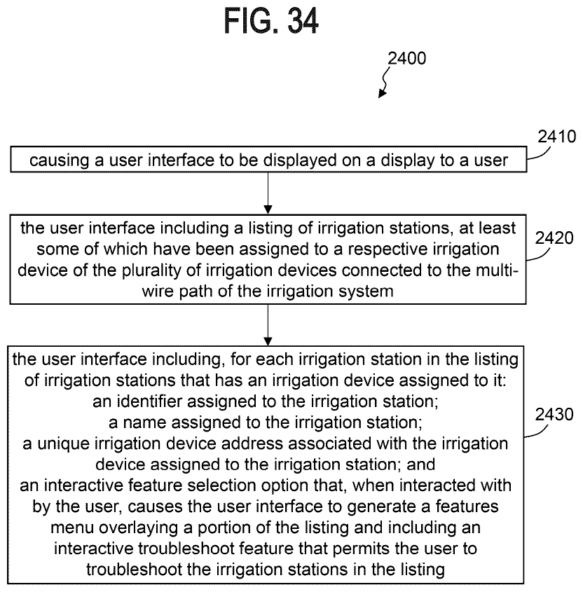

FIG. 34 illustrates a simplified flow diagram of an exemplary method 2400 of managing irrigation in accordance with some embodiments. In step 2410, the method 2400 includes causing a user interface (e.g., user interfaces 1800, 2000, 2100 described above) to be displayed on a display to a user. In step 2420, the method 2400 includes causing the user interface to display a listing of irrigation stations, at least some of which have been assigned to a respective irrigation device of the plurality of irrigation devices connected to the multi-wire path of the irrigation system (e.g., listing 1801, 1901, 2001 described above). In step 2430, the method 2400 further includes the user interface including, for each irrigation station in the listing of irrigation stations that has an irrigation device assigned to it: an identifier assigned to the irrigation station (e.g., identifier 1803 described above); a name assigned to the irrigation station (e.g., name 1806 described above); a unique irrigation device address associated with the irrigation device assigned to the irrigation station (e.g., address 1804 described above); and an interactive feature selection option that, when interacted with by the user, causes the user interface to generate a features menu overlaying a portion of the listing and including an interactive troubleshoot feature that permits the user to troubleshoot the irrigation stations in the listing (e.g., feature selection option 2182 and features menu 1883 and FIGS. 29A-31B described above).

In some embodiments, the activation, control and/or display of data from the diagnostic modes is performed using the user interface rather than at a controller interface saving time and providing convenience for the user.

Some embodiments provide an irrigation management system that includes an irrigation management application for use in monitoring and/or controlling irrigation of an irrigation area by an irrigation system including a plurality of irrigation devices configured to be connected to a multi-wire path of the irrigation system. The irrigation management application comprises computer program code to be executed by an electronic device including a control circuit. When executed by the control circuit, the irrigation management application causes a user interface to be displayed on a display to a user. The user interface includes: a listing of irrigation stations, at least some of which have been assigned to a respective irrigation device of the plurality of irrigation devices connected to the multi-wire path of the irrigation system; and for each irrigation station in the listing of irrigation stations that has an irrigation device assigned to it: an identifier assigned to the irrigation station; a name assigned to the irrigation station; a unique irrigation device address associated with the irrigation device assigned to the irrigation station; and a status indicator visually indicating a status of the unique irrigation device address.

In some aspects, the status indicator includes a visual indicator that indicates that the unique irrigation device address is at least one of: an existing unique irrigation device address pre-assigned to the irrigation station; a new unique irrigation device address discovered and assigned to the irrigation station; a previously discovered unique irrigation device address that is not found in a new irrigation device address scan; and an excess unique irrigation device address discovered and not assigned to any one of the irrigation stations of the irrigation system. In some implementations, responsive to a selection of a first one of the irrigation stations or a first one of the irrigation device addresses in the listing, the irrigation management application causes the user interface to generate a graphical element adjacent to or surrounding the status indicator to visibly indicate that the first one of the irrigation stations or the first one of the unique irrigation device address in the listing has been selected by the user.

In certain embodiments, the listing includes one or more unique irrigation device addresses not assigned to any of the irrigation stations in the listing. In some aspects, the user interface permits the user to update the listing of the irrigation stations by manually adding to the listing of the irrigation stations an additional irrigation station having a pre-assigned unique irrigation device address. In some implementations, the user interface further includes an interactive irrigation device address scan feature that permits the user to cause the irrigation management application to scan the irrigation system to detect all unique irrigation device addresses connected to the multi-wire path. In some embodiments, responsive to an interaction by the user with the interactive irrigation device address scan feature, the irrigation management application causes the user interface to generate an interactive prompt that requires the user to select an option that indicates whether the irrigation system includes a master valve.

In some aspects, responsive a selection by the user of the option indicating that the irrigation system includes the master valve, the irrigation management application at least one of: performs a scan for the unique addresses of the irrigation devices coupled to the multi-wire path; causes the user interface to generate an on-screen informational field indicating that the scan of the unique addresses of the irrigation devices is being performed; and causes the user interface to display an updated listing of the irrigation stations, the updated listing of the irrigation stations including the unique irrigation device addresses detected connected to the multi-wire path that were identified during the scan.

In some embodiments, the listing comprises: a plurality of distinct interactive blocks or sections, each of the interactive blocks or sections being associated with a single irrigation station of the irrigation stations in the listing and including: an identifier assigned to the single irrigation station; a name assigned to the single irrigation station; a unique irrigation device address associated with the irrigation device assigned to the single irrigation station; and a status indicator visually indicating a status of the unique irrigation device address assigned to the single irrigation station. In some aspects, the user interface permits the user to assign more than one unique irrigation device address to any one of the irrigation stations in the listing.

In some implementations, the user interface further includes an interactive sorting feature to permit the user to select one of a plurality of sort options for sorting how the irrigation stations are displayed in the listing; and responsive to a selection of the interactive sorting feature by the user, the user interface generates an interactive sorting menu as an overlay over a portion of the listing, the interactive sorting menu including an option to sort the irrigation stations by status of the unique irrigation device address. In some aspects, the sort options of the interactive sorting menu further include at least one of: an option to sort the irrigation stations by respective identifiers of the irrigation stations, an option to sort the irrigation stations by respective names assigned to the irrigation stations, and an option to sort the irrigation stations by respective unique irrigation device addresses assigned to the irrigation stations.

In some embodiments, the user interface further includes an interactive filtering feature and, responsive to a selection by the user of the filtering feature, the user interface generates an interactive filtering menu overlaid over a portion of the listing; and the interactive filtering menu includes one or more filtering options selectable by the user in association with filtering the irrigation stations by the status of the unique irrigation device address, the filtering options including at least one of: an option to filter the irrigation stations by existing unique irrigation device addresses pre-assigned to the irrigation stations; an option to filter the irrigation stations by new unique irrigation device addresses discovered and assigned to the irrigation station; an option to filter the irrigation stations by previously discovered unique irrigation device addresses that are not found in a new irrigation device address scan; and an option to filter the irrigation stations by excess unique irrigation device addresses discovered and not assigned to any one of the irrigation stations of the irrigation system.

In certain aspects, the user interface further includes an interactive search feature that, when interacted with by the user, permits the user to enter a search query into a freeform text input field to search for at least one of the identifier of the irrigation station of the irrigation stations in the listing, the name of the irrigation station of the irrigation stations in the listing, and the unique irrigation device address of the irrigation station of the irrigation stations in the listing.

Some embodiments provide a method of managing irrigation including: by an irrigation management application comprising computer program code to be executed by an electronic device including a control circuit, the irrigation management application being for use in monitoring and/or controlling irrigation of an irrigation area by an irrigation system including a plurality of irrigation devices configured to be connected to a multi-wire path of the irrigation system, and, in response to being executed by the control circuit of the electronic device: causing a user interface to be displayed on a display to a user, the user interface including: a listing of irrigation stations, at least some of which have been assigned to a respective irrigation device of the plurality of irrigation devices connected to the multi-wire path of the irrigation system; and for each irrigation station in the listing of irrigation stations that has an irrigation device assigned to it: an identifier assigned to the irrigation station; a name assigned to the irrigation station; a unique irrigation device address associated with the irrigation device assigned to the irrigation station; and a status indicator visually indicating a status of the unique irrigation device address.

Some embodiments provide an irrigation management system that includes an irrigation management application for use in monitoring and/or controlling irrigation of an irrigation area by an irrigation system including a plurality of irrigation devices configured to be connected to a multi-wire path of the irrigation system. The irrigation management application comprises computer program code to be executed by an electronic device including a control circuit. When executed by the control circuit, the irrigation management application causes a user interface to be displayed on a display to a user. The user interface includes: a listing of irrigation stations, at least some of which have been assigned to a respective irrigation device of the plurality of irrigation devices connected to the multi-wire path of the irrigation system; and for each irrigation station in the listing of irrigation stations that has an irrigation device assigned to it: an identifier assigned to the irrigation station; a name assigned to the irrigation station; a unique irrigation device address associated with the irrigation device assigned to the irrigation station; and an interactive station options feature that includes a swap address option that, when selected by the user, causes the user interface to generate an interactive swapping menu as an overlay over a portion of the listing to permit the user to select a first irrigation station of the irrigation stations and a second irrigation station of the irrigation stations to perform a swap of the unique irrigation device address assigned to the first irrigation station with the unique irrigation device address assigned to the second irrigation station. Responsive to a selection by the user of the first irrigation station and the second irrigation station for the swap, the irrigation management application causes the user interface to: display a preview window visually depicting each of the first and second irrigation stations with their respective post-swap unique irrigation device addresses; and display an interactive graphical element that, when interacted with by the user, initiates the swap.

In some aspects, the interactive swapping menu includes a scrollable listing of the irrigation stations available for the swap, the scrollable listing of the irrigation stations permitting the user to select the second irrigation station for the swap by interacting with the second irrigation station in the scrollable listing. In some implementations, the interactive swapping menu further includes an interactive address select field that, when interacted with by the user, causes the user interface to display the scrollable listing of the irrigation stations available for the swap; and responsive to an interaction by the user with the second irrigation station in the scrollable listing, the irrigation management application causes the user interface to: hide the scrollable listing and display the first irrigation station and the second irrigation station selected by the user for the swap; display the preview window visually depicting each of the first and second irrigation stations with their respective post-swap unique irrigation device addresses; and display the interactive graphical element that, when interacted with by the user, initiates the swap. In some embodiments, the interactive station options feature includes a station edit option that, when selected by the user, causes the user interface to generate an interactive station options menu as an overlay over a portion of the listing to permit the user to at least one of: change the name of the irrigation station; upload a photograph of a physical location where the irrigation station is located; and view and modify one or more operational parameters of the irrigation station.

In certain implementations, the interactive station options feature includes a station remove option that, when selected by the user, causes the user interface to: generate an interactive prompt as an overlay over the listing of stations, the interactive prompt including a user-selectable option for the user to confirm or cancel removal of the unique irrigation device address from being assigned to the irrigation station in the listing; and remove from the listing, in response to an interaction by the user with the option to confirm the removal of the unique irrigation address from being assigned to the irrigation station in the listing, the unique irrigation device address selected by the user to be removed from being assigned to the irrigation station.

Some embodiments provide a method of managing irrigation including: by an irrigation management application comprising computer program code to be executed by an electronic device including a control circuit, the irrigation management application being for use in monitoring and/or controlling irrigation of an irrigation area by an irrigation system including a plurality of irrigation devices configured to be connected to a multi-wire path of the irrigation system, and, in response to being executed by the control circuit of the electronic device:
causing a user interface to be displayed on a display to a user, the user interface including:
a listing of irrigation stations, at least some of which have been assigned to a respective irrigation device of the plurality of irrigation devices connected to the multi-wire path of the irrigation system; and for each irrigation station in the listing of irrigation stations that has an irrigation device assigned to it: an identifier assigned to the irrigation station; a name assigned to the irrigation station; a unique irrigation device address associated with the irrigation device assigned to the irrigation station; and an interactive station options feature that includes a swap address option that, when selected by the user, causes the user interface to generate an interactive swapping menu as an overlay over a portion of the listing to permit the user to select a first irrigation station of the irrigation stations and a second irrigation station of the irrigation stations to perform a swap of the unique irrigation device address assigned to the first irrigation station with the unique irrigation device address assigned to the second irrigation station. Responsive to a selection by the user of the first irrigation station and the second irrigation station for the swap, the irrigation management application causes the user interface to: display a preview window visually depicting each of the first and second irrigation stations with their respective post-swap unique irrigation device addresses; and display an interactive graphical element that, when interacted with by the user, initiates the swap.

Some embodiments provide an irrigation management system that includes an irrigation management application for use in monitoring and/or controlling irrigation of an irrigation area by an irrigation system including a plurality of irrigation devices configured to be connected to a multi-wire path of the irrigation system. The irrigation management application comprises computer program code to be executed by an electronic device including a control circuit. When executed by the control circuit, the irrigation management application causes a user interface to be displayed on a display to a user. The user interface includes: a listing of irrigation stations, at least some of which have been assigned to a respective irrigation device of the plurality of irrigation devices connected to the multi-wire path of the irrigation system; for each irrigation station in the listing of irrigation stations that has an irrigation device assigned to it: an identifier assigned to the irrigation station; a name assigned to the irrigation station; a unique irrigation device address associated with the irrigation device assigned to the irrigation station; and an interactive feature selection option that, when interacted with by the user, causes the user interface to generate a features menu overlaying a portion of the listing and including an interactive troubleshoot feature that permits the user to troubleshoot the irrigation stations in the listing.

In some aspects, responsive to an interaction by the user with the interactive troubleshoot feature, the irrigation management application causes the user interface to display a troubleshooting menu as an overlay over the listing, the troubleshooting menu including at least one of: an interactive multi-wire health option to activate a multi-wire health mode and obtain a snapshot of a health of the multi-wire path associated with the irrigation stations in the listing; and an interactive find short option to activate a find short mode and energize the multi-wire path to find one or more electrical shorts in the multi-wire path. In certain implementations, responsive to a selection by the user of the interactive multi-wire health option, the irrigation management application causes: the user interface to display a health snapshot menu; and a signal to be sent to the irrigation controller to cause the controller to measure at least one of current draw and voltage and return data back to the user interface to populate fields of the health snapshot menu.

In some embodiments, the health snapshot menu includes at least one of: a first informational field indicating a numerical value of a measured current draw; a second informational field indicating a numerical value of a measured voltage; a third informational field indicating a time and date of a most recent measured current draw; a fourth informational field indicating a time and date of a most recent measured voltage; a first value bar that visually indicates a range of nominal values of the measured current draw, and a range of outlier values of the measured current draw; and a second value bar that visually indicates a range of nominal values of the measured voltage, and a range of outlier values of the measured voltage. The nominal values represent values associated with normal operation, and the outlier values represent values that are above or below the values associated with the normal operation.

In some aspects, a central region of the first value bar represents the range of the nominal values of the measured current draw, and peripheral regions of the first value bar represent the range of the outlier values of the measured current draw; and a central region of the second value bar represents the range of the nominal values of the measured voltage, and peripheral regions of the second value bar represent the range of the outlier values of the measured voltage. In certain implementations, the first value bar includes a first visual indicator positioned adjacent to or on the first value bar at a location that corresponds to the numerical value of the measured current draw; and the second value bar includes a first visual indicator positioned adjacent to or on the second value bar at a location that corresponds to the numerical value of the measured voltage. In some embodiments, responsive to a selection by the user of the interactive multi-wire health option, the irrigation management application causes the irrigation controller to continuously measure at least one of the current draw and the voltage at predetermined time intervals and update the third and fourth informational fields at the predetermined time intervals to indicate the most recent measured current draw and voltage, respectively.

In certain implementations, responsive to a selection by the user of the interactive multi-wire health option, the irrigation management application causes the irrigation controller to illuminate a status light that visually indicates that measurements of the current draw or voltage are being taken. In some aspects, the health snapshot menu further includes at least one of: a first interactive link associated with the current draw and configured to permit the user to enter the find short mode without interacting with the interactive find short option of the troubleshooting menu; and a second interactive link associated with the voltage and configured to permit the user to enter the find short mode without interacting with the interactive find short option of the troubleshooting menu. In some aspects, responsive to a selection by the user of the interactive find short multi-wire health option, the irrigation management application causes the user interface to display an interactive prompt that requires the user to interact with an option to proceed with the find short mode or to interact with an option to cancel the find short mode.

In certain embodiments, responsive to a selection by the user of the option to proceed with the find short mode, the irrigation management application causes: a current to be transmitted along the multi-wire path to energize the multi-wire path; and the user interface to display a short finding menu that includes an informational field indicating that the multi-wire path is energized and an interactive field that permits the user to exit the find short mode and deenergize the multi-wire path. In some aspects, responsive to a selection by the user of the option to proceed with the find short mode, the irrigation management application causes at least one of: a pause of irrigation by the irrigation stations associated with the multi-wire path while the multi-wire path is energized; and cause irrigation devices coupled to the irrigation stations associated with the multi-wire path to draw from about 0.5 to about 1 mA.

In some aspects, the features menu further includes an interactive rescan feature that, when interacted with by the user, permits the user to cause the irrigation management application to rescan the irrigation system to detect all of the unique irrigation device addresses connected to the multi-wire path. In some implementations, the features menu further includes a remove all feature that, when interacted with by the user, permits the user to cause the irrigation management application to update the user interface by removing all of the unique irrigation device addresses listed in the updated listing from association with the irrigation stations.

Some embodiments provide a method of managing irrigation comprising: by an irrigation management application comprising computer program code to be executed by an electronic device including a control circuit, the irrigation management application being for use in monitoring and/or controlling irrigation of an irrigation area by an irrigation system including a plurality of irrigation devices configured to be connected to a multi-wire path of the irrigation system, and, in response to being executed by the control circuit of the electronic device: causing a user interface to be displayed on a display to a user, the user interface including: a listing of irrigation stations, at least some of which have been assigned to a respective irrigation device of the plurality of irrigation devices connected to the multi-wire path of the irrigation system; and for each irrigation station in the listing of irrigation stations that has an irrigation device assigned to it: an identifier assigned to the irrigation station; a name assigned to the irrigation station; a unique irrigation device address associated with the irrigation device assigned to the irrigation station; and an interactive feature selection option that, when interacted with by the user, causes the user interface to generate a features menu overlaying a portion of the listing and including an interactive troubleshoot feature that permits the user to troubleshoot the irrigation stations in the listing.

User interfaces may be caused to be displayed on various forms of interfaces, such as on a controller display screen with lights and buttons/switches/dials, a mobile device having a touch sensitive display screen and buttons/voice input and running a mobile application, a computer screen of a computer executing an irrigation application and using various user input devices, on a computing device as provided by a server or other central irrigation application transmitting content for display on the computing device, for example. Further details regarding various user interface displays may be found in one or more of the following patent documents, all incorporated herein by reference:
U.S. Pat. No. 10,039,241, granted Aug. 7, 2018, titled PROGRAMMABLE IRRIGATION CONTROLLER HAVING USER INTERFACE (Docket No. 8473-136242-US);
U.S. Pat. No. 10,609,878, granted Apr. 7, 2020, titled WIRELESS REMOTE IRRIGATION CONTROL (Docket No. 8473-141359-US);
U.S. Pat. No. 11,109,546, granted Sep. 7, 2021, titled IRRIGATION CONTROLLER WIRELESS NETWORK ADAPTER AND NETWORKED REMOTE SERVICE (Docket No. 8473-144302-US);
U.S. application Ser. No. 18/123,976, filed Mar. 20, 2023, titled IRRIGATION CONTROL SYSTEMS AND USER INTERFACES, (Docket No. 8473-156623-US);
U.S. application Ser. No. 18/123,979, filed Mar. 20, 2023, titled IRRIGATION CONTROL SYSTEMS AND USER INTERFACES, (Docket No. 8473-157196-US);
U.S. application Ser. No. 18/123,981, filed Mar. 20, 2023, titled IRRIGATION CONTROL SYSTEMS AND USER INTERFACES, (Docket No. 8473-157197-US);
U.S. application Ser. No. 18/123,975, filed Mar. 20, 2023, titled IRRIGATION CONTROL SYSTEMS AND USER INTERFACES, (Docket No. 8473-157198-US); and
U.S. application Ser. No. 18/123,980, filed Mar. 20, 2023, titled IRRIGATION CONTROL SYSTEMS AND USER INTERFACES, (Docket No. 8473-157199-US.

In some embodiments, from time to time, firmware stored in and executed by the decoders (and/or other devices coupled to the two-wire path) in the field to control its operation may need to be updated. Normally, it is not practical to update the firmware of such devices and often decoders with outdated firmware are simply replaced. However, in some embodiments, the decoders described herein include the functionality to receive replacement firmware code from the data modulated on the AC power signal via the two-wire path. That is, the decoders described herein include sufficient memory to receive the replacement firmware code, and include a “bootloader” program that will reboot the decoder with the replacement firmware. In some aspects, the firmware of the decoders can be reflashed via the two-wire interface. The decoders include adequate memory and a bootloader program. Additional details regarding reflashing and/or the use of a bootloader are described in the following patent document which is incorporated herein by reference: U.S. Pat. No. 11,163,284, granted 11-2-2021, titled CODE REPLACEMENT FOR IRRIGATION CONTROLLERS (Docket No. 8473-149113-US).

Those skilled in the art will recognize that a wide variety of other modifications, alterations, and combinations can also be made with respect to the above-described embodiments without departing from the scope of the invention, and that such modifications, alterations, and combinations are to be viewed as being within the ambit of the inventive concept.

1. An irrigation management system comprising:
an irrigation management application for use in monitoring and/or controlling irrigation of an irrigation area by an irrigation system including a plurality of irrigation devices configured to be connected to a multi-wire path of the irrigation system, the irrigation management application comprising computer program code to be executed by an electronic device including a control circuit, and, when executed by the control circuit, the irrigation management application causes a user interface to be displayed on a display to a user, the user interface including:
a listing of irrigation stations, at least some of which have been assigned to a respective irrigation device of the plurality of irrigation devices connected to the multi-wire path of the irrigation system; and
for each irrigation station in the listing of irrigation stations that has an irrigation device assigned to it:
an identifier assigned to the irrigation station;
a name assigned to the irrigation station;
a unique irrigation device address associated with the irrigation device assigned to the irrigation station; and
a status indicator visually indicating a status of the unique irrigation device address.

2. The irrigation management system of claim 1, wherein the status indicator includes a visual indicator that indicates that the unique irrigation device address is at least one of:
an existing unique irrigation device address pre-assigned to the irrigation station;
a new unique irrigation device address discovered and assigned to the irrigation station;
a previously discovered unique irrigation device address that is not found in a new irrigation device address scan; and
an excess unique irrigation device address discovered and not assigned to any one of the irrigation stations of the irrigation system.

3. The irrigation management system of claim 2, wherein, responsive to a selection of a first one of the irrigation stations or a first one of the irrigation device addresses in the listing, the irrigation management application causes the user interface to generate a graphical element adjacent to or surrounding the status indicator to visibly indicate that the first one of the irrigation stations or the first one of the unique irrigation device address in the listing has been selected by the user.

4. The irrigation management system of claim 1, wherein the listing includes one or more unique irrigation device addresses not assigned to any of the irrigation stations in the listing.

5. The irrigation management system of claim 1, wherein the user interface permits the user to update the listing of the irrigation stations by manually adding to the listing of the irrigation stations an additional irrigation station having a pre-assigned unique irrigation device address.

6. The irrigation management system of claim 1, wherein the user interface further includes an interactive irrigation device address scan feature that permits the user to cause the irrigation management application to scan the irrigation system to detect all unique irrigation device addresses connected to the multi-wire path.

7. The irrigation management system of claim 6, wherein, responsive to an interaction by the user with the interactive irrigation device address scan feature, the irrigation management application causes the user interface to generate an interactive prompt that requires the user to select an option that indicates whether the irrigation system includes a master valve.

8. The irrigation management system of claim 7, wherein, responsive a selection by the user of the option indicating that the irrigation system includes the master valve, the irrigation management application at least one of:
performs a scan for the unique addresses of the irrigation devices coupled to the multi-wire path;
causes the user interface to generate an on-screen informational field indicating that the scan of the unique addresses of the irrigation devices is being performed; and
causes the user interface to display an updated listing of the irrigation stations, the updated listing of the irrigation stations including the unique irrigation device addresses detected connected to the multi-wire path that were identified during the scan.

9. The irrigation management system of claim 1, wherein the listing comprises:
a plurality of distinct interactive blocks or sections, each of the interactive blocks or sections being associated with a single irrigation station of the irrigation stations in the listing and including:
an identifier assigned to the single irrigation station;
a name assigned to the single irrigation station;
a unique irrigation device address associated with the irrigation device assigned to the single irrigation station; and
a status indicator visually indicating a status of the unique irrigation device address assigned to the single irrigation station.

10. The irrigation management system of claim 1, wherein the user interface permits the user to assign more than one unique irrigation device address to any one of the irrigation stations in the listing.

11. The irrigation management system of claim 1, wherein:
the user interface further includes an interactive sorting feature to permit the user to select one of a plurality of sort options for sorting how the irrigation stations are displayed in the listing; and
responsive to a selection of the interactive sorting feature by the user, the user interface generates an interactive sorting menu as an overlay over a portion of the listing, the interactive sorting menu including an option to sort the irrigation stations by status of the unique irrigation device address.

12. The irrigation management system of claim 11, wherein the sort options of the interactive sorting menu further include at least one of: an option to sort the irrigation stations by respective identifiers of the irrigation stations, an option to sort the irrigation stations by respective names assigned to the irrigation stations, and an option to sort the irrigation stations by respective unique irrigation device addresses assigned to the irrigation stations.

13. The irrigation management system of claim 11, wherein:
the user interface further includes an interactive filtering feature and, responsive to a selection by the user of the filtering feature, the user interface generates an interactive filtering menu overlaid over a portion of the listing; and
the interactive filtering menu includes one or more filtering options selectable by the user in association with filtering the irrigation stations by the status of the unique irrigation device address, the filtering options including at least one of:
an option to filter the irrigation stations by existing unique irrigation device addresses pre-assigned to the irrigation stations;
an option to filter the irrigation stations by new unique irrigation device addresses discovered and assigned to the irrigation station;
an option to filter the irrigation stations by previously discovered unique irrigation device addresses that are not found in a new irrigation device address scan; and
an option to filter the irrigation stations by excess unique irrigation device addresses discovered and not assigned to any one of the irrigation stations of the irrigation system.

14. The irrigation management system of claim 11, wherein the user interface further includes an interactive search feature that, when interacted with by the user, permits the user to enter a search query into a freeform text input field to search for at least one of the identifier of the irrigation station of the irrigation stations in the listing, the name of the irrigation station of the irrigation stations in the listing, and the unique irrigation device address of the irrigation station of the irrigation stations in the listing.

15. A method of managing irrigation comprising:
by an irrigation management application comprising computer program code to be executed by an electronic device including a control circuit, the irrigation management application being for use in monitoring and/or controlling irrigation of an irrigation area by an irrigation system including a plurality of irrigation devices configured to be connected to a multi-wire path of the irrigation system, and, in response to being executed by the control circuit of the electronic device:
causing a user interface to be displayed on a display to a user, the user interface including:
a listing of irrigation stations, at least some of which have been assigned to a respective irrigation device of the plurality of irrigation devices connected to the multi-wire path of the irrigation system; and
for each irrigation station in the listing of irrigation stations that has an irrigation device assigned to it:
an identifier assigned to the irrigation station;
a name assigned to the irrigation station;
a unique irrigation device address associated with the irrigation device assigned to the irrigation station; and
a status indicator visually indicating a status of the unique irrigation device address.

16-36. (canceled)

37. The method of claim 15, wherein the status indicator includes a visual indicator that indicates that the unique irrigation device address is at least one of:
an existing unique irrigation device address pre-assigned to the irrigation station;
a new unique irrigation device address discovered and assigned to the irrigation station;
a previously discovered unique irrigation device address that is not found in a new irrigation device address scan; and
an excess unique irrigation device address discovered and not assigned to any one of the irrigation stations of the irrigation system.

38. The method of claim 15, wherein the listing includes one or more unique irrigation device addresses not assigned to any of the irrigation stations in the listing.

39. The method of claim 15, wherein the user interface further includes an interactive irrigation device address scan feature that permits the user to cause the irrigation management application to scan the irrigation system to detect all unique irrigation device addresses connected to the multi-wire path.

40. The method of claim 15, wherein the listing comprises:
a plurality of distinct interactive blocks or sections, each of the interactive blocks or sections being associated with a single irrigation station of the irrigation stations in the listing and including:
an identifier assigned to the single irrigation station;
a name assigned to the single irrigation station;
a unique irrigation device address associated with the irrigation device assigned to the single irrigation station; and
a status indicator visually indicating a status of the unique irrigation device address assigned to the single irrigation station.

41. The method of claim 15, wherein:
the user interface further includes an interactive sorting feature to permit the user to select one of a plurality of sort options for sorting how the irrigation stations are displayed in the listing; and
responsive to a selection of the interactive sorting feature by the user, the user interface generates an interactive sorting menu as an overlay over a portion of the listing, the interactive sorting menu including an option to sort the irrigation stations by status of the unique irrigation device address.
